(19) United States
(12) Patent Application Publication
(10) Pub. No.: US 2026/0094353 A1
(43) Pub. Date: Apr. 2, 2026

(54) SYSTEMS AND METHODS FOR LOCKING THE PRESENTATION OF CONTENT IN A THREE-DIMENSIONAL ENVIRONMENT

(71) Applicant: Apple Inc., Cupertino, CA (US)

(72) Inventors: Devin W. CHALMERS, Oakland, CA (US); William D. LINDMEIER, San Francisco, CA (US); Luis R. DELIZ CENTENO, Fremont, CA (US); Tony KOBAYASHI, Berkeley, CA (US); Giancarlo YERKES, San Francisco, CA (US); Rahul NAIR, Hayward, CA (US); Michael R. ALGER, Mountain View, CA (US); Gregory LUTTER, Boulder Creek, CA (US)

(21) Appl. No.: 19/336,336

(22) Filed: Sep. 22, 2025

Related U.S. Application Data
(60) Provisional application No. 63/700,378, filed on Sep. 27, 2024.
(60) Provisional application No. 63/771,968, filed on Mar. 14, 2025.
(60) Provisional application No. 63/882,902, filed on Sep. 16, 2025.

(51) Int. Cl. G06T 15/20

(52) U.S. Cl. CPC G06T 15/20

(57) ABSTRACT

Some examples of the disclosure are directed to systems and methods for locking the presentation of content in a three-dimensional environment. For example, a first electronic device presents content in a world-locked orientation in a three-dimensional environment in accordance with a determination that a second electronic detects one or more characteristics of the first electronic device or of a user of the first electronic device. For example, the second electronic device is in communication with the first electronic device. Some examples of the disclosure are further directed to systems and methods for performing one or more operations on a first electronic device in response to detecting, via one or more input devices of a second electronic device, one or more portions of a user.

### CROSS-REFERENCE TO RELATED APPLICATIONS

This application claims the benefit of U.S. Provisional Application No. 63/882,902, filed Sep. 16, 2025, U.S. Provisional Application No. 63/771,968, filed Mar. 14, 2025, and U.S. Provisional Application No. 63/700,378, filed Sep. 27, 2024, the contents of which are incorporated herein by reference in their entireties for all purposes.

### FIELD OF THE DISCLOSURE

This relates generally to systems and methods for presenting virtual content in a three-dimensional environment.

### BACKGROUND OF THE DISCLOSURE

Some computer graphical environments provide two-dimensional and/or three-dimensional environments where at least some objects displayed for a user's viewing are virtual and generated by a computer.

### SUMMARY OF THE DISCLOSURE

Some examples of the disclosure are directed to systems and methods for locking the presentation of content in a three-dimensional environment. For example, the systems and methods of the disclosure enable a first electronic device that includes a display, but optionally does not include one or more input devices for world-locking content (e.g., one or more image sensors that enable localization of virtual content with respect to a three-dimensional environment), to present virtual content in world-locked orientations in a three-dimensional environment using one or more input devices of a second electronic device (e.g., the second electronic device is in communication with the first electronic device).

In some examples, a method is performed at a computing system including a first electronic device in communication with a second electronic device. In some examples, the computing system presents, via one or more displays of the first electronic device, first content (e.g., virtual content) in a three-dimensional environment. In some examples, presenting the first content in the three-dimensional environment includes, in accordance with a determination that one or more first criteria are satisfied, the one or more first criteria including a criterion that is satisfied when the computing system detects, via one or more input devices of the second electronic device, a first characteristic of the first electronic device or of a user of the first electronic device, locking the presentation of the first content in a first manner. For example, locking the presentation of the first content in the first manner includes presenting the first content in a world-locked orientation relative to a location of the second electronic device in the three-dimensional environment. Alternatively, for example, locking the presentation of the first content in the first manner includes presenting the first content in a world-locked orientation at a location in the three-dimensional environment that is at least partially independent from a location of the second electronic device. In some examples, presenting the first content in the three-dimensional environment includes, in accordance with a determination that one or more second criteria are satisfied, different from the one or more first criteria, locking the presentation of the first content in a second manner, different from the first manner. For example, locking the presentation of the first content in the second manner includes presenting the first content in a body-locked orientation in the three-dimensional environment. Alternatively, for example, locking the presentation of the first content in the second manner includes presenting the first content in a head-locked orientation in the three-dimensional environment.

Some examples of the disclosure are directed to systems and methods for performing one or more operations on a first electronic device in response to detecting one or more portions of a user using a second electronic device. For example, the systems and methods of the disclosure enable a first electronic device that includes a display, but optionally does not include one or more input devices (e.g., one or more image sensors and/or hand-tracking for tracking one or more portions of a user) for detecting air gestures (e.g., performed by a hand) to perform one or more operations in a three-dimensional environment in response to air gestures using one or more input devices of a second electronic device (e.g., the second electronic device is in communication with the first electronic device).

In some examples, a method is performed at a computing system including a first electronic device in communication with a second electronic device. In some examples, while presenting, via one or more displays of the first electronic device, first content in a three-dimensional environment, the computing system detects, via one or more input devices of the second electronic device, a first pose of the second electronic device (and/or of the user of the second electronic device). In some examples, in response to detecting the first pose of the second electronic device (and/or of the user of the second electronic device), in accordance with a determination that the first pose of the second electronic device (and/or of the user of the second electronic device) satisfies one or more criteria, the computing system operates the second electronic device in a first mode for detecting one or more portions of a user of the computing system. In some examples, while operating the second electronic device in the first mode, the computing system detects, via the one or more input devices of the second electronic device, a first characteristic of the one or more portions of the user. In some examples, in response to detecting the first characteristic of the one or more portions of the user, the computing system performs a first operation associated with the first content presented in the three-dimensional environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIGS. 3A-3N illustrate a computing system presenting virtual content in a world-locked orientation in a three-dimensional environment relative to a location of a companion device according to some examples of the disclosure.

FIGS. 4A-4G illustrate a computing system presenting virtual content in a world-locked orientation in a three-dimensional environment according to some examples of the disclosure.

FIG. 5 illustrates a flow diagram of an example process for locking the presentation of content in a three-dimensional environment according to some examples of the disclosure.

FIGS. 6A-6K illustrate a computing system performing operations in a three-dimensional environment on a first electronic device in response to detecting one or more characteristics of a portion of a user on a second electronic device according to some examples of the disclosure.

FIG. 7 illustrates a flow diagram of an example process for performing an operation in a three-dimensional environment according to some examples of the disclosure.

FIGS. 8A-8C illustrate a computing system with a first electronic device and a second electronic device, the second electronic device used for controlling the operation of the first electronic device.

FIG. 9 illustrates a flow diagram of an example process for performing an operation in a three-dimensional environment according to some examples of the disclosure.

### DETAILED DESCRIPTION

Some examples of the disclosure are directed to systems and methods for locking the presentation of content in a three-dimensional environment. For example, the systems and methods of the disclosure enable a first electronic device that includes a display, but optionally does not include one or more input devices for world-locking content (e.g., one or more image sensors that enable localization of virtual content with respect to a three-dimensional environment), to present virtual content in world-locked orientations in a three-dimensional environment using one or more input devices of a second electronic device (e.g., the second electronic device is in communication with the first electronic device).

In some examples, a method is performed at a computing system including a first electronic device in communication with a second electronic device. In some examples, the computing system presents, via one or more displays of the first electronic device, first content (e.g., virtual content) in a three-dimensional environment. In some examples, presenting the first content in the three-dimensional environment includes, in accordance with a determination that one or more first criteria are satisfied, the one or more first criteria including a criterion that is satisfied when the computing system detects, via one or more input devices of the second electronic device, a first characteristic of the first electronic device or of a user of the first electronic device, locking the presentation of the first content in a first manner. For example, locking the presentation of the first content in the first manner includes presenting the first content in a world-locked orientation relative to a location of the second electronic device in the three-dimensional environment. Alternatively, for example, locking the presentation of the first content in the first manner includes presenting the first content in a world-locked orientation at a location in the three-dimensional environment that is at least partially independent from a location of the second electronic device. In some examples, presenting the first content in the three-dimensional environment includes, in accordance with a determination that one or more second criteria are satisfied, different from the one or more first criteria, locking the presentation of the first content in a second manner, different from the first manner. For example, locking the presentation of the first content in the second manner includes presenting the first content in a body-locked orientation in the three-dimensional environment. Alternatively, for example, locking the presentation of the first content in the second manner includes presenting the first content in a head-locked orientation in the three-dimensional environment.

Some examples of the disclosure are directed to systems and methods for performing one or more operations on a first electronic device in response to detecting one or more portions of a user using a second electronic device. For example, the systems and methods of the disclosure enables a first electronic device that includes a display, but optionally does not include one or more input devices (e.g., one or more image sensors and/or hand-tracking for tracking one or more portions of a user) for detecting air gestures (e.g., performed by a hand) to perform one or more operations in a three-dimensional environment in response to air gestures using one or more input devices of a second electronic device (e.g., the second electronic device is in communication with the first electronic device).

In some examples, a method is performed at a computing system including a first electronic device in communication with a second electronic device. In some examples, while presenting, via one or more displays of the first electronic device, first content in a three-dimensional environment, the computing system detects, via one or more input devices of the second electronic device, a first pose of the second electronic device (and/or of the user of the second electronic device). In some examples, in response to detecting the first pose of the second electronic device (and/or of the user of the second electronic device), in accordance with a determination that the first pose of the second electronic device (and/or of the user of the second electronic device) satisfies one or more criteria, the computing system operates the second electronic device in a first mode for detecting one or more portions of a user of the computing system. In some examples, while operating the second electronic device in the first mode, the computing system detects, via the one or more input devices of the second electronic device, a first characteristic of the one or more portions of the user. In some examples, in response to detecting the first characteristic of the one or more portions of the user, the computing system performs a first operation associated with the first content presented in the three-dimensional environment.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed (e.g., presented) in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes). In some examples, a head-locked object follows movement of the user's head (as the viewpoint of the user changes) in response to a threshold amount of head movement (e.g., when the user's head movement exceeds a threshold distance and/or a threshold change in orientation) (e.g., the follow movement of the head-locked object in the three-dimensional environment is optionally smoothed). In some examples, a head-locked object (e.g., an object displayed at a head-locked orientation) is a display-locked object (e.g., displayed at a fixed location on a display).

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

In some examples, a tilt-locked object comprises an environment-locked object (e.g., displayed at a fixed location in the three-dimensional environment) with one or more features within the environment-locked object that move based on movement of the user's head. In some examples, the tilt locked-object may include an environment-locked user interface (e.g., which does not move within the three-dimensional environment) that displays scrollable content. In some examples, the scrollable content is scrolled based on the tilt of the head of the user (e.g., in the pitch direction or the roll direction). As one example, as the head of the user tilts up (e.g., on the pitch axis), the environment-locked user interface remains at the same position in the environment (e.g., relative to an altitude in the three-dimensional environment, which is achieved via moving the display-locked user interface downwards (e.g., on the pitch axis) on the display in accordance with the upwards head tilt). However, as the head of the user tilts up, the scrollable content is scrolled upwards, thereby allowing a user to manipulate the scrollable content via head motion.

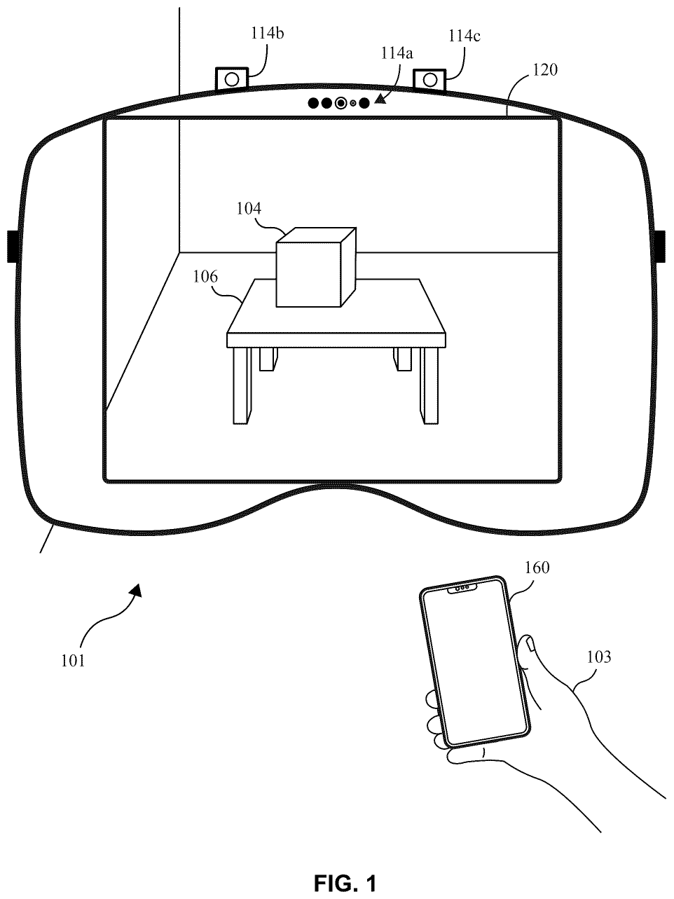

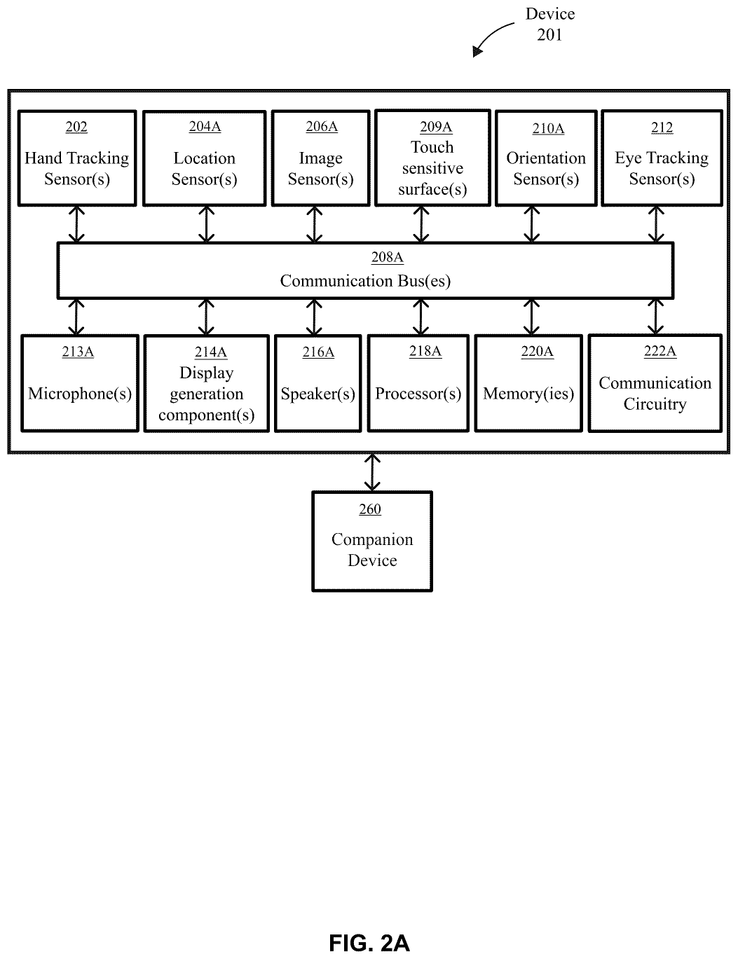

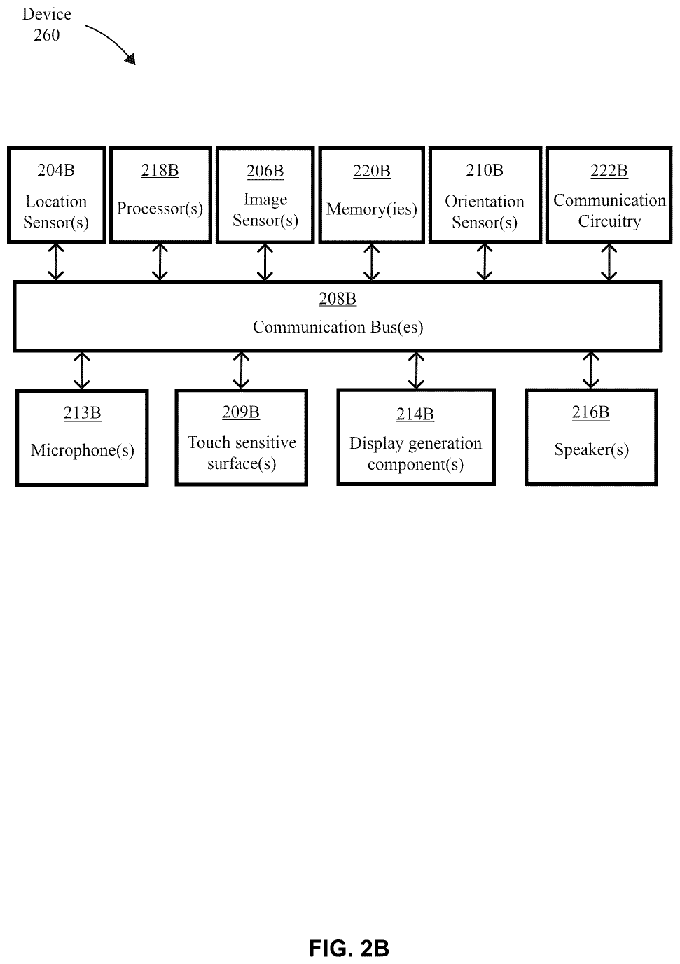

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, the electronic device 101 may be configured to communicate with a second electronic device, such as a companion device. For example, as illustrated in FIG. 1, the electronic device 101 may be in communication with electronic device 160. In some examples, the electronic device 160 corresponds to a mobile electronic device, such as a smartphone, a tablet computer, a smart watch, or other electronic device. Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned (e.g., mounted) on a head of a user and the electronic device 160 may be positioned near electronic device 101, such as in a hand 103 of the user (e.g., the hand 103 is holding of the electronic device 160), and the electronic device 101 and the electronic device 160 are associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, electronic device 101 may present content (e.g., images and/or video) that is rendered by electronic device 160 (e.g., electronic device 101 includes a passive display). For example, electronic device 160 renders virtual object 104 and sends a signal to electronic device 101 to present virtual object 104 via the display 120 (e.g., electronic device 160 is in wired or wireless communication with electronic device 101).

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices 201 and 260 according to some examples of the disclosure. In some examples, electronic device 201 and/or electronic device 260 include one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1. In some examples, electronic device 260 corresponds to electronic device 160 described above with reference to FIG. 1. Electronic device 201 and electronic device 260 optionally form and/or are included in a computing system.

As illustrated in FIG. 2A, the electronic device 201 optionally includes various sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), one or more display generation components 214A, optionally corresponding to display 120 in FIG. 1, one or more speakers 216A, one or more processors 218A, one or more memories 220A, and/or communication circuitry 222A. One or more communication buses 208A are optionally used for communication between the above-mentioned components of electronic devices 201. Additionally, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260. The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A or 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 201 and 260 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with each of electronic devices 201 and 260 or external to each of electronic devices 201 and 260 that is in communication with each of electronic devices 201 and 260).

Electronic devices 201 and 260 optionally include image sensor(s) 206A and 206B, respectively. Image sensors(s) 206A, 206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A, 206B also optionally include one or more cameras configured to capture movement of physical objects in the real-world environment. Image sensor(s) 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201, 260 uses CCD sensors, event cameras, and depth sensors in combination to detect the physical environment around electronic device 201, 260. In some examples, image sensor(s) 206A, 206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201, 260 uses image sensor(s) 206A, 206B to detect the position and orientation of electronic device 201, 260 and/or display generation component(s) 214A, 214B in the real-world environment. For example, electronic device 201, 260 uses image sensor(s) 206A, 206B to track the position and orientation of display generation component(s) 214A, 214B relative to one or more fixed objects in the real-world environment. In some examples, electronic device 201, 260 uses one or more sensors for detecting relevant information about the relative positions of the first device, the user, and/or the environment (e.g., image sensor(s) 206A, 206B). For example, a light detection and ranging (LIDAR) sensor is optionally used in addition to or in place of an image sensor to achieve the effects described here.

In some examples, electronic devices 201 and 260 include microphone(s) 213A and 213B, respectively, or other audio sensors. Electronic device 201, 260 optionally uses microphone(s) 213A, 213B to detect sound from the user and/or the real-world environment of the user. In some examples, microphone(s) 213A, 213B includes an array of microphones (a plurality of microphones) that optionally operate in tandem, such as to identify ambient noise or to locate the source of sound in space of the real-world environment.

In some examples, electronic devices 201 and 260 include location sensor(s) 204A and 204B, respectively, for detecting a location of electronic device 201A and/or display generation component(s) 214A and a location of electronic device 260 and/or display generation component(s) 214B, respectively. For example, location sensor(s) 204A, 204B can include a global positioning system (GPS) receiver that receives data from one or more satellites and allows electronic device 201, 260 to determine the device's absolute position in the physical world.

In some examples, electronic devices 201 and 260 include orientation sensor(s) 210A and 210B, respectively, for detecting orientation and/or movement of electronic device 201 and/or display generation component(s) 214A and orientation and/or movement of electronic device 260 and/or display generation component(s) 214B, respectively. For example, electronic device 201, 260 uses orientation sensor(s) 210A, 210B to track changes in the position and/or orientation of electronic device 201, 260 and/or display generation component(s) 214A, 214B, such as with respect to physical objects in the real-world environment. Orientation sensor(s) 210A, 210B optionally include one or more gyroscopes and/or one or more accelerometers.

In some examples, electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214A, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214A. In some examples, hand tracking sensor(s) 202 and/or eye tracking sensor(s) 212 are implemented together with the display generation component(s) 214A. In some examples, the hand tracking sensor(s) 202 and/or eye tracking sensor(s) 212 are implemented separate from the display generation component(s) 214A. In some examples, electronic device 201 alternatively does not include hand tracking sensor(s) 202 and/or eye tracking sensor(s) 212. In some such examples, the display generation component(s) 214A may be utilized by the electronic device 260 to provide an extended reality environment and utilize input and other data gathered via the other sensor(s) (e.g., the one or more location sensors 204A, one or more image sensors 206A, one or more LIDAR sensors, one or more touch-sensitive surfaces 209A, one or more motion and/or orientation sensors 210A, and/or one or more microphones 213A or other audio sensors) of the electronic device 201 as input and data that is processed by the processor(s) 218B of the electronic device 260. Additionally or alternatively, electronic device 201 optionally does not include other components shown in FIG. 2B, such as location sensors 204B, image sensors 206B, touch-sensitive surfaces 209B, etc. In some such examples, the display generation component(s) 214A may be utilized by the electronic device 260 to provide an extended reality environment and the electronic device 260 utilize input and other data gathered via the one or more motion and/or orientation sensors 210A (and/or one or more microphones 213A) of the electronic device 201 as input.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). As discussed above, an alternative sensor (e.g., a LIDAR sensor) is optionally used in addition to or in place of an image sensor to the effects described herein.

In some examples, the hands can be resolved with sufficient resolution to distinguish fingers and their respective positions. In some examples, one or more image sensors 206A are positioned relative to the user to define a field of view of the image sensor(s) 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

In some examples, electronic device 201 may present content (e.g., images and/or video) via display generation component(s) 214A that is rendered by electronic device 260 (e.g., electronic device 201 includes a passive display). For example, electronic device 260 renders the content and sends a signal to electronic device 260 to present the content via display generation component(s) 214A.

Attention is now directed toward examples of a computing system locking the presentation of content in a three-dimensional environment. For example, the computing system comprises a first electronic device (e.g., corresponding to electronic devices 101 and/or 201) and a second electronic device (e.g., corresponding to electronic devices 160 and/or 260). For example, the computing system utilizes one or more input devices (e.g., image sensors) of the second electronic device to present content on the first electronic device in a world-locked orientation in a three-dimensional environment.

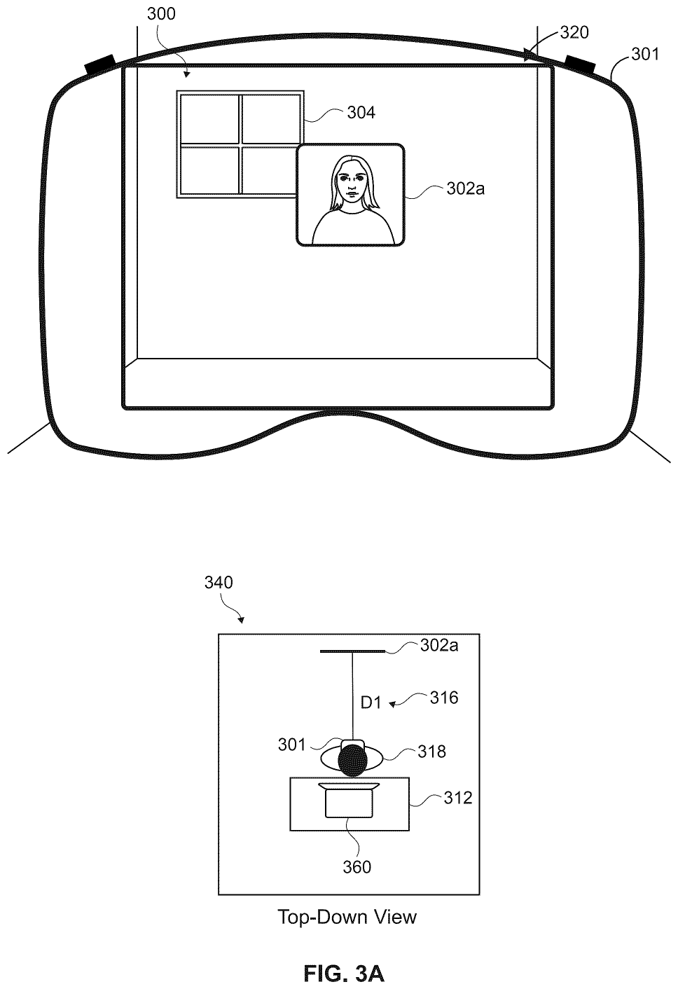

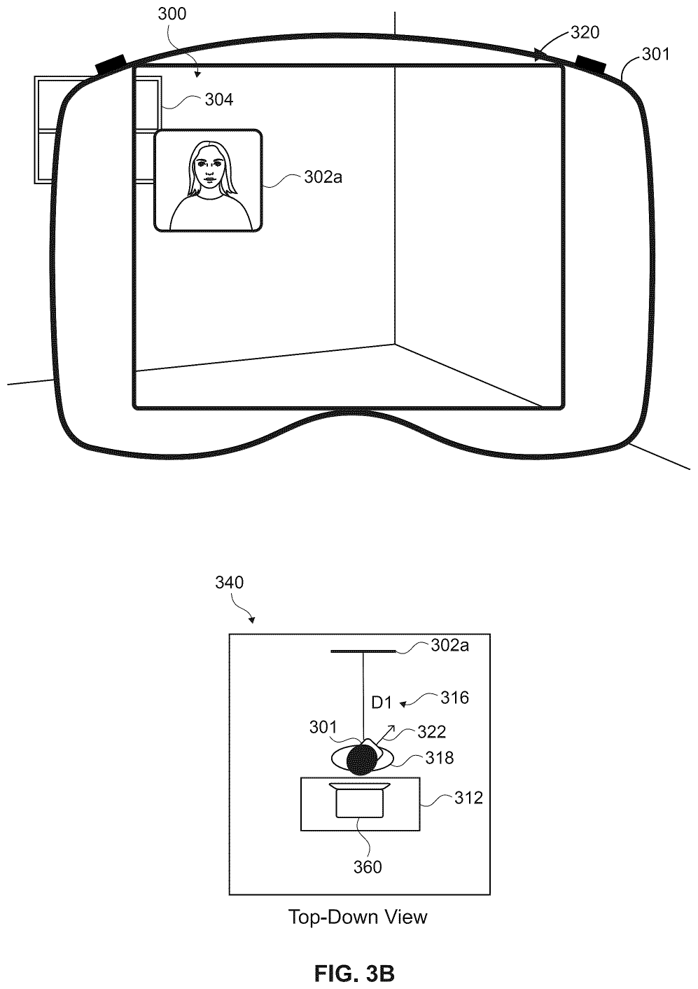

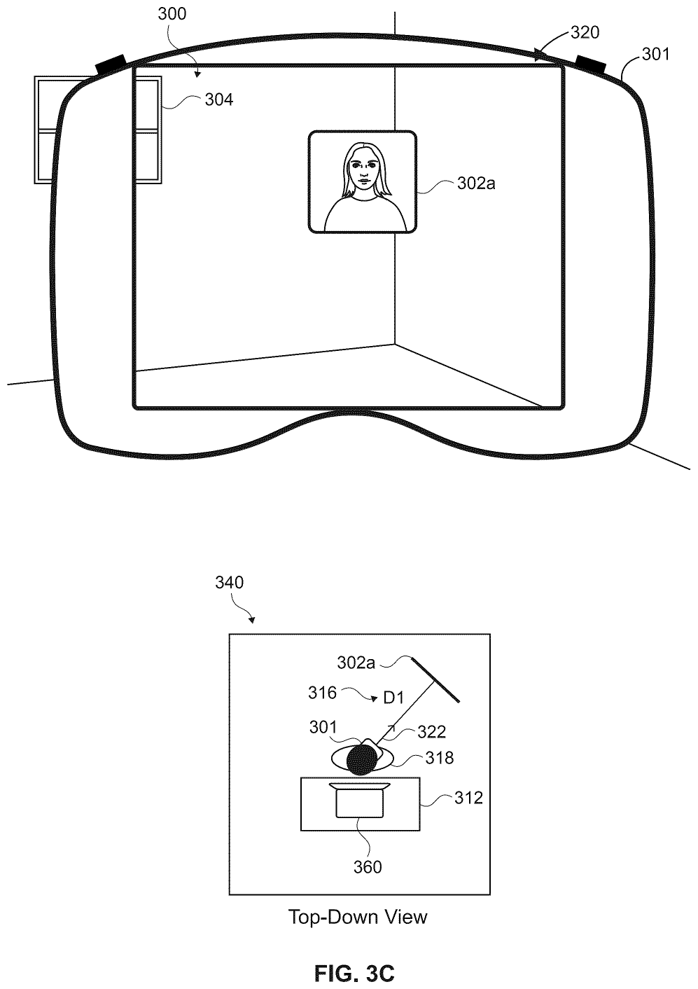

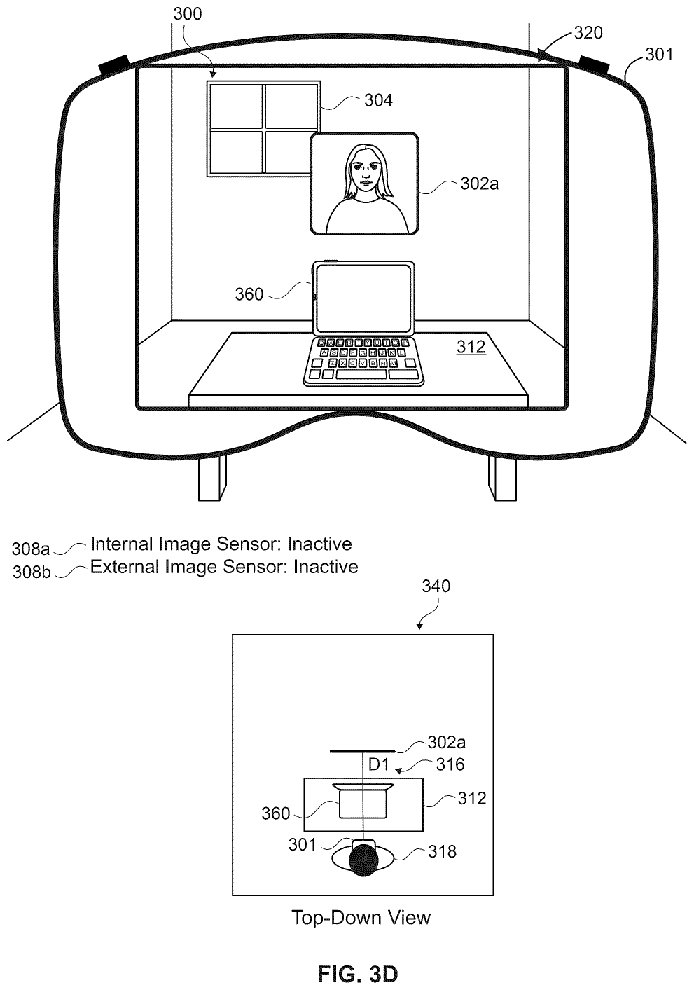

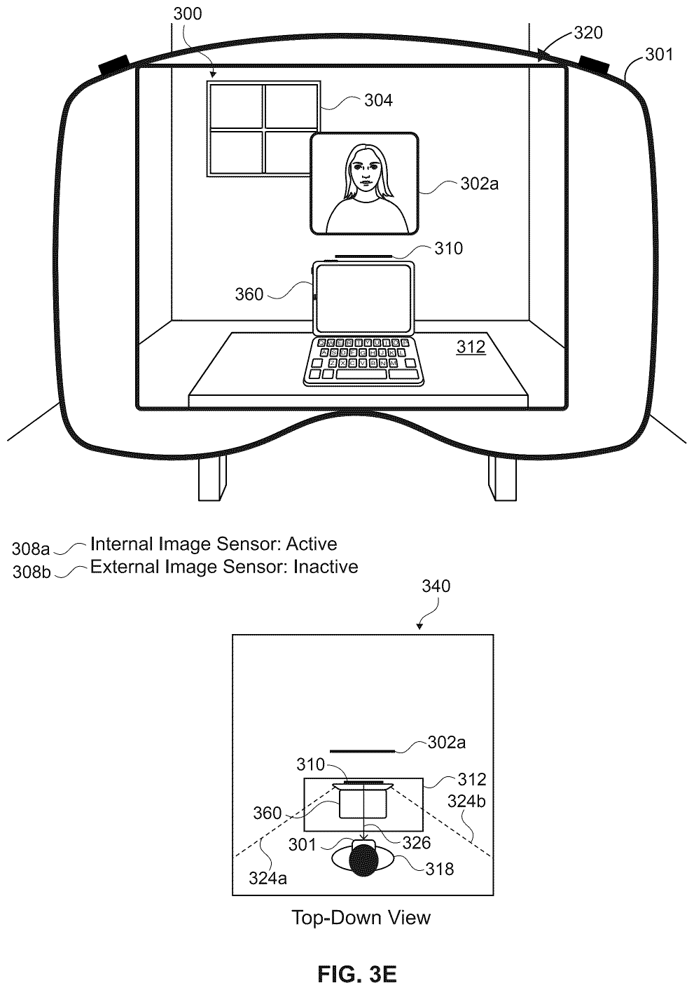

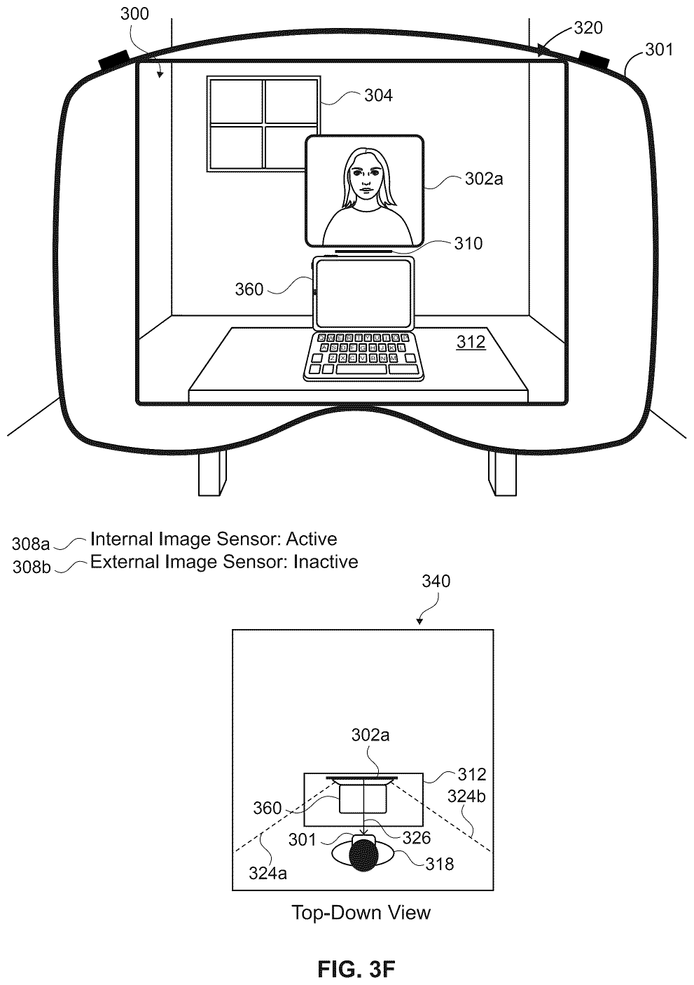

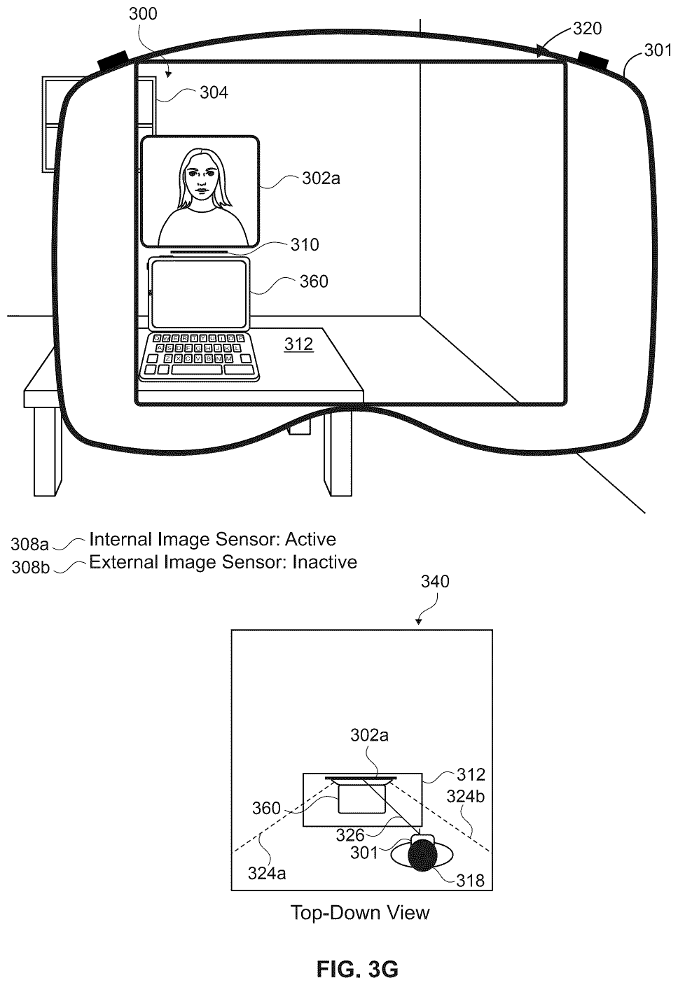

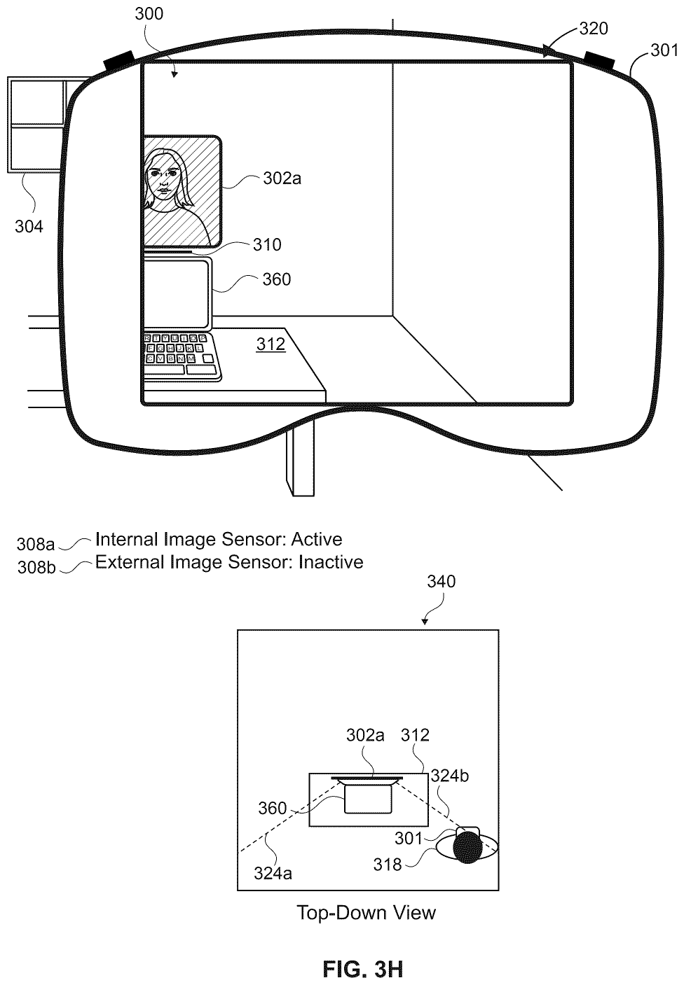

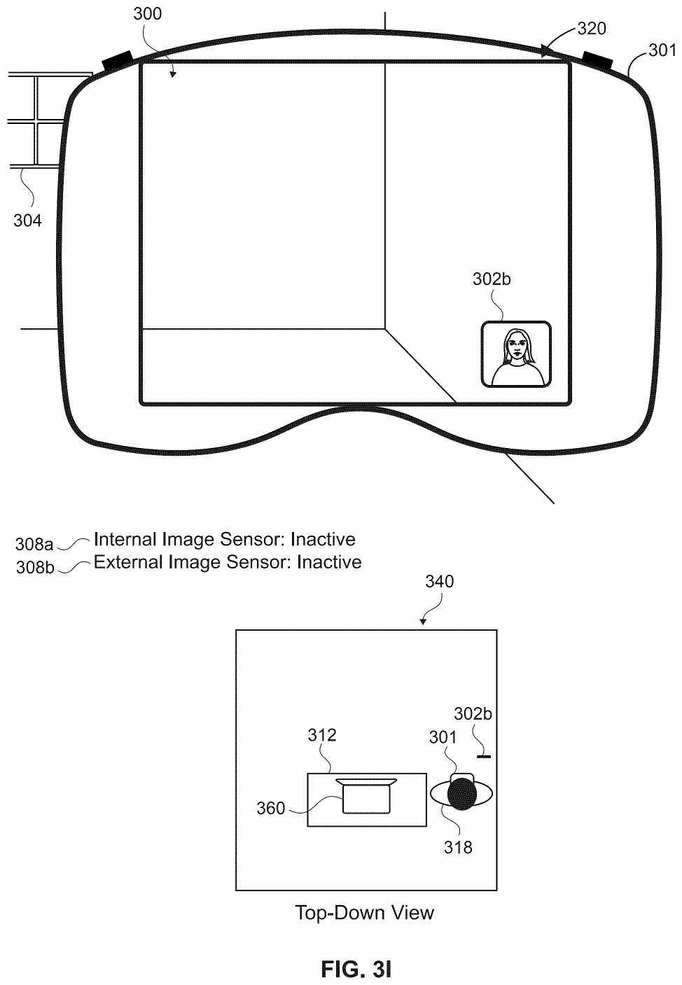

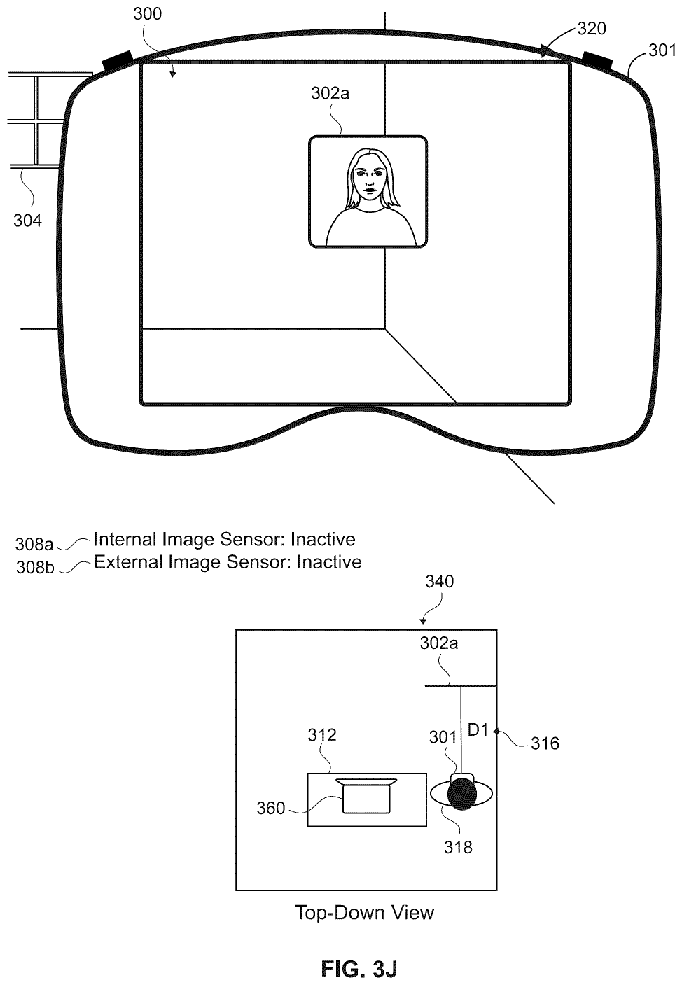

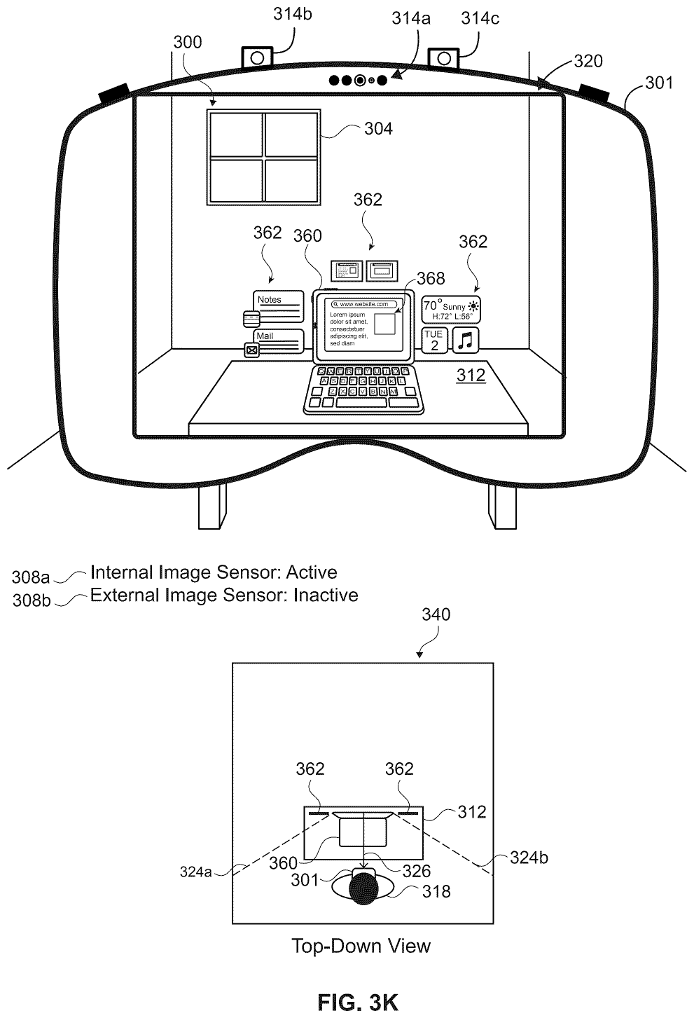

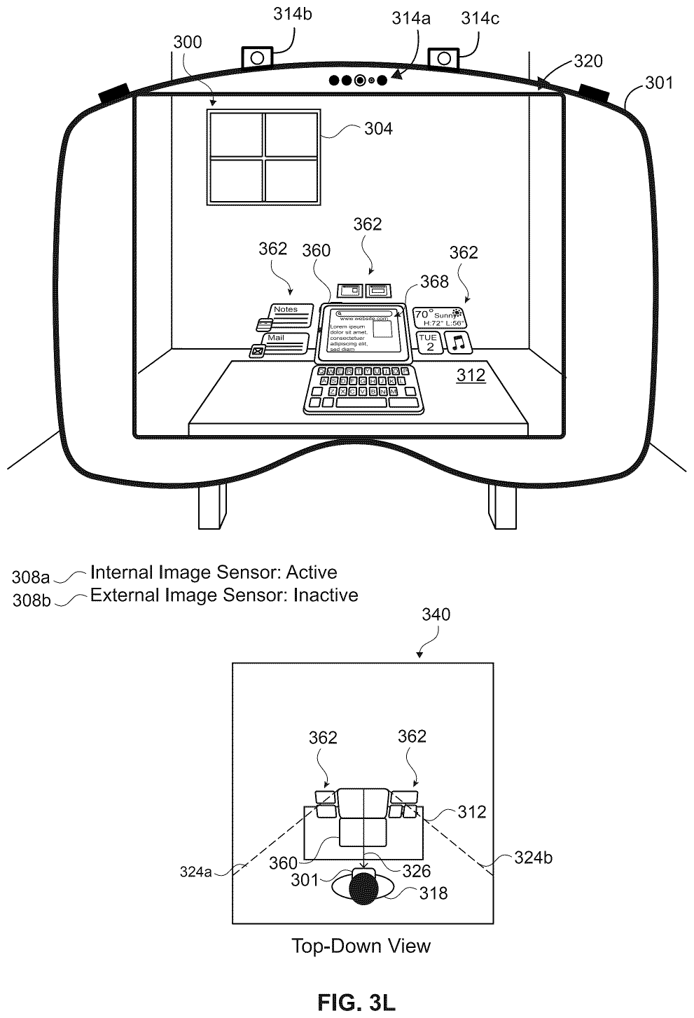

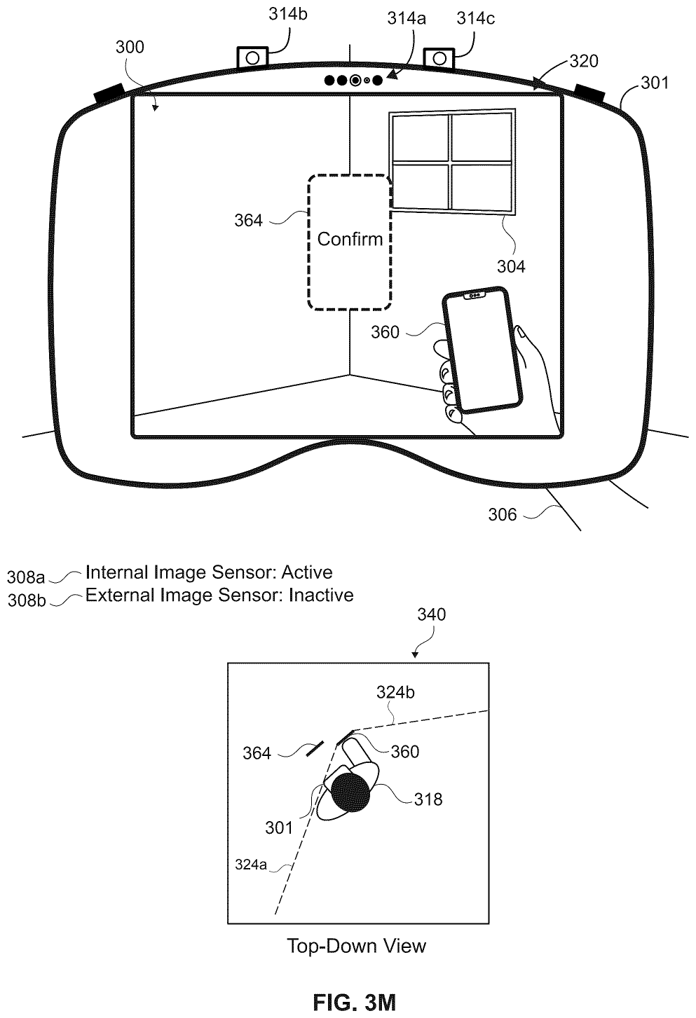

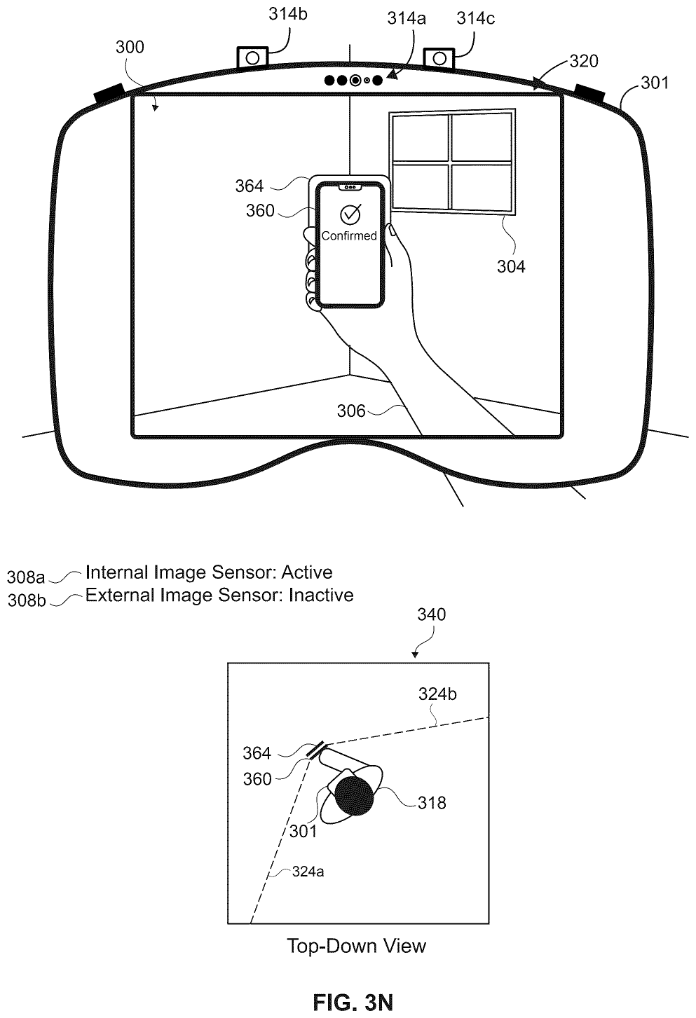

In some examples, presenting content in a world-locked orientation requires an electronic device (e.g., and/or a computing system) to detect (e.g., using one or more input devices, such as image sensors, location sensors, eye-tracking sensors, and/or hand-tracking sensors) a position of a user (e.g., of a user's head or eyes) relative to one or more locations of a three-dimensional environment. The below described methods and processes (e.g., described with reference to FIGS. 3A-5) enable a first electronic device that optionally includes orientation sensors (e.g., for detecting motion and/or an orientation of the first electronic device) but that optionally does not include image sensors, location sensors, eye-tracking sensors, and/or hand-tracking sensors (e.g., input devices used for tracking position of a user's head, face, and/or eyes) to present content in world-locked orientations in a three-dimensional environment using one or more input devices of a companion device (e.g., a second electronic device having one or more characteristics of electronic devices 160 and/or 260). The below described methods and processes improve the overall functionality of the first electronic device (e.g., despite the first electronic device not including the input devices required for presenting world-locked content) and enable a user of the first electronic device to acquire greater freedom of displaying and/or interacting with content in the three-dimensional environment (e.g., which enhances the functionality of one or more applications for presenting content that are accessed through the first electronic device).

FIGS. 3A-3N illustrate a computing system presenting virtual content in a world-locked orientation in a three-dimensional environment relative to a location of a companion device according to some examples of the disclosure. In some examples, the computing system includes a first electronic device 301 (e.g., having one or more characteristics of electronic device 101 and/or 201) and a second electronic device 360 (e.g., having one or more characteristics of electronic device 160 and/or 260). In some examples, the computing system includes first electronic device 301, and the first electronic device 301 is configured to be in communication with second electronic device 360 (e.g., second electronic device 360 is an auxiliary and/or companion device in communication with first electronic device 301).

As shown in FIGS. 3A-3N, first electronic device 301 includes a display 320 (e.g., having one or more characteristics of display 120 and/or display generation component(s) 214A). In some examples, display 320 includes multiple display generation components (e.g., first electronic device 301 is a head-mounted display including two stereo displays).

In FIGS. 3A-3N, an environment 300 is visible via display 320. In some examples, environment 300 is a three-dimensional environment that is presented to a user of first electronic device 301 via display 320. In some examples, environment 300 is an extended reality (XR) environment having one or more characteristics of an XR environment described above. For example, from a current viewpoint of a user of first electronic device 301 (e.g., user 318 shown in top-down view 340), one or more virtual objects (e.g., virtual object 302a shown in FIG. 3A) are presented in environment 300 while one or more physical objects (e.g., real-world window 304) from a physical environment of the user are visible (e.g., through video passthrough or optical see-through of the physical environment).

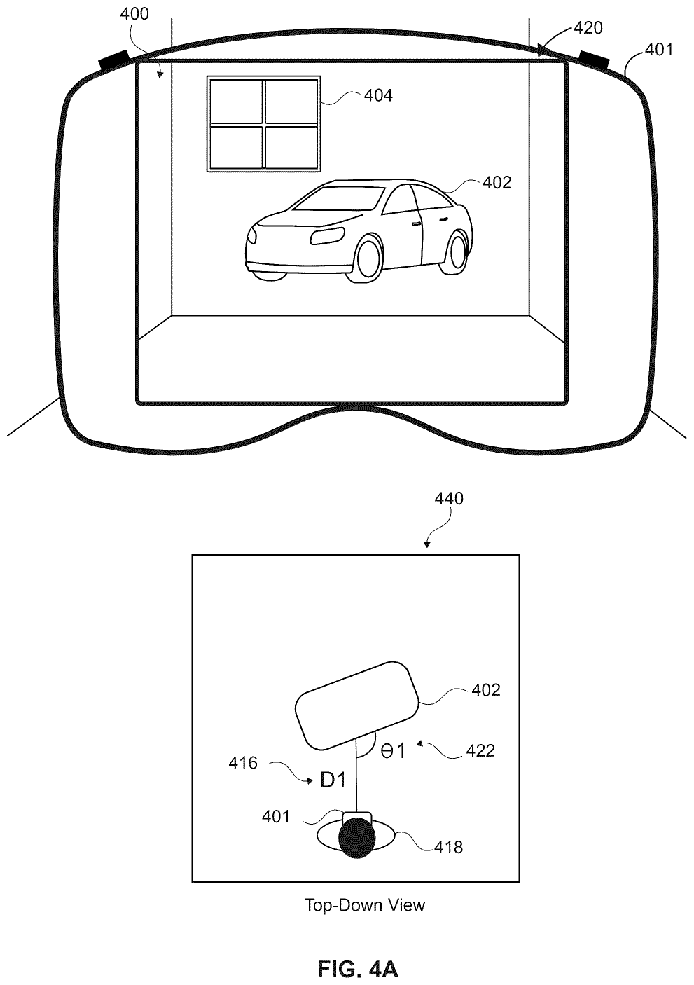

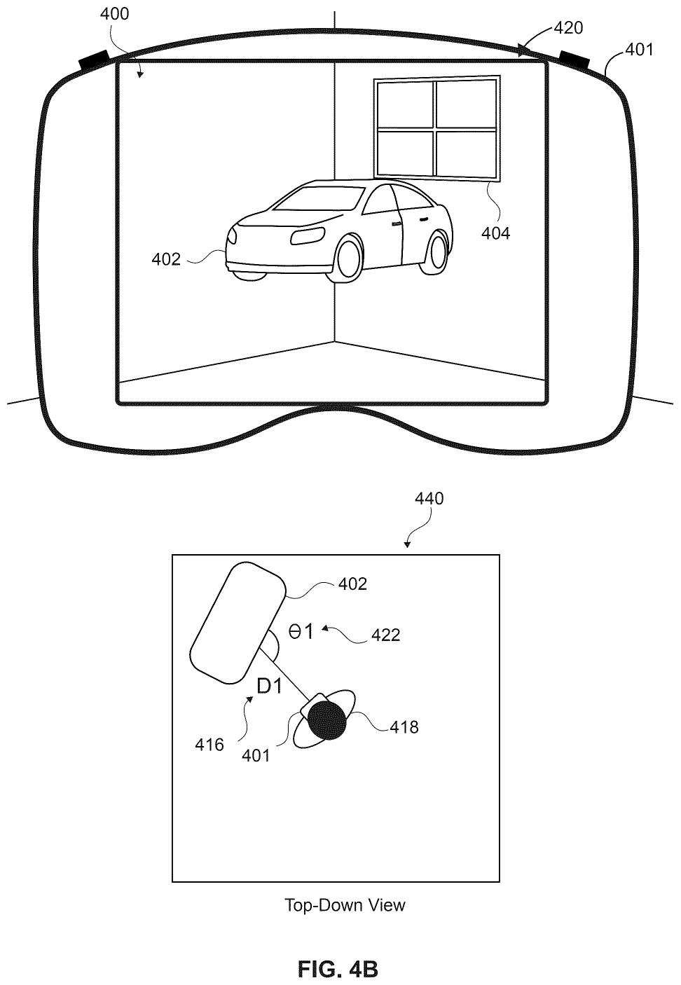

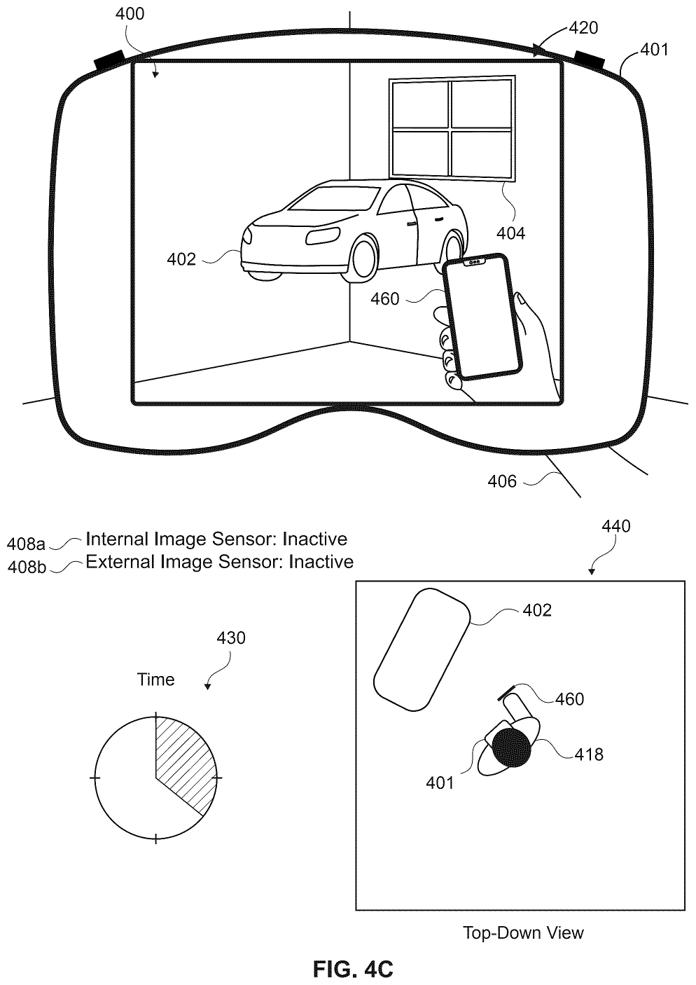

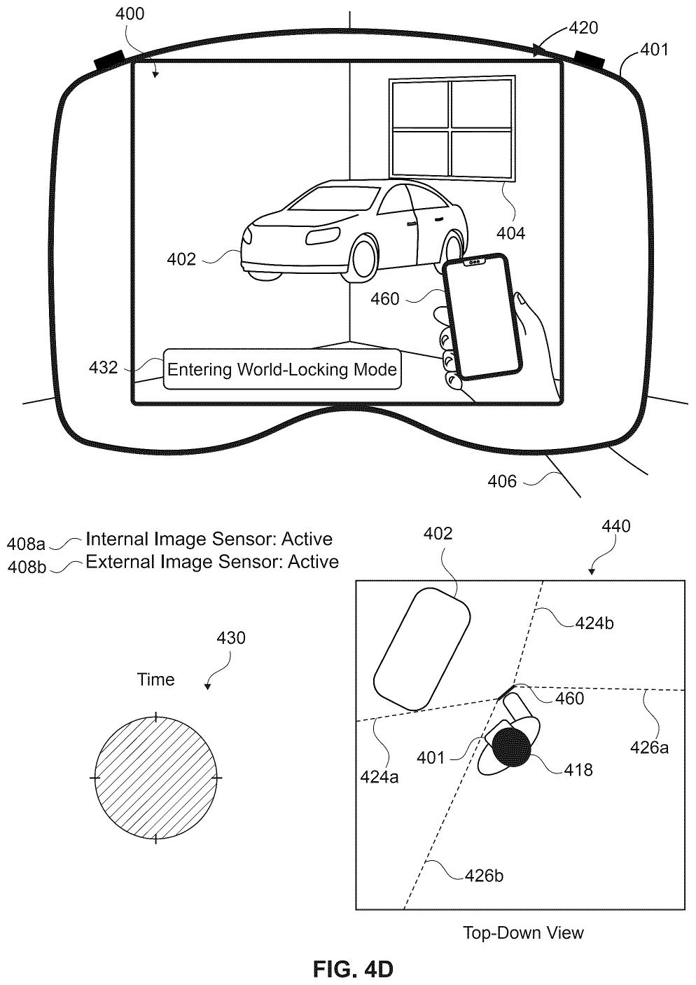

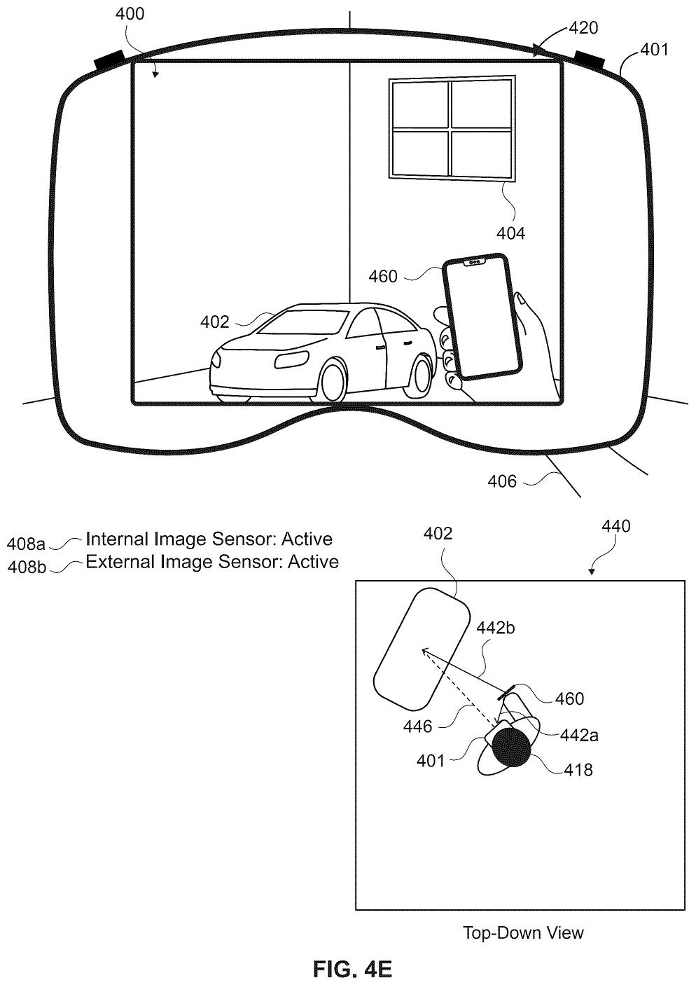

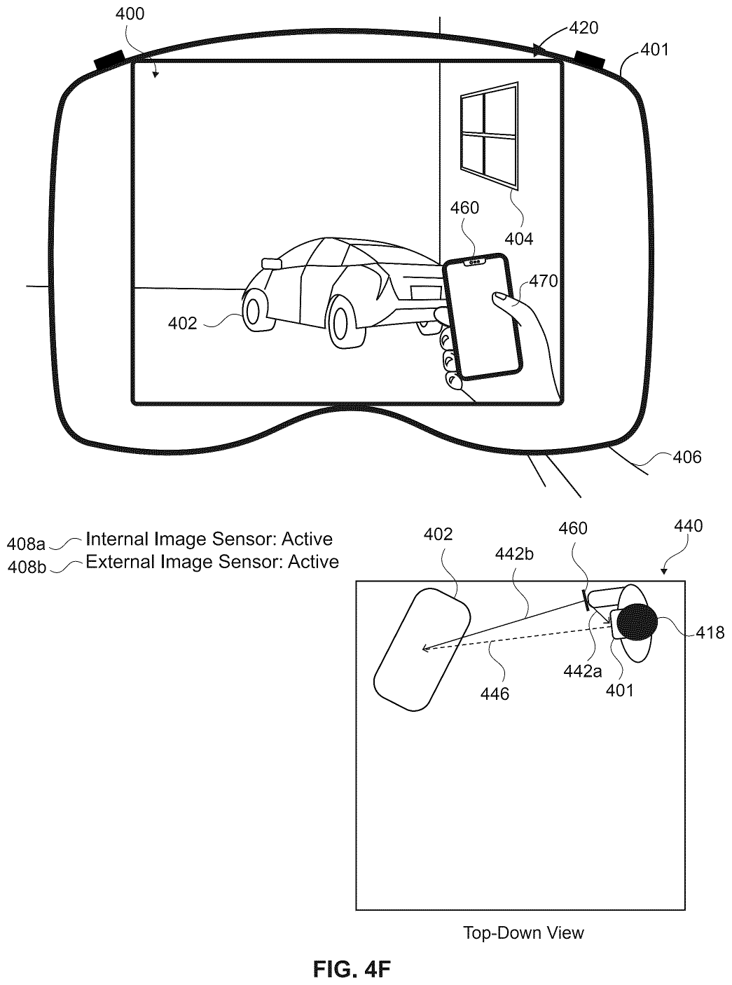

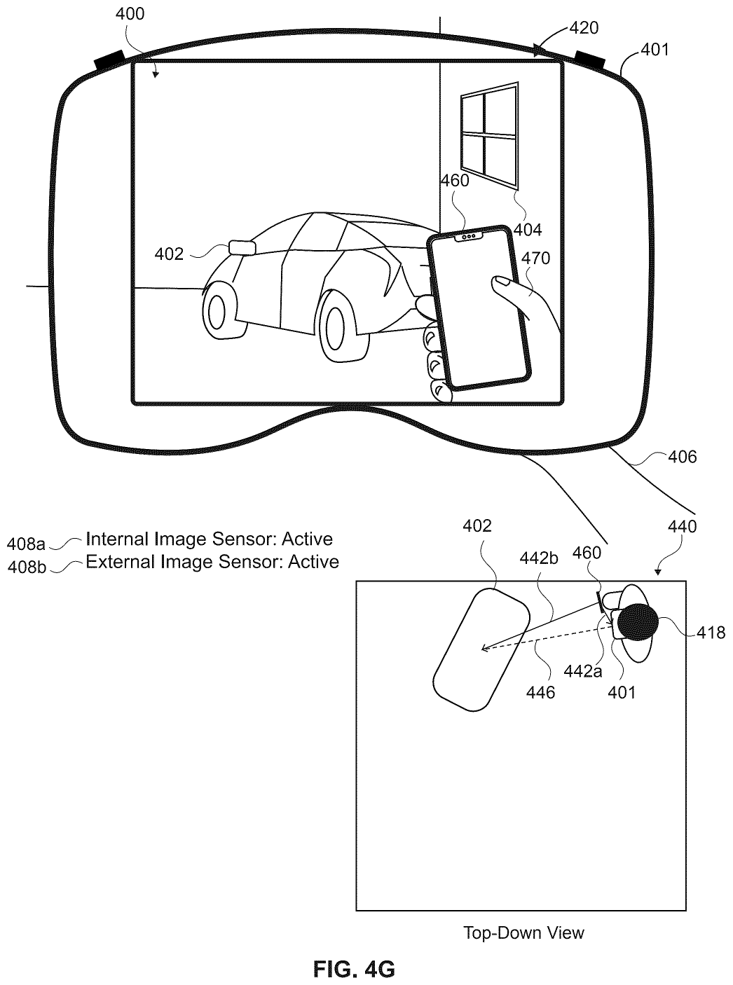

FIG. 3A illustrates first electronic device 301 presenting virtual object 302a in environment 300. In some examples, virtual object 302a corresponds to a virtual window that includes content associated with a respective application (e.g., a video messaging and/or videotelephony application). Although the processes and methods of FIGS. 3A-3J illustrate a virtual window (e.g., virtual object 302a), in some examples, the processes and methods of FIGS. 3A-3J are performed while different content is presented in environment 300 (e.g., content having one or more characteristics of virtual object 402 shown and described with reference to FIGS. 4A-4G). In some examples, first electronic device 301 presents virtual object 302a in environment 300 in a head-locked orientation (e.g., as described above and with reference to FIG. 3B). In some examples, first electronic device 301 presents virtual object 302a in environment 300 in a body-locked orientation (e.g., as described above and with reference to FIG. 3C). Alternatively, or additionally, in some examples, first electronic device 301 presents virtual object 302a in a tilt-locked orientation (e.g., as described above).

FIGS. 3A-3N include a top-down view 340 of environment 300. As shown in top-down view 340, a user 318 is shown wearing first electronic device 301 (e.g., a view of environment 300 shown within display 320 corresponds to a current field-of-view of user 318). For example, first electronic device 301 is a head-mounted display worn by user 318. Top-down view 340 further includes an overhead view of second electronic device 360. Second electronic device 360 is optionally a mobile device, such as a mobile phone, tablet computer, or laptop computer. In some examples, as shown in top-down view 340, second electronic device 360 rests on an object (e.g., real-world table 312) in environment 300 (e.g., as further shown in FIGS. 3D-3H).

In FIG. 3A, top-down view 340 includes a reference line corresponding to a distance 316 (“D1”) between user 318 and virtual object 302a in environment 300 (e.g., a depth offset). In some examples, distance 316 corresponds to a distance offset of virtual object 302a from a portion of user 318 (e.g., a torso of user 318, a head of user 318, etc.) (e.g., when virtual object 302a is presented in a body-locked orientation as shown and described with reference to FIG. 3B). In some examples, distance 316 corresponds to a distance offset of virtual object 302 from first electronic device 301 (e.g., when virtual object 302a is presented in a head-locked orientation as shown and described with reference to FIG. 3C).

FIG. 3B illustrates an example of first electronic device 301 presenting virtual object 302a in environment 300 in a body-locked orientation. As shown in FIG. 3B, user 318 rotates their current viewpoint (e.g., represented by arrow 322 in top-down view 340) relative to environment 300 (e.g., user 318 changes their head pose rightward (compared to as shown in FIG. 3A) while wearing first electronic device 301). In some examples, in response to detecting a change in orientation of first electronic device 301 (e.g., caused by the rotation of the current viewpoint of user 318 (e.g., in the pitch, roll, and/or yaw direction)), the computing system maintains display of virtual object 302a at the same position (e.g., location and/or orientation) in environment 300 shown in FIG. 3A. For example, as shown in top-down view 340, the computing system maintains distance 316 between a portion of user 318 (e.g., the user's torso) and virtual object 302a (e.g., such that a change in pose of first electronic device 301 in the pitch, yaw, or roll directions do not cause movement of virtual object 302a in environment 300). Translational movement of first electronic device 301 (e.g., as shown and described with reference to FIG. 3D) optionally causes first electronic device 301 to move virtual object 302a in environment 300 while virtual object 302a is presented in a body-locked orientation.

FIG. 3C illustrates an alternative example of first electronic device 301 presenting virtual object 302a in environment 300 in a head-locked orientation. As shown in FIG. 3C, user 318 rotates their current viewpoint (represented by arrow 322 in top-down view 340) relative to environment 300 (e.g., as shown and described with reference to FIG. 3B). In some examples, in response to detecting a change in orientation of first electronic device 301 (e.g., caused by the rotation of the current viewpoint of user 318), the computing system changes a position of virtual object 302a in environment 300 from the position shown in FIG. 3A. For example, as shown in top-down view 340, the computing system maintains distance 316 between first electronic device 301 (e.g., between a forward portion of first electronic device 301 and/or the head of user 318) and virtual object 302a (e.g., such that a change in pose of first electronic device 301 in the pitch, yaw, or roll directions cause movement of virtual object 302a in environment 300). Translational movement of first electronic device 301 (e.g., as shown and described with reference to FIG. 3D) optionally causes first electronic device 301 to move virtual object 302a in environment 300 while virtual object 302a is presented in a head-locked orientation.

FIG. 3D illustrates first electronic device 301 maintaining presentation of virtual object 302a in a body-locked orientation and/or head-locked orientation in environment 300 while first electronic device 301 moves translationally. In some examples, first electronic device 301 presents virtual object 302a in a body-locked orientation, and the computing system maintains distance 316 between the portion of user 318 (e.g., the torso of user 318) and virtual object 302a (e.g., such that translational movement (e.g., and not rotational movement) of user 318 and/or first electronic device 301 cause virtual object 302a to move in environment 300). Alternatively, in some examples, first electronic device 301 presents virtual object 302a in a head-locked orientation, and the computing system maintains distance 316 between first electronic device 301 and virtual object 302a (e.g., such that rotational or translational movement of first electronic device 301 cause virtual object 302a to move in environment 300).

As shown in FIG. 3D, second electronic device 360 and real-world table 312 are visible (e.g., in video passthrough or optical see-through) in environment 300 via display 320. Second electronic device 360 is optionally a tablet computer (e.g., including a display and a keyboard (e.g., as an attachment to the display)). Alternatively, in some examples, second electronic device 360 is a different type of electronic device (e.g., a mobile phone, desktop computer, or a laptop computer, etc.).

In some examples, second electronic device 360 includes one or more image sensors (e.g., having one or more characteristics of image sensor(s) 206B described with reference to FIG. 2B). For example, second electronic device 360 includes one or more internal image sensors (e.g., on the same side as a display of second electronic device 360 (e.g., with a viewpoint from a surface of second electronic device 360 directed toward user 318 in FIG. 3D)) and one or more external image sensors (e.g., on an opposite side of a display of second electronic device 360 (e.g., with a viewpoint from a surface of second electronic device 360 directed away from user 318 in FIG. 3D)). In the context of second electronic device 360, the term “internal image sensors” and the term “external image sensors” are meant to mirror the usage of “internal image sensors” and “external image sensors” of electronic device 101 in FIG. 1. Specifically, the “internal image sensors” capture images of the user of electronic device (e.g., face, eyes, etc.) while the user is observing the one or more displays of the electronic device, whereas the “external image sensors” typically capture images other than of the user of the electronic device. Optionally, in some examples, second electronic device 360 includes one or more internal image sensors and does not include one or more external image sensors (e.g., the methods and processes described with reference to FIGS. 3D-3J are performed with one or more internal image sensors and not with one or more external image sensors (e.g., second electronic device 360 is a laptop computer that does not include external image sensors)).

For reference, FIGS. 3D-3J include textual indications of statuses of an internal image sensor 308a of second electronic device 360 and an external image sensor 308b of second electronic device 360 (e.g., internal image sensor 308a and external image sensor 308 have one or more characteristics of image sensor(s) 206B described with reference to FIG. 2B). For example, the statuses of internal image sensor 308a and/or external image sensor 308b may be active or inactive, as described below. In some examples, internal image sensor 308a corresponds to a plurality of internal image sensors, and external image sensor 308b corresponds to a plurality of external image sensors (e.g., the computing system uses a plurality of internal image sensors and/or external image sensors of second electronic device 360 to present virtual content in a world-locked orientation in environment 300).

In some examples, when internal image sensor 308a of second electronic device 360 is active, second electronic device 360 is (e.g., actively (e.g., at a sampling rate that is above a threshold amount for supporting three-dimensional localization of virtual content in environment)) capturing images of the physical environment (e.g., the real-world environment) using internal image sensor 308a. For example, when internal image sensor 308a is active, internal image sensor 308 is capturing images at a rate that is at least 0.5, 0.75, 1, or 2 times the frame rate and/or refresh rate of display 320 (e.g., when internal image sensor 308a is inactive, internal image sensor 308a is capturing images at a rate that is less than 0.5, 0.75, 1, or 2 times the frame rate and/or refresh rate of display 320). For example, when internal image sensor 308a is active, second electronic device 360 is (e.g., actively) capturing movement of physical objects (e.g., first electronic device 301 and/or one or more portions (e.g., head, hand(s), and/or torso) of user 318) relative to the physical environment (e.g., and/or relative to second electronic device 360) using internal image sensor 308a. For example, when internal image sensor 308a is active, second electronic device 360 is (e.g., actively) detecting a position (e.g., distance and/or orientation) of physical objects (e.g., first electronic device 301 and/or one or more portions (e.g., head, hand(s), and/or torso) of user 318) relative to second electronic device 360 using internal image sensor 308a. In some examples, when internal image sensor 308a is inactive, second electronic device 360 is not capturing images (e.g., actively) of the physical environment using internal image sensor 308a (e.g., and is not capturing movement of physical objects and/or positions of physical objects using internal image sensor 308a). It should be appreciated that when internal image sensor 308a is in the inactive state, second electronic device 360 may optionally capture one or more images occasionally (e.g., not actively (e.g., to determine whether user 318 and/or first electronic device 301 is within a field-of-view of internal image sensor 308a)).

In some examples, when external image sensor 308b of second electronic device 360 is active, second electronic device 360 is capturing (e.g., actively) one or more images of the physical environment using external image sensor 308b. For example, when external image sensor 308b is active, second electronic device 360 is capturing (e.g., actively (e.g., at a sampling rate that is above a threshold amount for supporting three-dimensional localization of virtual content in environment 300)) movement of physical objects relative to the physical environment (and/or relative to second electronic device 360) using external image sensor 308b. For example, when external image sensor 308b is active, external image sensor 308b is capturing images at a rate that is at least 0.5, 0.75, 1, or 2 times the frame rate and/or refresh rate of display 320 (e.g., when external image sensor 308b is inactive, external image sensor 308b is capturing images at a rate that is less than 0.5, 0.75, 1, or 2 times the frame rate and/or refresh rate of display 320). For example, when external image sensor 308b is active, second electronic device 360 is detecting a position (e.g., distance and/or orientation) of physical objects relative to second electronic device 360 using external image sensor 308b. In some examples, when external image sensor 308b is inactive (e.g., as shown in FIGS. 3D-3N), second electronic device 360 is not capturing images of the physical environment (e.g., actively) using external image sensor 308b (e.g., and is not capturing movement of physical objects and/or positions of physical objects using external image sensor 308b). It should be appreciated that when external image sensor 308b is in the inactive state, second electronic device 360 may optionally capture one or more images occasionally (e.g., not actively).

In some circumstances, a user of the computing system (e.g., user 318) may desire to present content (e.g., virtual object 302a) in environment 300 in a world-locked orientation (e.g., such that the performance and user experience are improved by presenting the user with content that is responsive to more freedom of movement (e.g., six degrees of freedom of movement) relative to the content in environment 300). Accordingly, in some examples, the computing system may present virtual object 302a in a world-locked orientation in environment 300 in accordance with a determination that one or more criteria are satisfied. For example, the one or more criteria include a criterion that is satisfied when the computing system detects a position (e.g., a pose (e.g., location and/or orientation)) of first electronic device 301 and/or one or more portions of user 318 (e.g., the head, face, and/or eyes of user 318). In some examples, the computing system detects the position of first electronic device 301 and/or the one or more portions of user 318 using internal image sensor 308a of second electronic device 360 (e.g., first electronic device 301 does not include one or more input devices for detecting the one or more portions of user 318, as described above).

In FIG. 3D, internal image sensor 308a and external image sensor 308b of second electronic device 360 are inactive. In some examples, in FIG. 3D, the computing system maintains presentation of virtual object 302 in environment 300 in a body-locked orientation (e.g., as shown and described with reference to FIG. 3B) or a head-locked orientation (e.g., as shown and described with reference to FIG. 3C) because internal image sensor 308a and/or external image sensor 308b are inactive (e.g., and a position of first electronic device 301 and/or the one or more portions of user 318 are not (e.g., actively) detected by the computing system using second electronic device 360).

FIG. 3E illustrates second electronic device 360 activating internal image sensor 308a (e.g., external image sensor 308b remains inactive). In some examples, second electronic device 360 activates internal image sensor 308a in response to user input. For example, user 318 selects a selectable option (e.g., presented in environment 300 on first electronic device 301 or via a display of second electronic device 360) that is selectable to present virtual object 302a in a world-locked orientation (e.g., the selectable option is presented within a user interface of the respective application that is associated with virtual object 302a, or is presented by the computing system in accordance with one or more system settings). For example, user 318 provides a verbal input (e.g., a verbal command detected by one or more audio sensors (e.g., having one or more characteristics of microphone(s) 213A and/or 213B described with reference to FIGS. 2A-2B) of first electronic device 301 and/or second electronic device 360) corresponding to a request to present virtual object 302a in a world-locked orientation. In some examples, second electronic device 360 activates internal image sensor 308a automatically (e.g., without user input). For example, second electronic device 360 activates internal image sensor 308a in accordance with a determination that second electronic device 360 has moved by less than a threshold amount (e.g., less than 0.01, 0.05, 0.1, 0.2, 0.5, or 1 meter) over a predetermined period of time (e.g., 1, 2, 5, 10, 15, 30, 60, or 120 seconds), such as is shown and described with reference second electronic device 460 in FIGS. 4C-4D. For example, second electronic device 360 activates internal image sensor 308a in accordance with a determination that one or more user settings (e.g., stored in a user profile associated with user 318) have one or more respective values (e.g., user 318 previously activated a setting that permits the computing system to world-lock content (e.g., from one or more specified applications) in environment 300 (e.g., when user 318 is within a field-of-view of internal image sensor 308a and second electronic device 360 has moved by less than the threshold amount over the predetermined period of time).

In FIG. 3E, after activating internal image sensor 308a, the computing system detects a position of first electronic device 301 and/or the one or more portions (e.g., head, face, and/or eyes) of user 318. Top-down view 340 includes a schematic representation (represented by reference lines 324a and 324b) of a field-of-view of second electronic device 360 (e.g., the field-of-view corresponds to a region of environment 300 that is captured using internal image sensor 308a). For example, second electronic device 360 captures images of the region of environment 300 included between reference line 324a and 324b, which includes user 318 and first electronic device 301. Further, in FIG. 3E, top-down view 340 includes a vector 326 extending from second electronic device 360 to first electronic device 301 (and/or user 318). In some examples, vector 326 is a schematic representation of second electronic device 360 detecting a position of first electronic device 301 and/or the one or more portions of user 318.

In some examples, in FIG. 3E, the computing system uses internal image sensor 308 to detect the position of first electronic device 301 and/or the one or more portions of user 318 relative to second electronic device 360. Using the detected position of first electronic device 301 and/or the one or more portions of user 318 relative to second electronic device 360, the computing system optionally determines the position of second electronic device 360 relative to first electronic device 301 and/or the one or more portions of user 318 (e.g., by inversing the detected relationship between the position of first electronic device 301 (and/or the one or more portions of user 318) and second electronic device 360). Accordingly, in some examples, such as in FIG. 3E, the computing system determines the position of second electronic device 360 relative to the current viewpoint of user 318 (and/or relative to the current pose of first electronic device 301) to enable first electronic device 301 to present virtual object 302a in a world-locked orientation relative to the location of second electronic device 360 in environment 300 (e.g., virtual object 302a is presented as anchored relative to the location of second electronic device 360 in environment 300). Additionally or alternatively, in some examples, the computing system uses simultaneous localization and mapping (SLAM) techniques to determine the pose of first electronic device 301 relative to second electronic device 360 (e.g., and uses this information to present virtual object 302a as anchored relative to the location of second electronic device 360 in environment 300).

FIGS. 3E-3F illustrate first electronic device 301 presenting an animation in environment 300. For example, the animation corresponds to a transition from presenting virtual object 302a in a body-locked orientation or head-locked orientation to presenting virtual object 302 in a world-locked orientation. As shown in FIG. 3E, the animation includes presenting a virtual element 310 above second electronic device 360 in environment 300. For example, virtual element 310 corresponds to a docking location of virtual object 302a in environment 300 (e.g., a location that virtual object 302a will be displayed anchored to in environment 300 while presented in the world-locked orientation). From FIG. 3E to FIG. 3F, the animation includes moving virtual object 302a to virtual element 310 (e.g., such that virtual object 302a is presented as docked on virtual element 310 in environment 300). Alternatively, in some examples, first electronic device 301 does not present virtual element 310 (e.g., and/or an animation corresponding to the transition in environment 300). For example, first electronic device 301 presents a visual indication in environment 300, such as visual indication 432 shown and described with reference to FIG. 4D.

Although virtual object 302a is presented in FIG. 3F above second electronic device 360 in environment 300, in some examples, first electronic device 301 presents virtual object 302a at a different location relative to second electronic device 360 (e.g., on a side of second electronic device 360 or overlaid on a physical display of second electronic device 360 (e.g., second electronic device 360 turns off the physical display and/or operates the physical display in a power-saving mode)).

FIG. 3G illustrates user 318 (and first electronic device 301) moving in environment 300 while first electronic device 301 presents virtual object 302a in the world-locked orientation relative to the location of second electronic device 360. As shown in FIG. 3G (e.g., in top-down view 340), user 318 moves rightward in environment 300 (e.g., while wearing first electronic device 301). In some examples, as shown in top-down view 340, user 318 moves to a location that is within the field-of-view of internal image sensor 308a of second electronic device 360 (user 318 is shown in top-down view 340 between reference lines 324a and 324b). For example, the computing system continues to track the position of the one or more portions of user 318 (e.g., the head and/or eyes of user 318) and/or first electronic device 301 relative to second electronic device 360 using internal image sensor 308a, as represented by vector 326 in top-down view 340 (e.g., and the computer system continues to determine the position of second electronic device 360 relative to the current viewpoint of user 318 (and/or relative to the current pose of first electronic device 301)). Accordingly, for example, in FIG. 3G, in response to the movement of user 318 and first electronic device 301 in environment 300, first electronic device 301 maintains presentation of virtual object 302a at the same location (and/or orientation) in environment 300 compared to as shown in FIG. 3F (e.g., above second electronic device 360 (e.g., docked on virtual element 310)).

FIG. 3H illustrates user 318 (and first electronic device 301) moving to a location in environment 300 that is outside of the field-of-view of internal image sensor 308a of second electronic device 360. For example, as shown in top-down view 340, a first electronic device 301 and user 318 is outside of the field-of-view of second electronic device 360 (represented by reference lines 324a and 324b). In some examples, the movement of user 318 in FIG. 3H causes the computing system to no longer detect a current position of the portion of user 318 (e.g., head and/or eyes of user 318) and/or first electronic device 301 (e.g., and the computing system ceases to determine a current position of second electronic device 360 relative to the current viewpoint of user 318 and/or the current pose of first electronic device 301). Accordingly, for example, in FIG. 3H, first electronic device 301 presents an animation in environment 300. For example, the animation corresponds to a transition from presenting virtual object 302a in the world-locked orientation (e.g., relative to the location of second electronic device 360 in environment 300) to a head-locked orientation or body-locked orientation (e.g., to the manner first electronic device 301 presented virtual object 302a in environment 300 prior to presenting virtual object 302a in the world-locked orientation). In some examples, the animation includes ceasing to present virtual object 302a in environment 300. For example, as shown in FIG. 3H, ceasing to present virtual object 302a includes modifying one or more visual characteristics of virtual object 302a (represented by a change in fill pattern of virtual object 302a), such as by increasing a transparency of virtual object 302a (e.g., gradually (e.g., over a period of time, such as 0.1, 0.2, 0.5, 1, 2, 5, or 10 seconds) until virtual object 302a is not visible in environment 300 from the current viewpoint of user 318). In some examples, after ceasing to present virtual object 302a in environment 300, first electronic device 301a presents the content included in virtual object 302a in environment 300 in a head-locked orientation or a body-locked orientation (e.g., as shown and described with reference to FIGS. 3I-3J).

FIG. 3I illustrates first electronic device 301 presenting content in a picture-in-picture representation in environment 300 in a head-locked orientation or a body-locked orientation. In some examples, in accordance with a determination that internal image sensor 308a no longer detects the current position of the one or more portions of user 318 and/or first electronic device 301, first electronic device 301 transitions from presenting virtual object 302a in the world-locked orientation (e.g., as shown in FIGS. 3I-3J) to presenting a picture-in-picture representation (e.g., virtual object 302b) in environment 300 in a head-locked orientation or a body-locked orientation. For example, as shown in FIG. 3I, first electronic device 301 presents, via display 320, a virtual object 302b in a picture-in-picture representation. In some examples, virtual object 302b includes the same content presented by virtual object 302a in FIGS. 3A-3H (e.g., virtual object 302b includes a representation of a participant in a communication session with user 318). For example, virtual object 302b is a picture-in-picture version of virtual object 302a (e.g., virtual object 302b is presented with a smaller size than virtual object 302a and offset (e.g., in a corner) in the field-of-view of user 318). First electronic device 301 optionally transitions from presenting virtual object 302b to presenting virtual object 302a in response to user input corresponding to a request to exit the picture-in-picture presentation. For example, the user input includes selection of a selectable option (e.g., presented in environment 300), a verbal command, a touch input (e.g., on a touch-sensitive surface of first electronic device 301 and/or second electronic device 360), and/or actuation of one or more hardware input devices (e.g., buttons, switches, and/or knobs) of first electronic device 301 and/or second electronic device 360.

In some examples, in accordance with a determination that second electronic device 360 does not detect the one or more portions of user 318 and/or first electronic device 301 (e.g., over a predetermined period of time (e.g., 0.1, 0.2, 0.5, 1, 2, 5, or 10 seconds)), the second electronic device 360 deactivates internal image sensor 308a. For example, as shown in FIG. 3I (and FIG. 3J), the status of internal image sensor 308a is inactive.

FIG. 3J illustrates an alternative example to FIG. 3I in which first electronic device 301 presents virtual object 302a in environment 300 in a head-locked orientation or a body-locked orientation in response to the movement of user 318 and first electronic device 301 outside of the field-of-view of internal image sensor 308a (e.g., first electronic device 301 presents virtual object 302a in the manner first electronic device 301 presented virtual object 302a in prior to presenting virtual object 302a in the world-locked orientation). In some examples, in accordance with a determination that internal image sensor 308a no longer detects the current position of the one or more portions of user 318 and/or first electronic device 301, first electronic device 301 transitions from presenting virtual object 302a in the world-locked orientation to presenting virtual object 302a in a head-locked orientation or a body-locked orientation. For example, as shown in FIG. 3I, first electronic device 301 presents virtual object 302a in environment 300 with distance 316 between user 318 and virtual object 302a (shown in top-down view 340). For example, first electronic device 301 presents virtual object 302a in environment 300 with the same distance and/or orientation offset from a portion of user 318 (e.g., a torso of user 318) as virtual object 302a was presented with prior to being presented in the world-locked orientation (e.g., when virtual object 302a is presented in a body-locked orientation prior to being presented in the world-locked orientation, as shown in FIG. 3B). For example, first electronic device 301 presents virtual object 302a in environment 300 with the same distance and/or orientation offset from first electronic device 301 as prior to being presented in the world-locked orientation (e.g., when virtual object 302a is presented in a head-locked orientation prior to being presented in the world-locked orientation, as shown in FIG. 3C).

As described herein, in some examples, virtual content is optionally displayed, via a first electronic device, in a three-dimensional environment relative to a second electronic device. In some such examples, virtual content is optionally displayed world-locked relative to the second electronic device (e.g., using image sensors of the second electronic device to track the position of the user and/or the position of the first electronic device). In some such examples, the user can transfer content between the virtual content displayed via a first electronic device (e.g., a window or application) and content displayed via a display of the second electronic device. In some such examples, changes in orientation of the display of the second electronic device can be detected (e.g., using a hinge sensor), and the display of virtual content relative to the second electronic device can be adjusted relative to the orientation of the display of the second electronic device. For example, the display plane of the virtual content can be locked to a plane of the display of the second electronic device. World locking the content optionally enables richer user experiences and improved interactions by displaying of additional content (compared with that of the physical display of the second electronic device) in positions that are spatially stable relative to the content on the display of the second electronic device. Additionally or alternatively, aligning the display of the additional content with the display of the second electronic device can improve the user experience because the additional content is aligned with (and not disjointed from) the content on the display of the second electronic device.

FIGS. 3K-3L illustrate the computing system presenting first content 362 via one or more displays (e.g., display 320) of first electronic device 301 in environment 300 while concurrently presenting second content 368 via a display of second electronic device 360. As shown in FIG. 3K, the computing system optionally presents first content 362 adjacent to the display of second electronic device 360 in environment 300 (e.g., outside of the display region of second electronic device 360 and/or within a threshold distance (e.g., 0.01, 0.02, 0.05, 0.1, 0.2, 0.5, or 1 meter) of the perimeter of the display of second electronic device 360). First content 362 is optionally associated with second content 368. For example, second content 368 is content associated with a respective application accessible by user 318 via second electronic device 360 (and its associated input devices), and first content 362 is supplemental content that is associated with the respective application (e.g., one or more widgets associated with the respective application). Additionally or alternatively, in some examples, second content 368 is associated with a first application that is accessible via second electronic device 360 (e.g., second content 368 is website content accessed via a web-browsing application), and first content 362 is associated with one or more second applications, different from the first application, that are accessible via second electronic device 360 (e.g., first content 362 includes widgets for the one or more second applications).

Additionally or alternatively, in some examples, the computing system causes second content 368 to be presented by first electronic device 301 in environment 300 overlaid on the display of second electronic device 360. For example, the computing system operates second electronic device 360 in a power-saving state (e.g., that includes not actively operating the display of second electronic device 360), and the computing system generates second content 368 to be presented overlaid on the display of second electronic device 360 while the display of second electronic device 360 is not operational (e.g., while concurrently presenting first content 362 adjacent to the display of second electronic device 360).

In some examples, as shown in FIG. 3K, the computing system causes first electronic device 301 to present first content 362 (e.g., and optionally second content 368) in a world-locked orientation relative to second electronic device 360 (e.g., as described above with reference to virtual object 302a). For example, in FIG. 3K, internal image sensor 308a is activated (e.g., as described with reference to FIG. 3E). For example, in FIG. 3K, the computing system determines that the one or more criteria for presenting content in a world-locked orientation in environment 300 are satisfied (e.g., as described above). For example, the computing system detects a position (e.g., a pose (e.g., location and/or orientation)) of first electronic device 301 and/or the one or more portions of user 318 using internal image sensor 308a of second electronic device 360. The computing system optionally causes first electronic device 301 to present first content 362 (e.g., and/or second content 368) in environment 300 in response to determining that the one or more criteria for presenting the content in a world-locked orientation in environment are satisfied (e.g., in accordance with a determination that the one or more criteria are not satisfied, the computing system forgoes presenting first content 362 in environment 300).

In some examples, second electronic device 360 includes an input device configured to detect a current orientation of the display of second electronic device 360. For example, the input device includes an orientation sensor (e.g., having one or more characteristics of orientation sensor(s) 210B), a hinge sensor (e.g., measuring an angle of the hinge between a base and a display of a laptop), and/or a lid sensor configured to detect a current orientation of the display. In some examples, in response to detecting a change in orientation of the display of second electronic device 360, the computing system causes the display orientation of first content 362 in environment 300 to change (e.g., such that the current orientation of first content 362 matches and/or aligns with the current orientation of the display of second electronic device 360).

From FIG. 3K to FIG. 3L, the computing system detects, via one or more input devices of second electronic device 360 (e.g., using the input device configured to detect the current orientation of the display of second electronic device 360), a change in orientation of the display of second electronic device 360. In some examples, in response to detecting the change in orientation of the display of second electronic device 360, the computing system changes the display orientation of first content 362 (e.g., and optionally second content 368) in environment 300 (e.g., to remain aligned with the current orientation of the display of second electronic device 360). For example, as shown in FIG. 3K, while the current orientation of the display of second electronic device 360 is at a first orientation, the computing system presents first content 362 with a first spatial relationship (e.g., with a first position (e.g., location and/or orientation) and/or spatial arrangement) relative to the display of second electronic device 360 at the first orientation in environment 300. For example, as shown in FIG. 3L, in response to detecting the change in the current orientation of the display of second electronic device 360 from the first orientation to a second orientation, different from the first orientation, the computing system maintains presentation of first content 362 with the first spatial relationship (e.g., the first position (e.g., location and/or orientation) and/or spatial arrangement) relative to the display of second electronic device 360 at the second orientation in environment 300.

In some examples, as shown in FIGS. 3K-3L, user 318 and first electronic device 301 remain within the field-of-view of internal image sensor 308 of second electronic device 360 (e.g., represented by reference lines 324a and 324b in top-down view) during the change in orientation of the display of second electronic device 360. For example, because the user 318 and/or first electronic device 301 remain within the field-of-view of internal image sensor 308, the computing system maintains presentation of first content 362 (e.g., and optionally second content 368) in the world-locked orientation relative to second electronic device 360 in environment 300.

In some examples, to enable display of world-locked content relative to the second electronic device 360, the computing system assumes that the base of the second electronic device 360 is gravity-locked (e.g., the base on a laptop computer is on a surface orthogonal to the gravity vector). Additionally or alternatively, the computing system assumes a seating position of the user relative to the second electronic device 360 (e.g., distance from user to the display of the second electronic device 360). In some examples, using the assumed orientation of the base, the assumed seating position of the user relative to the second electronic device 360, and the sensed angle, the computing system is able to display the virtual content at a depth and with an orientation angle relative to the gravity vector. In some examples, rather than assuming the orientation and seating position of the user relative to the second electronic device 360, images sensors (e.g., cameras) of electronic device 101 or the second electronic device 360 can be used to determine the relative distance and orientation between electronic device 101 or the second electronic device 360, as described herein).

In some examples, the computing system displays the virtual content relative to the second electronic device in accordance with detecting user intent to interact or interaction with the second electronic device (optionally forgoing display until intent to interact or interaction is detected). For example, a change in angle indicative of adjusting the display orientation and/or input to the second electronic device (e.g., keyboard, trackpad, or mouse input) can be indicative of intent to interact or interaction with the second electronic device.

Referring back to FIG. 1, in some examples, the position and/or orientation of electronic device 160 relative to the electronic device 101 may be used as an input for a computing system including electronic device 101 and/or electronic device 160. This use of position and/or orientation provides for an additional input modality which can enables richer improved user experiences and improved interactions. FIGS. 3M-3N illustrate the computing system performing an action in response to detecting alignment of second electronic device 360 with an alignment user interface element in environment 300. In some examples, FIGS. 3M-3N show an alternative example of second electronic device 360 (e.g., illustrated as a mobile phone) compared to the example of second electronic device 360 illustrated in FIGS. 3A-3L (e.g., illustrated as a laptop computer). For example, in FIGS. 3M-3N, user 318 holds second electronic device 360 with hand 306.

FIG. 3M illustrates the computing system causing presentation of alignment user interface element 364 via display 320 of first electronic device 301. For example, alignment user interface element 364 is optionally associated with a process for calibrating tracking (e.g., using internal image sensor 308a) of the one or more portions of user 318 (e.g., as described above) and/or first electronic device 301. Alternatively, for example, alignment user interface element 364 is associated with a respective application accessible via first electronic device 301 and/or second electronic device 360. For example, alignment user interface element 364 is associated with a mobile payment service (e.g., alignment user interface element 364 is used to provide confirmation prior to authorizing a transaction through the mobile payment service) or unlocking an application or device.

In some examples, the computing system causes alignment user interface element 364 to be presented in a body-locked orientation or a head-locked orientation in environment 300 (e.g., as described above). In some examples, as shown in FIG. 3M, the computing system presents alignment user interface element 364, via display 320 of first electronic device 301, in environment 300 while operating internal image sensor 308a in an active state. For example, as shown in top-down view 340, second electronic device 360 actively tracks the one or more portions of user 318 and/or first electronic device 301 (e.g., user 318 and first electronic device 301 are within the current field-of-view of second electronic device 360, as represented by reference lines 324a and 324b).

Alternatively, for example, the computing system causes alignment user interface element 364 to be presented in a world-locked orientation in environment 300 (e.g., at a location independent of a current location of second electronic device 360, as described with reference to FIGS. 4A-4G). For example, the computing system presents alignment user interface 364 while operating internal image sensor 308a and external image sensor 308b in an active state (e.g., as shown and described with reference to internal image sensor 408a and external image sensor 408b in FIGS. 4D-4G).

From FIG. 3M to FIG. 3N, while the computing system detects the one or more portions of user 318 and/or first electronic device 301 using internal image sensor 308a of second electronic device 360, user 318 moves second electronic device 360 toward alignment user interface element 364 in environment 300. In some examples, in FIG. 3N, the computing system determines that the location and/or orientation of second electronic device 360 corresponds to alignment user interface element 364 (e.g., visually aligns with user interface element 364 from the current viewpoint of user 318). For example, the computing system determines that second electronic device 360 is aligned with alignment user interface element 364 using internal image sensor 308a (e.g., the computing system presents alignment user interface element 364 at an optionally fixed, center display position relative to current viewpoint of user 318, and the computing system determines that second electronic device 360 is aligned with user interface element 364 when the computing system detects, via internal image sensor 308a, that second electronic device 360 is aligned with a center portion of first electronic device 301 and/or a center portion of display 320). Additionally or alternatively, the computing system determines alignment when maintained for a threshold period of time (e.g., the second electronic moves by less than a threshold amount (e.g., less than 0.01, 0.05, 0.1 meters, etc.) over a predetermined period of time (e.g., 0.1, 0.25, 0.5, 1, 2 seconds, etc.). Additionally or alternatively, for example, the computing system determines that second electronic device 360 is aligned with alignment user interface element 364 in response to user input (e.g., when second electronic device 360 is visually aligned with alignment user interface element 364 from the current viewpoint of user 318, user 318 actuates an hardware input device (e.g., a hardware button) of second electronic device 360 and/or provides a touch input on a touch-sensitive surface (e.g., a touch-sensitive display) of second electronic device 360). Additionally or alternatively, for example, the computing system causes presentation of alignment user interface 364 in a world-locked orientation in environment 300 independent of a location of second electronic device 360 (e.g., as described above), and the computing system determines that second electronic device 360 is aligned with alignment user interface element 364 using internal image sensor 308a and external image sensor 308b (e.g., to determine the position (e.g., location and/or orientation) of second electronic device 360 relative to environment 300 and/or user 318).

In FIG. 3N, in response to detecting alignment of second electronic device 360 with alignment user interface element 364, the computing system optionally performs an action. In some examples, the action includes visual, audio, or haptic feedback, via the first electronic device or the second electronic device 360, indicative of successful alignment. For example, FIG. 3N illustrates a visual confirmation presented via first electronic device 301 or second electronic device 360. For example, the computing system stores calibration information (e.g., associated with tracking via the images sensors) in a memory of the computing system. For example, the computing system performs an action associated with a respective application (e.g., authorizes a transaction to be made through a mobile payment service).

FIGS. 4A-4G illustrate a computing system presenting virtual content in a world-locked orientation in a three-dimensional environment according to some examples of the disclosure. For example, the computing system presents the virtual content relative to a respective location in the three-dimensional environment that is independent of a location of a companion device in the three-dimensional environment. In some examples, the computing system includes a first electronic device 401 (e.g., having one or more characteristics of electronic device 101, 201, and/or 301) and a second electronic device 460 (e.g., having one or more characteristics of electronic device 160, 260, and/or 360). In some examples, the computing system includes first electronic device 301, and the first electronic device 301 is configured to be in communication with second electronic device 360 (e.g., second electronic device 360 is an auxiliary and/or companion device in communication with first electronic device 301).

As shown in FIGS. 4A-4G, first electronic device 401 includes a display 420 (e.g., having one or more characteristics of display 120, 320, and/or display generation component(s) 214A). In some examples, display 420 includes multiple display generation components (e.g., first electronic device 401 is a head-mounted display including two stereo displays).

In FIGS. 4A-4G, an environment 400 is visible via display 420. In some examples, environment 400 has one or more characteristics of environment 300 shown and described with reference to FIGS. 3A-3N. For example, from a current viewpoint of a user of first electronic device 401, one or more virtual objects (e.g., virtual object 402 shown in FIG. 4A) are presented in environment 400 while one or more physical objects (e.g., real-world window 404) from a physical environment of the user are visible (e.g., through video passthrough or optical see-through of the physical environment).

FIG. 4A illustrates first electronic device 401 presenting virtual object 402 in environment 400. In some examples, virtual object 402 corresponds to a virtual representation of a physical object (e.g., a car). In some examples, virtual object 402 is associated with a respective application that is accessible via first electronic device 401 and/or second electronic device 460 (shown in FIGS. 4C-4G). Although the processes and methods of FIGS. 4A-4G illustrate a virtual representation of a physical object (e.g., virtual object 402), in some examples, the processes and methods of FIGS. 4A-4G are performed while different content is presented in environment 400 (e.g., content having one or more characteristics of virtual object 302a and/or 302b shown and described with reference to FIGS. 3A-3J). In some examples, first electronic device 401 presents virtual object 402 in environment 400 in a head-locked orientation. In some examples, first electronic device 401 presents virtual object 402 in environment 400 in a body-locked orientation. Alternatively, or additionally, in some examples, first electronic device 401 presents virtual object 402 in a tilt-locked orientation (e.g., as described above).

FIGS. 4A-4G include a top-down view 440 of environment 400. As shown in top-down view 440, a user 418 is shown wearing first electronic device 401 (e.g., a view of environment 400 shown within display 420 corresponds to a current field-of-view of user 418). For example, first electronic device 401 is a head-mounted display worn by user 418.

In FIG. 4A, a reference line is shown in top-down view 440 corresponding to a distance 416 (“D1”) between user 418 and virtual object 402 (e.g., a depth offset). In some examples, distance 416 corresponds to a distance offset of virtual object 402 from one or more portions of user 418 (e.g., a torso of user 418, a head of user 418, etc.) (e.g., first electronic device 401 presents virtual object 402 in a body-locked orientation in environment 400). In some examples, distance 416 corresponds to a distance offset of virtual object 402 from first electronic device 401 (e.g., first electronic device 401 presents virtual object 402 in a head-locked orientation in environment 400). Further, in top-down view 440, a representation of an orientation 422 (“θ1”) of virtual object 402 is shown. In some examples, orientation 422 corresponds to an orientation offset of virtual object 402 from one or more portions of user 418 (e.g., a torso of user 418) (e.g., first electronic device 401 presents virtual object 402 in a body-locked orientation in environment 400). In some examples, orientation 422 corresponds to an orientation offset of virtual object 402 from first electronic device 401 (e.g., first electronic device 401 presents virtual object 402 in a head-locked orientation in environment 400).

FIG. 4B illustrates first electronic device 401 moving virtual object 402 in environment 400 (e.g., compared to the position of virtual object 402 in environment 400 shown in FIG. 4A) in response to translational movement of first electronic device 401. For example, as shown in FIG. 4B, the computing system maintains the spatial relationship (e.g., distance 416 and orientation 422) between first electronic device 401 (e.g., and/or user 418) and virtual object 402 during the translational movement of first electronic device 401. In some examples, first electronic device 401 presents virtual object 402 in a body-locked orientation, and the computing system maintains distance 416 and orientation 422 between the portion of user 418 (e.g., the torso of user 418) and virtual object 402 (e.g., such that translational movement of user 418 and/or first electronic device 401 cause virtual object 402 to move in environment 400). Alternatively, in some examples, first electronic device 401 presents virtual object 402 in a head-locked orientation, and the computing system maintains distance 416 and orientation 422 between first electronic device 401 and virtual object 402 (e.g., such that translational movement of first electronic device 401 causes virtual object 402 to move in environment 400).

FIG. 4C illustrates user 418 holding second electronic device 460 with hand 406 in environment 400. In some examples, as shown in FIG. 4C, second electronic device 460 is a mobile phone (e.g., that is in communication with first electronic device 401). Alternatively, second electronic device 460 is optionally a different type of electronic device, such as a tablet computer, laptop computer, or smart watch. In some examples, second electronic device 460 includes one or more internal image sensors (e.g., on a same side as a display of second electronic device 460 (e.g., with a viewpoint from a surface of second electronic device 460 directed toward user 418 in FIG. 4C)) and one or more external image sensors (e.g., on an opposite side of a display of second electronic device 460 (e.g., with a viewpoint from a surface of second electronic device 460 directed away from user 418 in FIG. 4C)).

For reference, FIGS. 4C-4G include textual indications of statuses of an internal image sensor 408a of second electronic device 460 and an external image sensor 408b of second electronic device 460 (e.g., internal image sensor 408a and external image sensor 408b have one or more characteristics of image sensor(s) 206B described with reference to FIG. 2B). For example, the statuses of internal image sensor 408a and/or external image sensor 408b may be active or inactive (e.g., having one or more characteristics of the active and/or inactive statuses of internal image sensor 308a and/or external image sensor 308b described with reference to FIGS. 3D-3J). In some examples, internal image sensor 408a corresponds to a plurality of internal image sensors and external image sensor 408b corresponds to a plurality of external image sensors (e.g., the computing system uses a plurality of internal image sensors and/or external image sensors of second electronic device 460 to present virtual content in a world-locked orientation in environment 400).

In some circumstances, a user of the computing system (e.g., user 418) may desire first electronic device 401 to present content (e.g., virtual object 402) in environment 400 in a world-locked orientation (e.g., such that the performance and user experience are improved by presenting the user with content that is responsive to more freedom of movement (e.g., six degrees of freedom of movement) relative to the content in environment 400). In some examples, first electronic device 401 may present virtual object 402 in a world-locked orientation relative to a location of second electronic device 460 in environment 400 (e.g., using the methods and/or processes shown and described with reference to FIGS. 3A-3N). For example, the computing system may use internal image sensor 408a of second electronic device 460 to detect a position of one or more portions of user 418 (e.g., a head, face, and/or eyes of user 418) and/or first electronic device 401 (e.g., a pose of first electronic device 401) relative to second electronic device 460 (e.g., and determine the location of second electronic device 460 relative to the current viewpoint of user 418 and/or the current pose of first electronic device 401). Alternatively, as described below with reference to FIGS. 4C-4G, first electronic device 401 may present virtual object 402 in a world-locked orientation relative to a location in environment 400 that is at least partially independent of a location and/or orientation of second electronic device 460 (e.g., such that movement of second electronic device 460 in environment 400 does not cause corresponding movement of virtual object 402 in environment 400). For example, the computing system may use internal image sensor 408a and external image sensor 408b of second electronic device 460 to present virtual object 402 in the world-locked orientation at a location and/or orientation in environment 400 that is independent from the location and/or orientation of second electronic device 460 in environment 400 (e.g., as described below).

In some examples, the computing system may present virtual object 402 in a world-locked orientation in environment 400 at a location and/or orientation independent from the location and/or orientation of second electronic device 460 in accordance with a determination that one or more criteria are satisfied. For example, the one or more criteria have one or more characteristics of the one or more criteria for presenting virtual object 302a in the world-locked orientation described above with reference to FIGS. 3A-3N.

As shown FIG. 4C, internal image sensor 408a and external image sensor 408b of second electronic device 360 are inactive. In some examples, in FIG. 4C, first electronic device 401 maintains presentation of virtual object 402 in environment 400 in a body-locked orientation or a head-locked orientation because internal image sensor 408a and external image sensor 408b are inactive (e.g., and a position of first electronic device 401 and/or the one or more portions of user 418 are not actively detected by the computing system using second electronic device 460). The internal image sensor 408a and the external image sensor 408b are optionally inactive in FIG. 4C because the one or more criteria for presenting virtual object 402 in a world-locked orientation are not satisfied. For example, the one or more criteria include a criterion that is satisfied when second electronic device 460 has moved by less than a threshold amount (e.g., less than 0.01, 0.05, 0.1, 0.2, 0.5, or 1 meter) over a predetermined period of time (e.g., 1, 2, 5, 10, 15, 20, 30, 60, or 120 seconds). For example, a time glyph 430 is shown in FIGS. 4C-4D representing an amount of time that second electronic device 460 has moved by less than the threshold amount. For example, in accordance with a determination that second electronic device 460 has moved by less than the threshold amount over the predetermined period of time (e.g., corresponding to when time glyph 430 is completely filled with a fill pattern, as shown in FIG. 4D), first electronic device 401 transitions the presentation of virtual object 402 from a body-locked orientation or head-locked orientation to a world-locked orientation in environment 400. For example, in FIG. 4C, less than the predetermined period of time (represented by time glyph 430) has passed. Accordingly, in FIG. 4C, first electronic device 401 maintains presentation of virtual object 402 in a body-locked orientation or a head-locked orientation (e.g., the computer system forgoes transitioning the presentation of virtual object 402 to a world-locked orientation in environment 400 because second electronic device 460 has moved by less than the threshold amount for less than the predetermined period of time).

FIG. 4D illustrates second electronic device 460 activating internal image sensor 408a and external image sensor 408b. In some examples, activating internal image sensor 408a and external image sensor 408b has one or more characteristics of activating internal image sensor 308a shown and described with reference to FIG. 3E. In some examples, in FIG. 4D, second electronic device 460 activates internal image sensor 408a and external image sensor 408b in accordance with a determination that second electronic device 460 has moved by less than the threshold amount for at least the predetermined amount of time (e.g., as described above). For example, as shown in FIG. 4D, second electronic device 460 has moved by less than the threshold amount for at least the predetermined period of time (e.g., as shown by time glyph 430).

In FIG. 4D, after activating internal image sensor 408a, the computing system detects a position of first electronic device 401 and/or the one or more portions (e.g., head, face, and/or eyes) of user 418. Top-down view 440 includes a schematic representation (represented by reference lines 426a and 426b) of a field-of-view of internal image sensor 408a of second electronic device 460 (e.g., the field-of-view corresponds to a region of environment 400 that is (e.g., actively) captured using internal image sensor 408a). For example, second electronic device 460 captures images, using internal image sensor 408a, of the region of environment 400 included between reference lines 426a and 426b, which includes user 418 and first electronic device 401. Further, in FIG. 4D, after activating external image sensor 408b, the computing system detects a region of environment 400 within a field-of-view of external image sensor 408b. Top-down view 440 includes a schematic representation (represented by reference lines 424a and 424b) of a field-of-view of external image sensor 408b of second electronic device 460. For example, second electronic device 460 captures images, using external image sensor 408b, of the region of environment 400 included between reference lines 424a and 424b (e.g., which includes a location corresponding to virtual object 402 in environment 400).

In some examples, in FIG. 4D, the computing system uses internal image sensor 408a and external image sensor 408b to determine a position of one or more locations of environment 400 (e.g., included between reference lines 424a and 424b in top-down view 440) relative to a current viewpoint of user 418 and/or a current pose of first electronic device 401. For example, in FIG. 4D, the computing system uses internal image sensor 408a to determine the position of second electronic device 460 relative to the current viewpoint of user 418 (and/or the current pose of first electronic device 401) (e.g., determining the position of second electronic device 460 relative to the current viewpoint of user 418 and/or the current pose of first electronic device 401 includes one or more characteristics of determining the position of second electronic device 360 relative to the current viewpoint of user 318 and/or the current pose of first electronic device 301 described with reference to FIG. 3E). Further, for example, in FIG. 4D, the computing system uses external image sensor 408b to detect the position of one or more locations of environment 400 (e.g., located in the region of environment 400 between reference lines 424a and 424b in top-down view 440) relative to second electronic device 460. Using the detected position of the one or more locations of environment 400 relative to second electronic device 460, the computing system optionally determines the position of second electronic device 460 relative to the one or more locations of environment 400 (e.g., by inversing the detected relationship between the position of the one or more locations of environment 400 and second electronic device 460). Accordingly, in some examples, such as in FIG. 4D, the computing system uses the determined position of second electronic device 460 relative to the current viewpoint of user 408 and the determined position of second electronic device 460 relative to the one or more locations of environment 400 to determine the position of the one or more locations of environment 400 relative to the current viewpoint of user 408 (and/or a current pose of first electronic device 401) such that first electronic device 401 may present content, such as virtual object 402, in a world-locked orientation at the one or more locations of environment 400.

Additionally or alternatively, in some examples, the computing system uses SLAM techniques to determine the pose of second electronic device 460 relative to environment 400 (e.g., using external image sensor 408b) and to determine the pose of first electronic device 401 relative to second electronic device 460 (e.g., and uses this information to present virtual object 402 as world-locked in environment 400).

Although reference lines 424a, 424b, 426a, and 426b are not shown in top-down view 440 in FIGS. 4E-4G (e.g., while internal image sensor 408a and external image sensor 408b are active) for ease of illustration, it should be appreciated that second electronic device 460 continues to capture images in FIGS. 4E-4G of one or more locations of environment 400 that are within the field-of-view of internal image sensor 408a and external image sensor 408b.

FIGS. 4D-4E illustrate first electronic device 401 presenting an animation in environment 400. For example, the animation corresponds to a transition from presenting virtual object 402 in a body-locked orientation or head-locked orientation to presenting virtual object 402 in a world-locked orientation. As shown in FIG. 4D, first electronic device 401 presents a visual indication 432 in environment 400. For example, visual indication 432 is a virtual notification indicating that first electronic device 401 is transitioning to presenting virtual object 402 in a world-locked orientation. From FIG. 4D to FIG. 4E, first electronic device 401 moves virtual object 402 in environment 400 (e.g., to a representation of a floor in environment 400). For example, while first electronic device 401 presents virtual object 402 in the world-locked orientation, user 418 (e.g., and first electronic device 401 and second electronic device 460) may move in the environment 400 while virtual object 402 remains at the same location and/or orientation (e.g., on the floor) in environment 400. Alternatively, in some examples, first electronic device 401 does not move virtual object 402 during the transition to presenting virtual object 402 in the world-locked orientation (e.g., and presents virtual object 402 in the world-locked orientation from the location and orientation of virtual object 402 shown in FIG. 4D).

In FIG. 4E, first electronic device 401 presents virtual object 402 in a world-locked orientation in environment 400. For example, top-down view 440 includes a vector 442a extending from second electronic device 460 to first electronic device 401 (and/or user 418). In some examples, vector 442a is a schematic representation of second electronic device 460 detecting a position of first electronic device 401 and/or the one or more portions of user 418. Further, top-down view 440 includes a vector 442b extending from second electronic device 460 to a location in environment 400 corresponding to virtual object 402. In some examples, vector 442b is a schematic representation of second electronic device 460 detecting a location (e.g., the location corresponding to virtual object 402) in environment 400. Further, top-down view 440 includes a reference line 446 extending from first electronic device 401 (and/or user 418) to the location in environment 400 corresponding to virtual object 402. In some examples, reference line 446 is a schematic representation of the computing system determining (e.g., using the detected position of first electronic device 401 and/or the one or more portions of user 418 (e.g., represented by vector 442a) and the detected position of the location in environment 400 corresponding to virtual object 402 (e.g., represented by vector 442b)) the position of the location in environment 400 corresponding to virtual object 402 to the current viewpoint of user 418 (e.g., and/or the current pose of first electronic device 401). In some examples, the computer system uses the determined position of the location of environment 400 corresponding to virtual object 402 relative to the current viewpoint of user 418 and/or the current pose of first electronic device 401 to present virtual object 402 in the world-locked orientation (e.g., such that user 418, first electronic device 401, and/or second electronic device 460 may move translationally in environment 400 without causing virtual object 402 to move in environment 400).

FIG. 4F illustrates user 418 (and first electronic device 401 and second electronic device 460) moving in environment 400 while first electronic device 401 presents virtual object 402 in the world-locked orientation (e.g., at a location that is independent from the location of second electronic device 460 in environment 400). As shown in FIG. 4F (e.g., in top-down view 440), user 418 moves to a different location in environment 400 (e.g., while wearing first electronic device 401 and while holding second electronic device 460 with hand 406). In some examples, the computing system continues to track the position of the one or more portions of user 418 (e.g., the head, face, and/or eyes of user 418) and/or first electronic device 401 relative to second electronic device 460 using internal image sensor 408a, as represented by vector 442a in top-down view 440 (e.g., and the computer system continues to determine the position of second electronic device 460 relative to the current viewpoint of user 418 (and/or relative to the current pose of first electronic device 401)). Additionally, in some examples, the computing system continues to track the position of one or more locations of environment 400 using external image sensor 408b, as represented by vector 442b in top-down view 440 (e.g., and the computer system continues to determine the position of second electronic device 460 relative to the one or more locations of environment 400). Additionally, in some examples, the computer system continues to determine the position of the one or more locations of environment 400 (e.g., the location in environment 400 corresponding to virtual object 402) relative to the current viewpoint of user 418 (and/or the current pose of first electronic device 401), as represented by reference line 446 in top-down view 440. Accordingly, for example, in FIG. 4F, in response to the movement of user 418 (and first electronic device 401 and second electronic device 460) in environment 400, first electronic device 401 maintains presentation of virtual object 402 at the same location (and/or orientation) in environment 400 compared to as shown in FIG. 4E (e.g., such that user 418 may view virtual object 402 from a different viewpoint in environment 400).

FIGS. 4F-4G illustrate the computing system moving virtual object 402 in environment 400 in response to user input. For example, as shown in FIG. 4F, while user 418 continues to hold second electronic device 460 with hand 406 (e.g., such that the one or more portions of user 418 and/or first electronic device 401 continue to be in the field-of-view of internal image sensor 408a), user 418 performs a touch input on second electronic device 460 (e.g., on a touch-sensitive display of second electronic device 460) using finger 470 of hand 406. For example, the touch input performed by finger 470 corresponds to a tap-and-hold input (e.g., user 418 holds finger 470 on the touch-sensitive display of second electronic device 460 for over a threshold period of time (e.g., 0.1 0.2, 0.5, 1, 2, 5, or 10 seconds)). In some examples, the touch input performed by user 418 in FIG. 4F corresponds to a request to move virtual object 402 in environment 400. For example, subsequent movement of second electronic device 460 while user 418 continues to perform the touch input with finger 470 (e.g., and while second electronic device 460 continues to detect the position of the one or more portions of user 418 and/or first electronic device 401) causes corresponding movement of virtual object 402 in environment 400, as shown in FIG. 4G.

FIG. 4G illustrates first electronic device 401 presenting virtual object 402 at a different location in environment 400 (e.g., compared to as shown in FIG. 4F) in response to the computing system detecting subsequent movement of second electronic device 460 while user 418 continues to perform the touch input with finger 470 (e.g., initiated in FIG. 4F). For example, as shown in FIG. 4G, the computing system moves virtual object 402 toward user 418 in environment 400 (e.g., closer in depth relative to the current viewpoint of user 418). In some examples, the movement of virtual object 402 corresponds to a direction and/or amount of movement of second electronic device 460 between FIG. 4F and FIG. 4G (e.g., while finger 470 maintains engagement of the touch-sensitive display of second electronic device 460, second electronic device 460 is moved closer to a location of user 418). In some examples, in accordance with a determination that user 418 ceases to perform the touch input (e.g., on the touch-sensitive display of second electronic device 460), the computer system forgoes moving virtual object 402 in environment 400 in response to subsequent movement of second electronic device 460.

In some examples, in FIG. 4G, the computing system continues to determine the position of one or more locations of environment 400 (e.g., that are within the field-of-view of external image sensor 408b) relative to the current viewpoint of user 418 and/or the current pose of first electronic device 401. For example, as shown in FIGS. 4F-4G, internal image sensor 408a and external image sensor 408b remain active during the user input corresponding to the request to move virtual object 402 in environment 400. Further, for example, as shown in top-down view 440 in FIG. 4G, the computing system detects the position of the one or more portions of user 418 and/or first electronic device 401 (as represented by vector 442a) and the location in environment 400 corresponding to the updated location of virtual object 402 (as represented by vector 442b). Using the detected position of the one or more portions of user 418 and/or first electronic device 401 and the location in environment 400 corresponding to the updated location of virtual object 402, the computing system determines the position of the updated location of virtual object 402 relative to the current viewpoint of user 418 and/or the current pose of first electronic device 401 (as represented by reference line 446). Accordingly, in FIG. 4G, first electronic device 401 continues to present virtual object 402 at a world-locked orientation in environment 400 (e.g., such that first electronic device 401 maintains presentation of virtual object 402 at the location and/or orientation shown in FIG. 4G in response to subsequent movement of user 418 relative to environment 400 (e.g., such that user 418 may view virtual object 402 at the same location and/or orientation in environment 400 shown in FIG. 4G from a different viewpoint)).

In some examples, while presenting virtual object 402 in a world-locked orientation in environment 400, such as shown in FIG. 4G, first electronic device 401 transitions to presenting virtual object 402 in a head-locked orientation or body-locked orientation in accordance with a determination that one or more second criteria are satisfied. For example, the one or more second criteria include a criterion that is satisfied when second electronic device 460 moves by more than a threshold amount (e.g., more than 0.01, 0.02, 0.05, 0.1, 0.2, 0.5, or 1 meter). For example, the one or more second criteria include a criterion that is satisfied when second electronic device 460 ceases to detect the one or more portions of user 418 and/or first electronic device 401 (e.g., using internal image sensor 408a) and/or the one or more locations of environment 400 (e.g., using external image sensor 408b) (e.g., user 418 ceases to hold second electronic device 460 with hand 406 in front of their face and/or first electronic device 401). For example, the one or more second criteria include a criterion that is satisfied in response to user input (e.g., user 418 selects a selectable option (e.g., presented using display 420 and/or using a display of second electronic device 460) that is selectable to present virtual object 402 in a body-locked orientation or a head-locked orientation, or user 418 provides a verbal command detected by the computing system corresponding to a request to present virtual object 402 in a body-locked orientation or a head-locked orientation).

In some examples, transitioning the presentation of virtual object 402 from the world-locked orientation to a head-locked orientation or body-locked orientation has one or more characteristics of the transition of the presentation of virtual object 302a from the world-locked orientation to the head-locked orientation or body-locked orientation shown and described with reference to FIGS. 3H-3J. For example, in accordance with a determination that the one or more second criteria are satisfied, first electronic device 401 presents virtual object 402 in environment 400 at distance 416 and/or orientation 422 relative to a portion of user 418 (e.g., the torso of user 418) and/or first electronic device 401 (e.g., a current pose of first electronic device 401), as shown in FIGS. 4A-4B (e.g., first electronic device 401 presents virtual object 402 in the same manner in environment 400 as prior to first electronic device 401 presenting virtual object 402 in the world-locked orientation).

According to the above, some examples of the disclosure are directed to presenting content in a three-dimensional environment in a world-locked orientation relative to a location of a companion device (e.g., as shown and described with reference to FIGS. 3A-3N), and some examples of the disclosure are directed to presenting content in a three-dimensional environment in a world-locked orientation relative to a location in the three-dimensional environment that is independent of a location of a companion device (e.g., as shown and described with reference to FIGS. 4A-4G). In some examples, a computing system may selectively present content in a world-locked orientation relative to a location of a companion device or in a world-locked orientation relative to a location independent of a location of the companion device. For example, if the companion device includes an external image sensor, and/or in accordance with a determination that an external image sensor is able to detect one or more locations of an environment (e.g., because the companion device has moved by less than a threshold amount (e.g., over at least a predetermined period of time) and/or there is a lack of physical obstruction within the field-of-view of the external image sensor), the computing system may present content in a world-locked orientation independent of a location of the companion device. For example, if the companion device does not include an external image sensor, and/or in accordance with a determination that an external image sensor is unable to detect one or more locations of an environment (e.g., because the companion device has moved by more than a threshold amount and/or there is physical obstruction within the field-of-view of the external image sensor), the computing system may present content in a world-locked orientation relative to a location of the companion device (e.g., using an internal image sensor and without using an external image sensor).

Additionally or alternatively, in some examples, the computing system may present content in a world-locked orientation relative to a location of a companion device (e.g., as shown and described with reference to FIGS. 3A-3N) or in a world-locked orientation relative to a location that is independent of a location of the companion device (e.g., as shown and described with reference to FIGS. 4A-4G) based on the type of content and/or a respective application the content is associated with. For example, in accordance with a determination that content is a first type of content (e.g., content associated with a videotelephony application, such as virtual object 302a shown in FIG. 3A), the computing system may present the content in a world-locked orientation relative to a location of the companion device (e.g., by default (e.g., as defined by one or more system settings, one or more settings associated with the respective application, and/or one or more settings associated with a user profile). Further, for example, in accordance with a determination that the content is a second type of content (e.g., a virtual representation of a physical object, such as virtual object 402 shown in FIG. 4A), different from the first type of content, the computing system may present the content in a world-locked orientation relative to a location that is independent of a location of the companion device (e.g., by default (e.g., as defined by one or more system settings, one or more settings associated with a respective application, and/or one or more settings associated with a user profile).

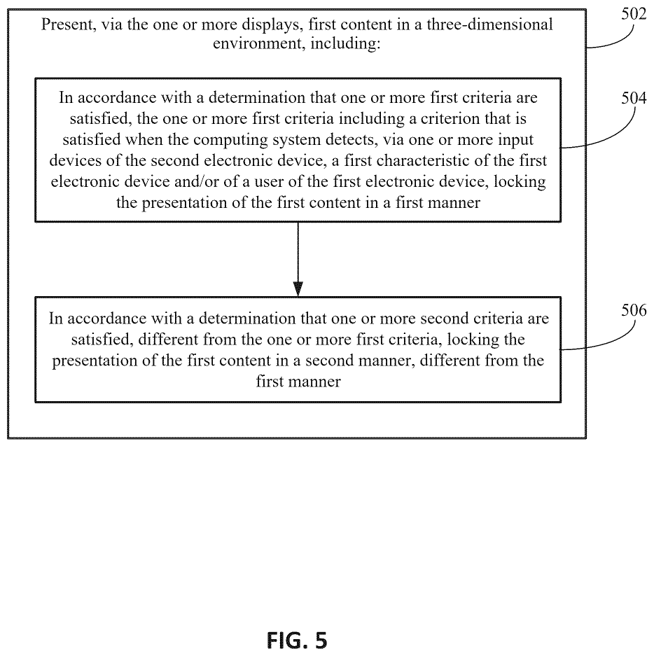

FIG. 5 illustrates a flow diagram of an example process for locking the presentation of content in a three-dimensional environment according to some examples of the disclosure. In some examples, process 500 begins at a computing system including a first electronic device and a second electronic device, wherein the first electronic device includes one or more displays. In some examples, the first electronic device is optionally a head-mounted display similar or corresponding to electronic device 201 of FIG. 2A, and the second electronic device is optionally an electronic device similar or corresponding to electronic device 260 of FIG. 2B.

As shown in FIG. 5, in some examples, at 502, the computing system presents, via the one or more displays, first content in a three-dimensional environment. For example, as shown in FIG. 3D, first electronic device 301 presents, via display 320, virtual object 302a in environment 300. For example, as shown in FIG. 4C, first electronic device 401 presents, via display 420, virtual object 402 in environment.

In some examples, at 504, presenting the first content in the three-dimensional environment includes, in accordance with a determination that one or more first criteria are satisfied, the one or more first criteria including a criterion that is satisfied when the computing system detects, via one or more input devices of the second electronic device, a first characteristic of the first electronic device and/or of a user of the first electronic device, locking the presentation of the first content in a first manner. In some examples, the first characteristic includes a pose of the first electronic device and/or a position of one or more portions (e.g., head, face, and/or eyes) of the user of the first electronic device. In some examples, locking the presentation of the first content in the first manner includes presenting the first content in a world-locked orientation in the three-dimensional environment. For example, as shown in FIGS. 3F-3G, first electronic device 301 presents virtual object 302a in a world-locked orientation relative to a location of second electronic device 360 in environment 300 in accordance with a determination that second electronic device 360 detects a position of one or more portions of user 318 and/or a current pose of first electronic device 301 using internal image sensor 308a. For example, as shown in FIGS. 4E-4F, first electronic device 401 presents virtual object 402 in a world-locked orientation relative to a location in environment 400 that is independent of a location of second electronic device 460 in environment 400 in accordance with a determination that second electronic device 460 detects a position of one or more portions of user 318 and/or a current pose of first electronic device 301 (e.g., using internal image sensor 408a) and one or more locations of environment 400 (e.g., using external image sensor 408b).

In some examples, at 506, presenting the first content in the three-dimensional environment includes, in accordance with a determination that one or more second criteria are satisfied, different from the one or more first criteria, locking the presentation of the first content in a second manner, different from the first manner. In some examples, the one or more second criteria include a criterion that is satisfied when one or more input devices of the second electronic device do not detect one or more characteristics of the user and/or the first electronic device (e.g., the second electronic device does not detect one or more portions of the user and/or a pose of the first electronic device). In some examples, locking the presentation of the first content in the second manner includes presenting the first content in a head-locked orientation or a body-locked orientation in the three-dimensional environment. For example, as shown in FIG. 3B, first electronic device 301 presents, via display 320, virtual object 302a in a body-locked orientation in environment 300 (e.g., second electronic device 360 does not detect a position of one or more portions of user 318 and/or a pose of first electronic device 301). For example, as shown in FIG. 3C, first electronic device 301 presents, via display 320, virtual object 302a in a head-locked orientation in environment 300 (e.g., second electronic device 360 does not detect a position of one or more portions of user 318 and/or a pose of first electronic device 301). For example, as shown in FIGS. 4A-4B, first electronic device 401 presents, via display 420, virtual object 402 in a head-locked orientation or a body-locked orientation in environment 400 (e.g., second electronic device 460 does not detect a position of one or more portions of user 418 and/or a pose of first electronic device 401).

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Attention is now directed toward examples of a computing system performing operations in a three-dimensional environment on a first electronic device in response to detecting one or more characteristics of one or more portions of a user of the first electronic device, using one or more sensors of a second electronic device. For example, the computing system comprises a first electronic device (e.g., corresponding to electronic device 101 and/or 201) and a second electronic device (e.g., corresponding to electronic devices 160 and/or 260). For example, the computing system utilizes one or more input devices (e.g., image sensors) of the second electronic device to perform operations associated with content presented in a three-dimensional environment on the first electronic device.

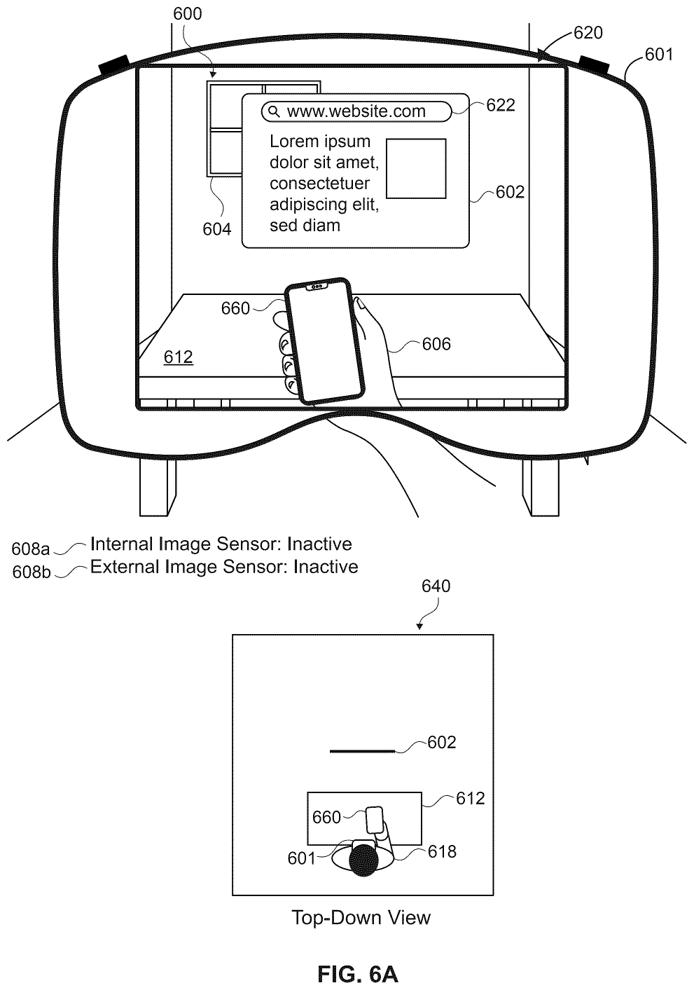

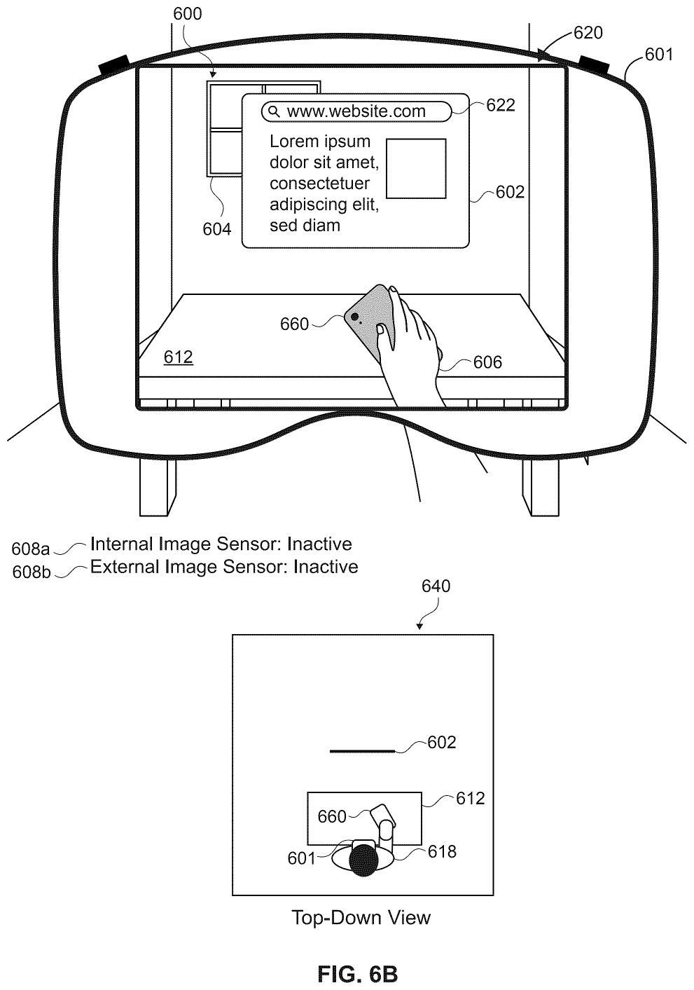

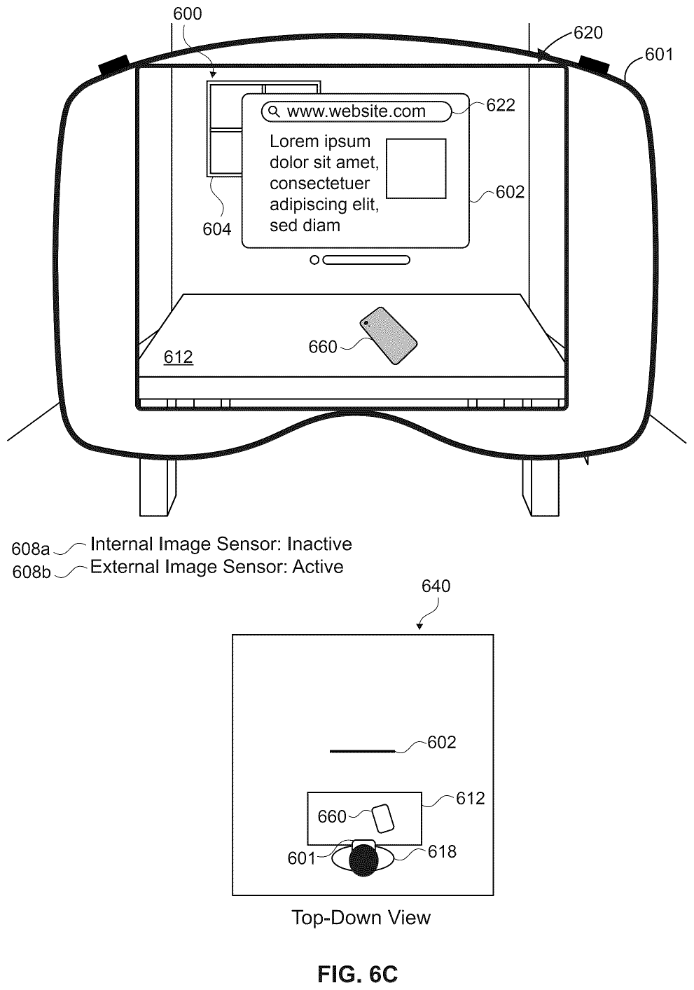

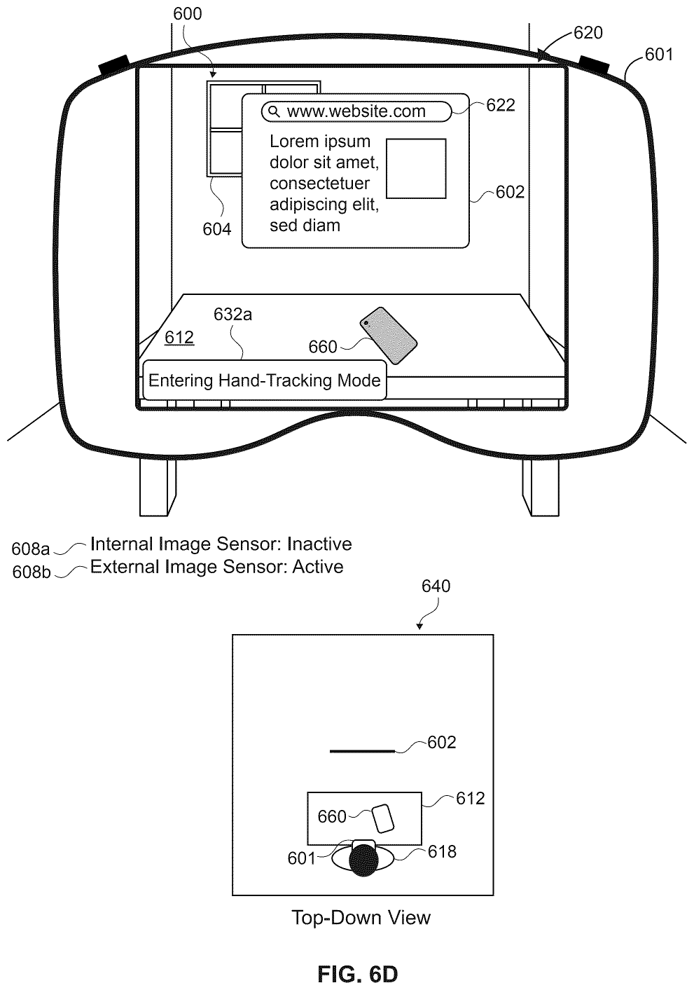

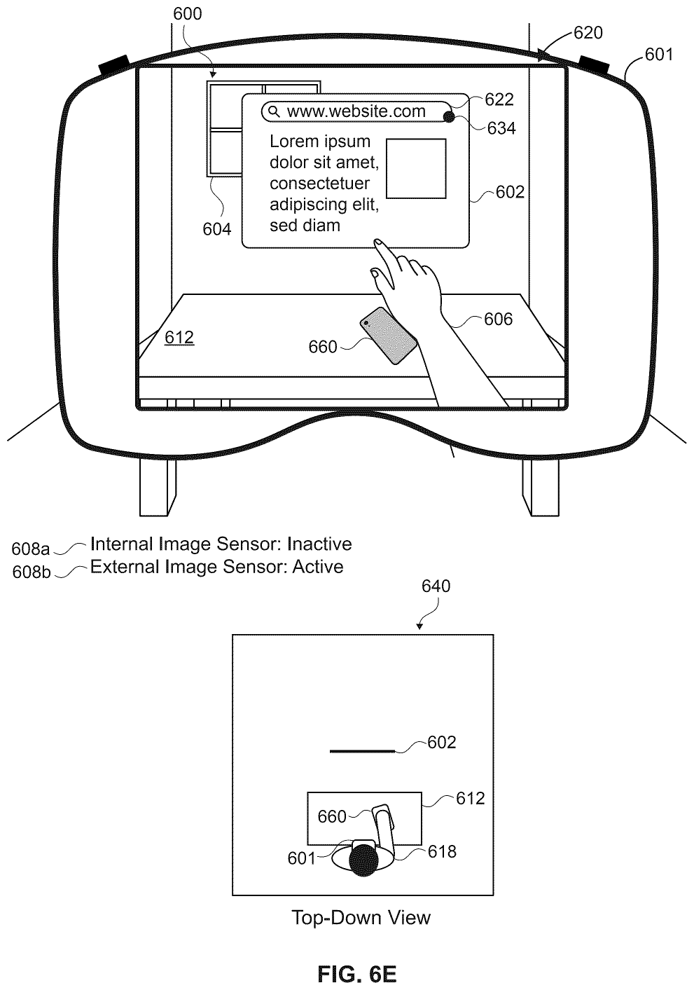

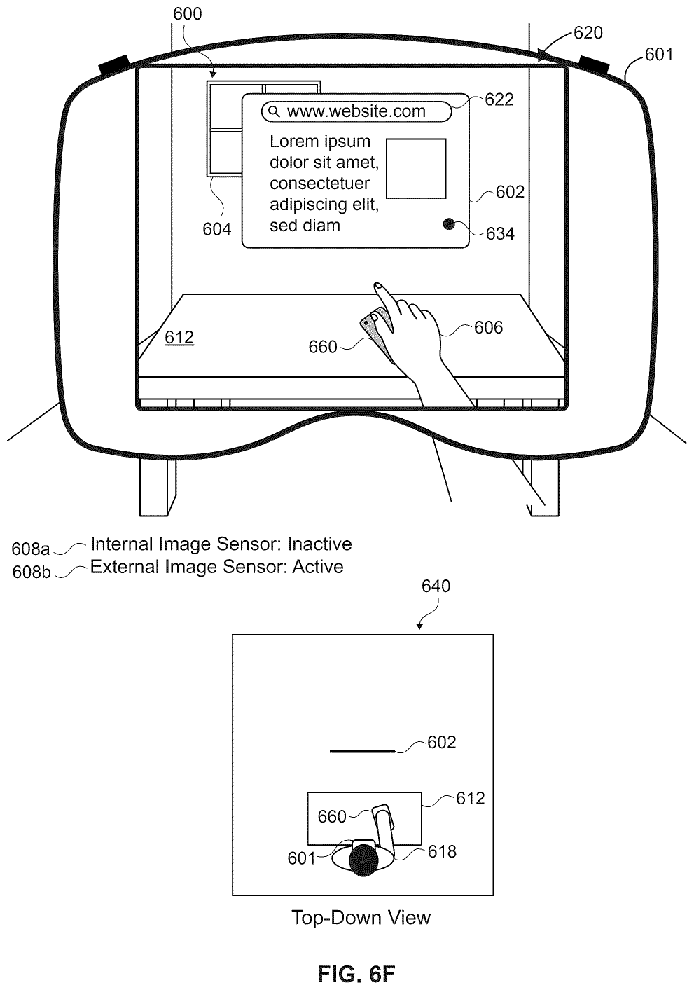

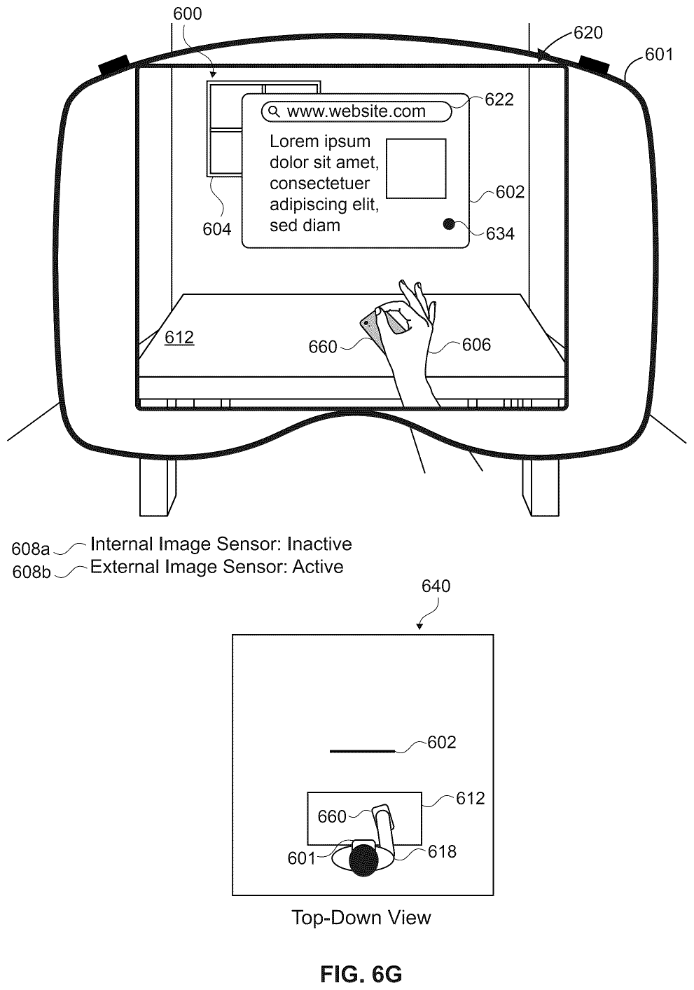

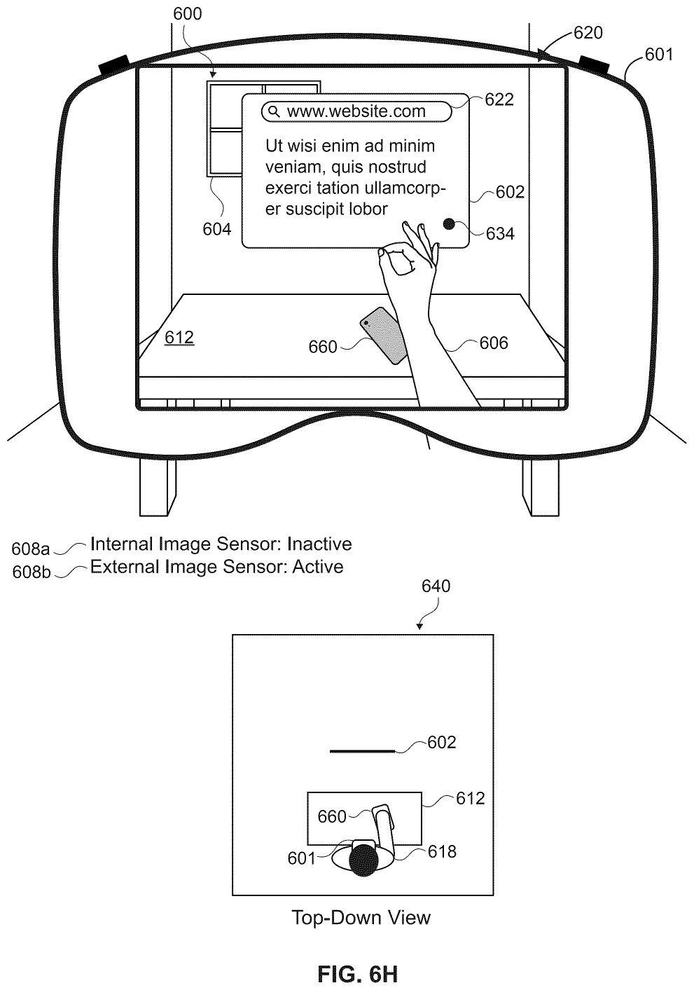

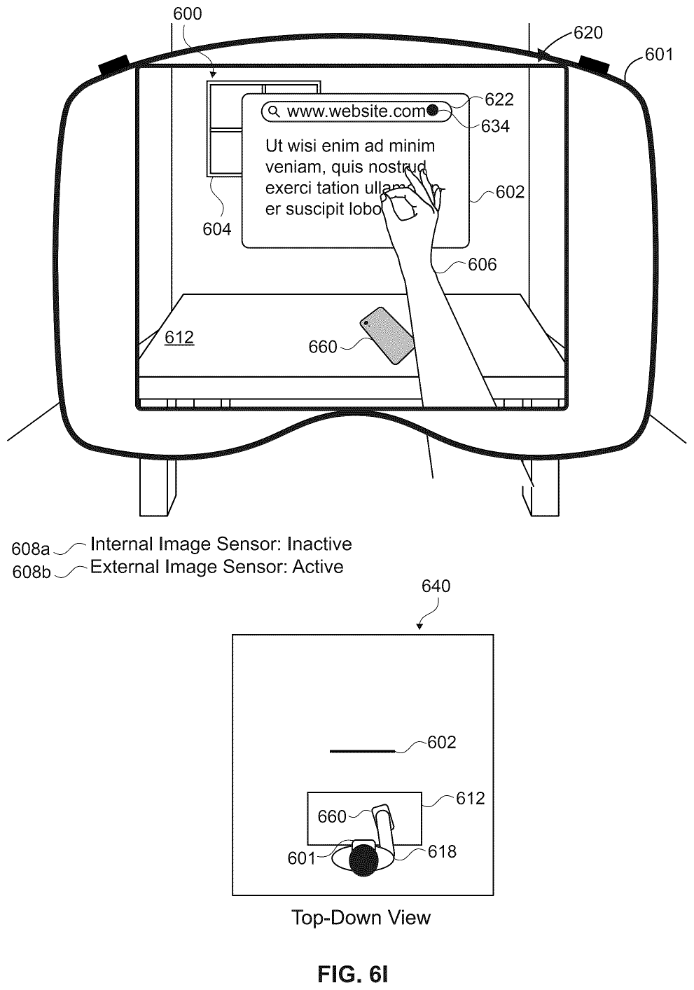

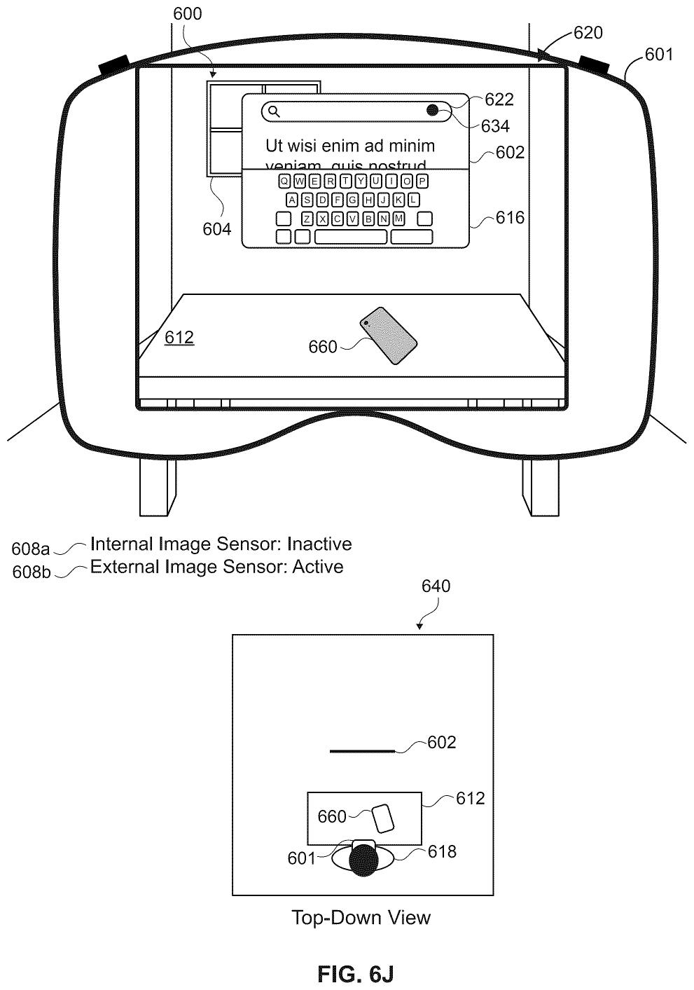

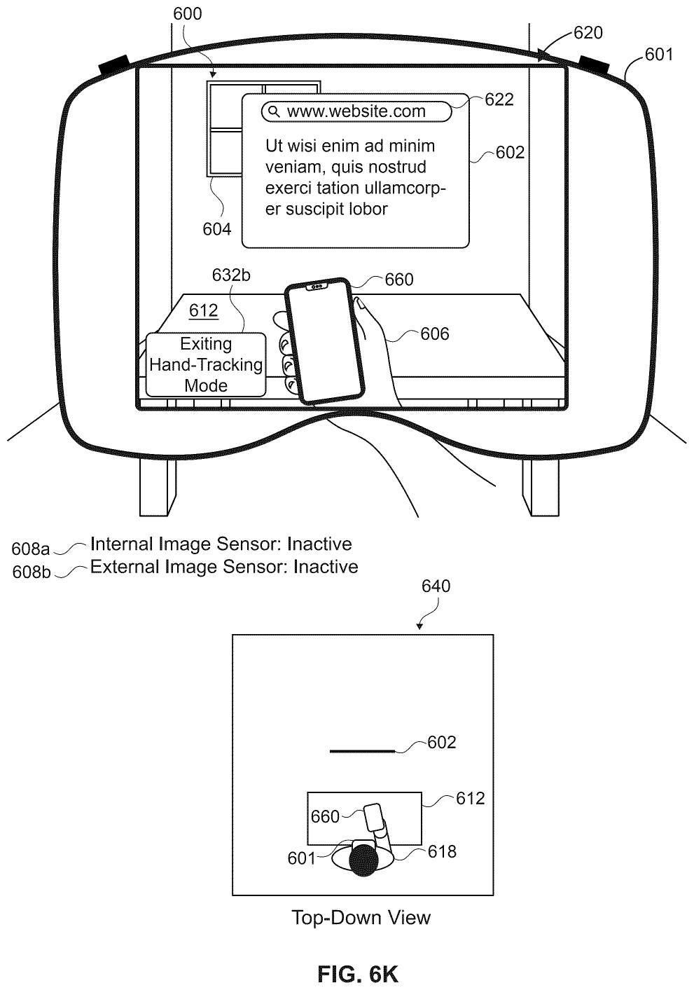

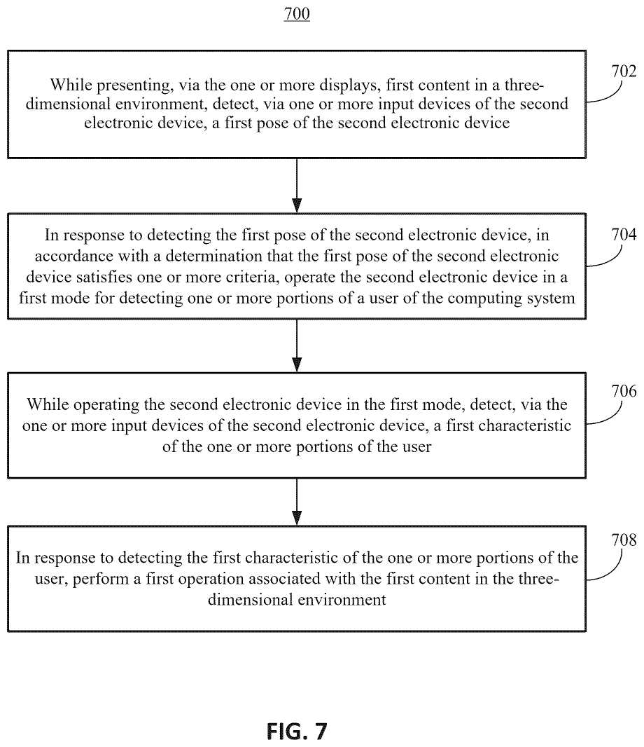

In some examples, interacting with content in a three-dimensional environment using air gestures (e.g., gestures performed by one or more hands of a user) requires an electronic device (e.g., and/or a computing system) to detect one or more hands of a user of the electronic device (e.g., using hand-tracking sensors). The below described methods and processes (e.g., described with reference to FIGS. 6A-7) enable an electronic device that optionally does not include image sensors, location sensors, eye-tracking sensors, and/or hand-tracking sensors (e.g., input devices used for detecting air gestures) to perform operations in a three-dimensional environment in response to one or more air gestures performed by a user using one or more input devices of a companion device (e.g., a second electronic device having one or more characteristics of electronic devices 160 and/or 260), thereby improving the overall functionality of the first electronic device (e.g., without the first electronic device including the input devices required for tracking hands and/or detecting air gestures) and providing a user of the first electronic device with additional options for interacting with content in the three-dimensional environment. It should be understood that, in some examples, the air gestures described with reference to FIGS. 6A-6K are gestures performed by one or more hands of a user over an image sensor of a companion device (e.g., while the companion device is performing hand-tracking using the image sensor), and the air gestures may optionally also be referred to as hand gestures.

FIGS. 6A-6K illustrate a computing system performing operations in a three-dimensional environment on a first electronic device in response to detecting one or more characteristics of one or more portions of a user using a second electronic device according to some examples of the disclosure. In some examples, the computing system includes a first electronic device 601 (e.g., having one or more characteristics of electronic device 101, 201, 301, and/or 401) and a second electronic device 660 (e.g., having one or more characteristics of electronic device 160, 260, 360, and/or 460). In some examples, the computing system includes first electronic device 601, and first electronic device 601 is configured to be in communication with second electronic device 660 (e.g., second electronic device 660 is an auxiliary and/or companion device in communication with first electronic device 601).

As shown in FIGS. 6A-6K, first electronic device 601 includes a display 620 (e.g., having one or more characteristics of display 120, 320, 420, and/or display generation component(s) 214A). In some examples, display 620 includes multiple display generation components (e.g., first electronic device 601 is a head-mounted display including two stereo displays).

In FIGS. 6A-6K, an environment 600 is visible via display 620. In some examples, environment 600 has one or more characteristics of environment 300 shown and described with reference to FIGS. 3A-3N and/or environment 400 shown and described with reference to FIGS. 4A-4G. For example, from a current viewpoint of a user of first electronic device 601, one or more virtual objects (e.g., virtual object 602 shown in FIG. 5A) are presented in environment 600 while one or more physical objects (e.g., real-world window 604 and/or real-world table 612) from a physical environment of the user are visible (e.g., through video passthrough or optical see-through of the physical environment).

FIGS. 6A-6K include a top-down view 640 of environment 600. In top-down view 640, a user 618 is shown wearing first electronic device 601 (e.g., a view of environment 600 shown within display 620 corresponds to a current field-of-view of user 618). For example, first electronic device 601 is a head-mounted display worn by user 618. Top-down view 640 further includes a representation of second electronic device 660. Second electronic device 660 is optionally a mobile device, such as a mobile phone (e.g., as shown in FIG. 6A).

FIG. 6A illustrates first electronic device 601 presenting a virtual object 602 in environment 600. In some examples, virtual object 602 corresponds to a virtual window that includes content associated with a respective application. For example, virtual object 602 is associated with a web-browsing application (e.g., and includes website content and a Uniform Resource Locator (URL) address bar 622).

As shown in FIG. 6A, user 618 holds second electronic device 660 with hand 606. In some examples, second electronic device 660 includes one or more image sensors (e.g., having one or more characteristics of image sensor(s) 206B described with reference to FIG. 2B). For example, second electronic device 660 includes one or more internal image sensors (e.g., on a same side as a display of second electronic device 660 (e.g., with a viewpoint from a surface of second electronic device 660 directed toward user 618 in FIG. 6A)) and one or more external image sensors (e.g., on an opposite side of a display of second electronic device 660 (e.g., with a viewpoint from a surface of second electronic device 660 directed away from user 618 in FIG. 6A)). Optionally, in some examples, second electronic device 660 includes one or more external image sensors and does not include one or more internal image sensors (e.g., the methods and processes described with reference to FIGS. 6A-6K are performed with one or more external image sensors and not with one or more internal image sensors). Alternatively, in some examples, second electronic device 660 includes one or more internal image sensors and does not include one or more external image sensors (e.g., the methods and processes described with reference to FIGS. 6A-6K are performed with one or more internal image sensors and not with one or more external image sensors).

For reference, FIGS. 6A-6K include textual indications of statuses of an internal image sensor 608a of second electronic device 660 and an external image sensor 608b of second electronic device 660 (e.g., internal image sensor 608a and external image sensor 608b have one or more characteristics of image sensor(s) 206B described with reference to FIG. 2B). For example, the statuses of internal image sensor 608a and/or external image sensor 608b may be active or inactive. In some examples, the statuses (e.g., active or inactive) of internal image sensor 608a and/or external image sensor 608b have one or more characteristics of the statuses of internal image sensor 308a and/or external image sensor 308b described with reference to FIGS. 3D-3J. In some examples, internal image sensor 608a corresponds to a plurality of internal image sensors, and external image sensor 608b corresponds to a plurality of external image sensors (e.g., the computing system uses a plurality of internal image sensors and/or external image sensors of second electronic device 660 to detect one or more portions of user 618).

FIGS. 6B-6C illustrate user 618 moving second electronic device 660 in environment 600. For example, as shown in FIG. 6B, user 618 is moving second electronic device 660 onto real-world table 612 (e.g., face-down (e.g., such that external image sensor 608b is directed upward from real-world table 612)). For example, as shown in FIG. 6C, second electronic device 660 rests on real-world table 612 (e.g., face-down). For example, external image sensor 608b is on a first side of second electronic device 660, and user 618 moves second electronic device 660 such that a second side, opposite the first side, of second electronic device 660 is directed toward real-world table 612 (e.g., the second side rests on real-world table 612).

In some examples, in accordance with a determination that a current pose of second electronic device 660 satisfies one or more criteria, the computer system operates second electronic device 660 in a mode for detecting one or more portions of user 618 (e.g., hand(s) of user 618, such as hand 606). For example, the one or more criteria include a criterion that is satisfied when the current pose of second electronic device 660 corresponds to a first pose (e.g., the computing system detects the current pose of second electronic device 660 using one or more input devices of second electronic device 660, such as orientation sensor(s) (e.g., having one or more characteristics of orientation sensor(s) 210B described with reference to FIG. 2B)). For example, the current pose of second electronic device 660 illustrated in FIG. 6C (e.g., such that the second side, opposite external image sensor 608b, of second electronic device 660 is directed toward the surface of real-world table 612) corresponds to the first pose. For example, the one or more criteria include a criterion that is satisfied when the current pose of second electronic device 660 corresponds to the first pose for at least a threshold amount of time (e.g., 1, 2, 5, 10, 15, 30, 60, or 120 second(s)). For example, the one or more criteria include a criterion that is satisfied when one or more settings (e.g., system settings, application settings (e.g., associated with the respective application associated with virtual object 602), and/or user settings (e.g., stored in a user profile)) have one or more respective values (e.g., user 618 previously activated a setting that permits the computing system to operate second electronic device 660 in the mode for detecting the one or more portions (e.g., hand(s)) of user 618).

It should be appreciated that in some examples, alternative poses of the second electronic device 660 may satisfy the one or more criteria for operating second electronic device 660 in the mode for detecting the one or more portions of user 618. For example, the one or more criteria include a criterion that is satisfied when the current pose of second electronic device 660 corresponds to a second pose (e.g., face-up on a surface (e.g., such that internal image sensor 608a of second electronic device 660 is directed upward from real-world table 612)). For example, while operating second electronic device 660 in the mode for detecting the one or more portions of user 618, the computing system uses internal image sensor 608a of second electronic device 660 to detect the one or more portions of user 618. For example, the one or more criteria include a criterion that is satisfied when second electronic device 660 is placed at least partially upright (e.g., on a stand or mount) in environment 600 (e.g., when second electronic device 660 is oriented (e.g., on a stand or mount) such that internal image sensor 608a is directed toward user 618 and/or when second electronic device 660 is oriented (e.g., on a stand or mount) such that external image sensor 608b is directed toward user 618).

In some examples, in FIG. 6C, the computing system activates external image sensor 608b of second electronic device 660 (e.g., to enable active hand-tracking) in accordance with a determination that the current pose of second electronic device 660 shown in FIG. 6C satisfies the one or more criteria for operating second electronic device 660 in the mode for detecting the one or more portions of user 618 (e.g., as described above). For example, the computing system uses external image sensor 608b to detect the one or more portions of user 618 while operating second electronic device 660 in the mode for detecting the one or more portions of user 618. For example, the computing system uses external image sensor 608b to detect air gestures performed by user 618 (e.g., hand gestures performed by user 618 within the field of view of external image sensor 608b). In some examples, in accordance with a determination that the current pose of second electronic device 660 does not satisfy the one or more criteria, the computing system forgoes operating second electronic device 660 in the mode for detecting the one or more portions of user 618. For example, the second electronic device 660 forgoes activating external image sensor 608b to enable active hand-tracking.

FIG. 6D illustrates the computing system transitioning the operation of second electronic device 660 into the mode for detecting the one or more portions (e.g., hand(s)) of user 618. As shown in FIG. 6D, first electronic device 601 presents a visual indication 632a in environment 600. For example, visual indication 632a corresponds to a virtual notification for indicating to user 618 that second electronic device 660 is being operated in the mode for detecting the one or more portions of user 618.

In some examples, while operating the second electronic device 660 in the mode for detecting the one or more portions of user 618, the computing system may perform one or more operations in environment 600 in response to detecting one or more characteristics of the one or more portions of user 618. For example, the computing system may perform one or more operations in environment 600 in response to detecting one or more air gestures performed by hand 606 of user 618. For example, the one or more air gestures are performed over the location of second electronic device 660 on real-world table 612 (e.g., such that the one or more air gestures are performed within a field-of-view of external image sensor 608b of second electronic device 660). In some examples, the computing system defines different air gestures to different operations. For example, the computing system defines a first air gesture (e.g., an air point (e.g., with hand movement)) to a first operation, and a second air gesture (e.g., an air pinch (e.g., with hand movement)) to a second operation, different from the first operation.

FIGS. 6E-6F illustrates the computing system performing a first operation in environment 600 while operating second electronic device 660 in the mode for detecting the one or more portions of user 618. As shown in FIG. 6E, first electronic device 601 presents, via display 620, a cursor 634 within virtual object 602 in environment 600. For example, as shown in FIG. 6E, first electronic device 601 presents cursor 634 in response to detecting a first air gesture (e.g., an air point) performed by hand 606 (e.g., over second electronic device 660 (e.g., within the field-of-view of external image sensor 608b)).

FIG. 6F illustrates the computing system moving cursor 634 in environment 600 in response to detecting movement of hand 606 relative to second electronic device 660. For example, as shown in FIG. 6F, hand 606 moves closer to a location of second electronic device 660 (e.g., toward external image sensor 608b) in environment 600 while continuing to perform the first air gesture (e.g., an air point (e.g., initiated in FIG. 6E)). For example, the movement of cursor 634 in environment 600 (e.g., within virtual object 602) corresponds to the direction and/or magnitude of movement of hand 606 (e.g., while performing the first air gesture). Although vertical movement of cursor 634 is shown in environment 600 in FIGS. 6E-6F, in some examples, the computing system moves cursor 634 horizontally in environment 600 (e.g., within virtual object 602) in response to horizontal movement of hand 606 relative to the location of second electronic device 660 (e.g., relative to external image sensor 608b) in environment 600 (e.g., the horizontal movement of hand 606 is performed while hand 606 maintains the first air gesture).

In some examples, in accordance with a determination that user 618 ceases to perform the first air gesture (e.g., an air point) with hand 606, first electronic device 601 ceases to present cursor 634 in environment 600. Additionally or alternatively, in some examples, in accordance with the determination that user 618 ceases to perform the first air gesture with hand 606, first electronic device 601 maintains presentation of cursor 634 for a predetermined amount of time (e.g., 0.1, 0.2, 0.5, 1, 2, 5, 10, 15, 30, or 60 second(s)) prior to ceasing to present cursor 634 in environment 600. For example, in accordance with a determination that the first air gesture is detected within the predetermined amount of time, first electronic device 601 maintains presentation of cursor 634 in environment 600 without ceasing to present cursor 634 after the predetermined amount of time.

FIGS. 6G-6H illustrate the computing system performing a second operation in environment 600 while operating second electronic device 660 in the mode for detecting the one or more portions of user 618 (e.g., the second operation is different from the first operation shown and described with reference to FIGS. 6E-6F). FIG. 6G illustrates second electronic device 660 detecting a second air gesture (e.g., an air pinch) performed by hand 606 (e.g., different from the first air gesture detected in FIGS. 6E-6F). For example, the second air gesture is performed by hand 606 over the location of second electronic device 660 on real-world table 612 (e.g., such that hand 606 is within the field-of-view of external image sensor 608b). In some examples, the second air gesture corresponds to a request to scroll a user interface presented within virtual object 602. For example, first electronic device 601 scrolls the content included within virtual object 602 in response to detecting movement of hand 606 while hand 606 performs the second air gesture (e.g., as shown in FIG. 6H).

FIG. 6H illustrates first electronic device 601 scrolling the content included within virtual object 602 in response to detecting movement of hand 606 while hand 606 performs the second air gesture (e.g., the air pinch initiated in FIG. 6G). For example, as shown in FIG. 6H, hand 606 moves away from a location of second electronic device 660 (e.g., away from external image sensor 608b) in environment 600. In some examples, as shown in FIG. 6H, the second operation includes scrolling the content included within virtual object 602 downward (e.g., in response to the upward movement of hand 606 while hand 606 performs the second air gesture). For example, the direction and/or magnitude of scrolling of the content corresponds to the direction and/or magnitude of movement of hand 606 from FIG. 6G to FIG. 6H (e.g., while the second air gesture is performed). Alternatively, in some examples, first electronic device 601 scrolls the content included within virtual object 602 upward in response to detecting the upward movement of hand 606 while hand 606 performs the second air gesture (e.g., upward movement of hand 606 (e.g., while performing the second air gesture) corresponds to upward scrolling, and downward movement of hand 606 (e.g., while performing the second air gesture) corresponds to downward scrolling).

FIGS. 6I-6J illustrate the computing system performing a third operation in environment 600 while operating second electronic device 660 in the mode for detecting the one or more portions of user 618 (e.g., the third operation is different from the first operation shown and described with reference to FIGS. 6E-6F and the second operation shown and described with reference to FIGS. 6G-6H). In some examples, prior to FIG. 6I, first electronic device 601 moves cursor 634 to a location within virtual object 602 corresponding to URL address bar 622 (e.g., in response to a user input including the first air gesture, as shown and described with reference to FIGS. 6E-6F). In some examples, as shown in FIG. 6I, while the location of cursor 634 in environment 600 corresponds to URL address bar 622, second electronic device 660 detects a third air gesture performed by hand 606. In some examples, third air gesture is an air pinch (e.g., having one or more characteristics of the second air gesture shown and described with reference to FIGS. 6G-6H). Additionally or alternatively, in some examples, third air gesture is a long air pinch (e.g., an air pinch that is performed (e.g., with or without movement) for at least a threshold amount of time (e.g., 0.1, 0.2, 0.5, 1, 2, 5, or 10 second(s)). In some examples, the third air gesture corresponds to a request to select URL address bar 622 (e.g., and present a virtual keyboard for inputting text within URL address bar 622)).

FIG. 6J illustrates first electronic device 601 presenting a virtual keyboard 616 within environment 600 in response to detecting the third air gesture in FIG. 6I (e.g., the third operation includes presenting virtual keyboard 616 in environment 600 (e.g., within virtual object 602)). In some examples, first electronic device 601 may input one or more characters within URL address bar 622 in response to detecting one or more air gestures performed by user 618 over second electronic device 660 (e.g., within the field-of-view of external image sensor 608b)). For example, first electronic device 601 moves cursor 634 in environment 600 to one or more locations corresponding to one or more keys of virtual keyboard 616 (e.g., in response to detecting an air gesture having one or more characteristics of the first air gesture shown and described with reference to FIGS. 6E-6F), and selects one or more keys of virtual keyboard 616 (e.g., in response to detecting an air gesture having one or more characteristics of the third air gesture shown and described with reference to FIG. 6I). Additionally or alternatively, for example, the computer system may operate virtual keyboard 616 as a swipe keyboard (e.g., and input one or more characters into URL address bar 622 based on movement of cursor 634 (e.g., controlled by an air gesture having one or more characteristics of first air gesture) relative to one or more keys of virtual keyboard 616).

FIG. 6K illustrates the computing system ceasing to operate second electronic device 660 in the mode for detecting the one or more portions (e.g., hand(s)) of user 618. In some examples, in accordance with a determination that the second electronic device 660 no longer has the first pose (e.g., user 618 moves second electronic device 660 from the first pose), the computing system ceases to operate second electronic device 660 in the mode for detecting the one or more portions of user. For example, as shown in FIG. 6K, user 618 picks up second electronic device 660 from real-world table 612 (e.g., such that second electronic device 660 no longer has the first pose). As shown in FIG. 6K, first electronic device 601 presents a visual indication 632b in environment 600. For example, visual indication 632b is a virtual notification indicating that the computing system is ceasing to operate second electronic device 660 in the mode for detecting the one or more portions of user 618 (e.g., such that one or more operations in environment 600 may no longer be performed in response to air gestures).

FIG. 7 illustrates a flow diagram of an example process for performing an operation in a three-dimensional environment according to some examples of the disclosure. In some examples, process 700 begins at a computing system including a first electronic device and a second electronic device, wherein the first electronic device includes one or more displays. In some examples, the first electronic device is optionally a head-mounted display similar or corresponding to electronic device 201 of FIG. 2A, and the second electronic device is optionally an electronic device similar or corresponding to electronic device 260 of FIG. 2B.

As shown in FIG. 7, in some examples, at 702, while presenting, via the one or more displays, first content in a three-dimensional environment, the computing system detects, via one or more input devices of the second electronic device (e.g., one or more orientation sensors having one or more characteristics of orientation sensor(s) 210B), a first pose of the second electronic device. For example, in FIG. 6C, the computing system detects that second electronic device 660 has the first pose in environment 600 (e.g., second electronic device 660 is face-down on real-world table 612 (e.g., such that external image sensor 608b is directed away from real-world table 612)).

In some examples, at 704, in response to detecting the first pose of the second electronic device, in accordance with a determination that the first pose of the second electronic device satisfies one or more criteria, the computing system operates the second electronic device in a first mode for detecting one or more portions of a user of the computing system. For example, as shown in FIGS. 6C-6D, in accordance with a determination that second electronic device 660 has the first pose in environment 600 (e.g., second electronic device 660 is face-down on real-world table 612 such that external image sensor 608b is directed away from real-world table 612), the computing system activates external image sensor 608b and operates second electronic device 660 in the mode for detecting the one or more portions (e.g., hand(s), such as hand 606) of user 618. In some examples, the one or more criteria include a criterion that is satisfied when the second electronic device is in the first pose for at least a threshold amount of time (e.g., 0.1, 0.2, 0.5, 1, 2, 5, or 10 second(s)).

In some examples, at 706, while operating the second electronic device in the first mode, the computing system detects, via the one or more input devices of the second electronic device (e.g., an image sensor of the second electronic device), a first characteristic of the one or more portions of the user (e.g., the computing system detects a position of a hand and/or one or more fingers of a hand of the user). For example, in FIGS. 6E-6F, the computing system detects, using external image sensor 608b of second electronic device 660, a first air gesture (e.g., an air point and/or hand movement) performed by hand 606 of user 618.

In some examples, at 708, in response to detecting the first characteristic of the one or more portions of the user, the computing system performs a first operation associated with the first content in the three-dimensional environment. For example, in response to detecting the first air gesture in FIGS. 6E-6F, the computing system presents cursor 634 in environment 600 (e.g., within virtual object 602) and moves cursor 634 in accordance with movement of hand 606 relative to second electronic device 660 (e.g., relative to external image sensor 608b).

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIGS. 2A-2B) or application specific chips, and/or by other components of FIGS. 2A-2B.

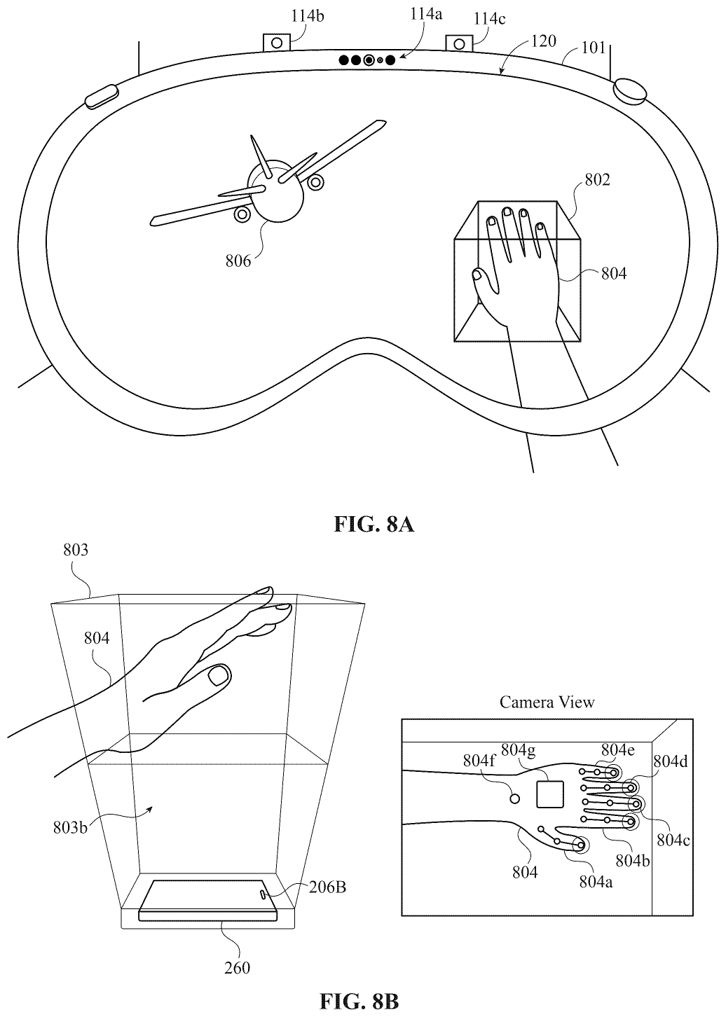

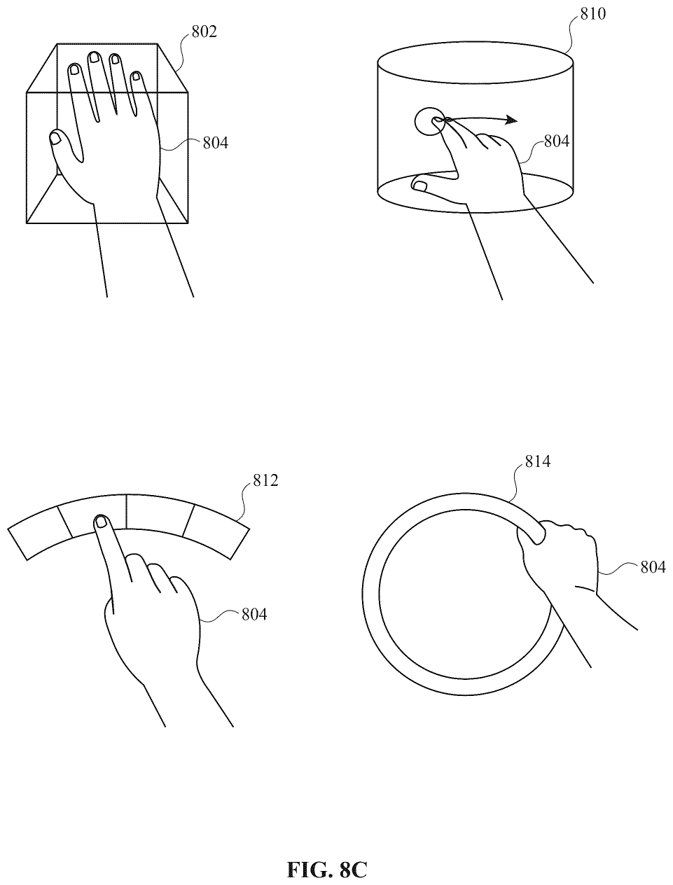

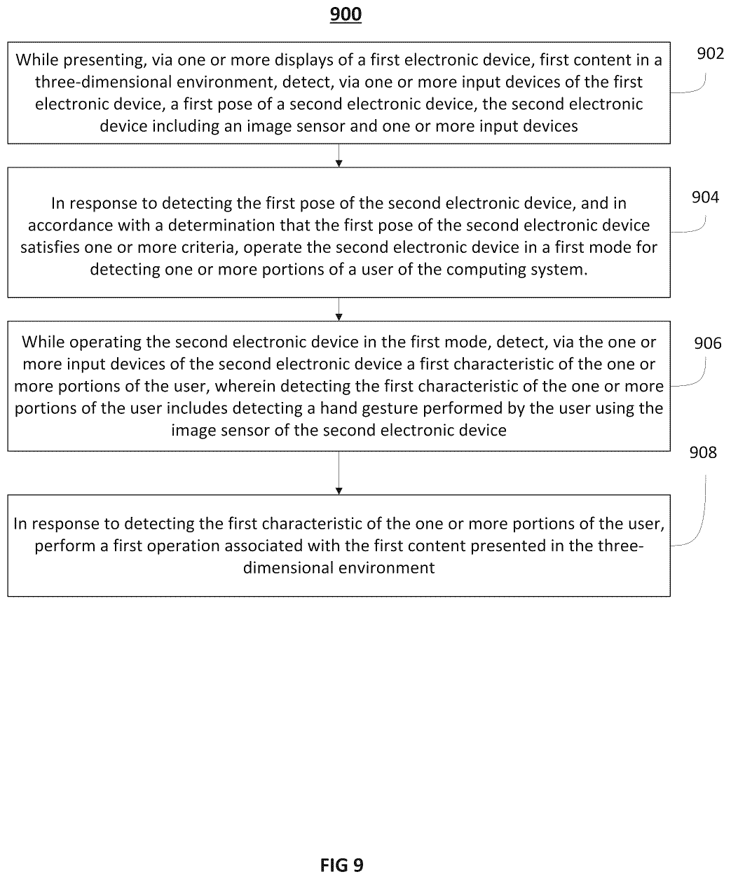

In some examples, when a second electronic device is used for hand tracking input for a first electronic device, the first electronic device displays user interface elements to guide the user to provide input within a detection region of the second electronic device. FIG. 8A illustrates a visualization of a three-dimensional volume displayed by the first electronic device for guiding hand placement when a second electronic device acts as a controller for detecting hand poses via an image sensor. As shown in FIG. 8A, the first electronic device (e.g., electronic device 101) displays an object 806 within a three-dimensional environment. In this example, object 806 is a virtual plane that can be manipulated and steered so as to navigate through a three-dimensional augmented reality (AR), virtual reality (VR), or XR environment. In this example, the user can use their hand 804 to control the steering of object 806 (e.g., when the user tilts hand 804 to the left, the plane will correspondingly tilt to the left, thereby providing an intuitive mechanism of control for manipulating object 806).

In the example shown in FIG. 8A, a second electronic device (e.g., electronic device 260) is being utilized to detect the pose of the hand and any changes to the pose of the hand, and communicates this information to the first electronic device. Accordingly, in these examples, a three-dimensional volume, such as virtual cube 802, is displayed so as to indicate to the user where the hand 804 should be placed for improving the accuracy of the control input. One advantage of such a control system is that, in some examples, the second electronic device is not easily visible by the user (e.g., the attention of the user is directed towards object 806 and/or second electronic device is not visible to the user within a fully immersive VR environment), and therefore errors in providing a control input with a hand gesture can be reduced. In some examples, the first electronic device displays a three-dimensional volume that includes locations in the three-dimensional environment that are visible from an image sensor of the second electronic device (e.g., image sensor 206B of electronic device 260), as will be discussed further with respect to FIG. 8B.

Additionally or alternatively, in some examples, one or more two-dimensional shapes are displayed so as to indicate a region where the hand 804 should be placed. For example, a square shape could be displayed, to indicate to the user that the region above this square shape is suitable for hand placement and tracking for input. As another example, two square shapes could be displayed to indicate that the space between these two square shapes corresponds to the region where the hand should be placed. In one example, the one or more two-dimensional shapes provide upper and lower bounds for hand placement. Additionally or alternatively, the one or more two-dimensional shapes provide bounds on the left, right, front, or back of a volume that is suitable for hand placement.

In some examples, the three-dimensional volume and/or one or more two-dimensional shapes are at least partially transparent. In some examples, when a three-dimensional volume is displayed, different portions of the three-dimensional volume have different visual appearances (e.g., the top of a virtual cube having a different level of transparency than the sides of a virtual cube). In some examples, when a plurality of two-dimensional shapes are displayed, each of the two-dimensional shapes have different visual appearances (e.g., different levels of transparency between respective shapes).

FIG. 8B illustrates a side view and a camera view associated with the second electronic device, used as the control device. As illustrated by FIG. 8B, a detectable region 803 corresponds to the volume in which a hand or hands are reliably detected by image sensor 206B of electronic device 260. In some examples, this detectable region 803 is determined by the first electronic device (electronic device 101) based on one or more parameters of the second electronic device. As one example, image sensors of the first electronic device detect the pose of the second electronic device and/or the location and/or orientation of an image sensor of the second electronic device. In this example, the first electronic device determines an estimated region that the image sensor of the second electronic device would be able to reliably detect (e.g., a field of view of an image sensor). In some examples, the detectable region 803 is defined based on a sensing capability of the second electronic device with an offset relative to the pose of the second electronic device, as perceived by the first electronic device. After determining detectable region 803, the first electronic device displays a three-dimensional volume that corresponds to the detectable region or displays a three-dimensional volume that is within the detectable region (e.g., to ensure that the displayed three-dimensional volume corresponds to detectable locations). As shown in FIG. 8A, in some examples, the detectable region 803 excludes a region 803b that is within a threshold distance from the second electronic device, which can help to ensure that the hand of the user is not brought too close with the electronic device during use. In some examples, this is advantageous so as to avoid the second electronic device being inadvertently moved during operation (which may, e.g., result in errors in hand detection).

FIG. 8B also illustrates a camera view of the second electronic device. In this example, it is illustrated that second electronic device (e.g., electronic device 260) detects one or more characteristics of hand 804, including the location and orientation of some of each of the fingers 804a-804e of the user. Additional characteristics, including a wrist location 804f and a palm location 804g, are optionally also detectable by the second electronic device.

FIG. 8C illustrates examples of three-dimensional volumes that are displayed for interaction with the user. In one example, the three-dimensional volume is a virtual cube 802, as shown previously with respect to FIG. 8A. In another example, the three-dimensional volume is a virtual cylinder 810. In some examples, the virtual cube 802 and virtual cylinder 810 have a maximum size so as to encompass regions in the three-dimensional environment visible from the second electronic device, and/or also have a minimum size to facilitate an ergonomic interaction with the hand of the user.

In some examples, in addition to indicating a region for hand placement, the three-dimensional volume can be a virtual user interface object for providing user input. As shown by virtual cylinder 810, the user can provide a gesture input (e.g., with a certain pose, such as interacting with the virtual cylinder with two fingers, as shown) to the three-dimensional object. In response to receiving this gesture input, the virtual cylinder 810 is rotated, and this rotational input is detected by the second electronic device.

In some examples, a virtual control panel 812 is shown having one or more virtual affordances. In such an example, when a portion of a hand of the user (e.g., a finger) is brought into proximity (e.g., within a threshold distance, such as within 0.1, 0.5, 1, 2, 5, or 10 cm) with one of the virtual affordances, the second electronic device registers an input corresponding to the respective virtual affordance that has been selected. In some examples, a virtual steering wheel 814 is displayed for interaction. By manipulating the virtual steering wheel 814, the user can provide a rotational input to the first electronic device via detection from the second electronic device. By providing a virtual control panel 812 or a virtual steering wheel 814, the immersion within the three-dimensional environment and/or reduction in user errors with providing input are improved, because the user is directed to interact with an object that they are already familiar with and the user is also provided guidance for providing the hand gesture input at the correct location within the environment so as to be reliably detectable by the second electronic device.

While the above examples describe a single, second electronic device, in some examples, multiple electronic devices (e.g., a second electronic device and a third electronic device) are present for receiving user input via hand gestures. In some examples, the first electronic device is configured to determine a detectable region that is detectable from both a second electronic device and a third electronic device. In other examples, a second detectable region is displayed based on locations visible from the third electronic device. In these examples, it is therefore possible to display simultaneously two distinct three-dimensional volumes (e.g., the second electronic device configured to detect hand gestures from a left hand of the user, and the third electronic device configured to detect hand gestures from a right hand of the user).

In some examples, a first portion of a detectable region is detectable from the second electronic device and a second portion of a detectable region is detectable from the third electronic device. In some examples, the first portion and the second portion overlap. In some examples, the detectable region includes an expanded field of view including the overlapping and the non-overlapping portions of the first portion of the detectable region and the second portion of the detectable region.

FIG. 9 illustrates a flow diagram of an example process for performing an operation in a three-dimensional environment according to some examples of the disclosure. In some examples, process 900 begins at a computing system including a first electronic device and a second electronic device, wherein the first electronic device includes one or more displays and wherein the second electronic device includes an image sensor and one or more input devices. In some examples, the first electronic device is optionally a head-mounted display similar or corresponding to electronic device 201 of FIG. 2A, and the second electronic device is optionally an electronic device similar or corresponding to electronic device 260 of FIG. 2B.

As shown in FIG. 9, in some examples, at 902, while presenting, via one or more displays of the first electronic device, first content in a three-dimensional environment, the computer system detects, via one or more input devices of the first electronic device (e.g., via external image sensors 114b and 114c of electronic device 101) a first pose of the second electronic device. For example, in FIG. 8A, the computing system detects that second electronic device (e.g., electronic device 260) has the first pose in environment 600 (e.g., electronic device 260 is horizontal on a surface (e.g., such that an image sensor 206B (external or internal) of the electronic device 260 is directed upwards and away from the surface)).

In some examples, at 904, in response to detecting the first pose of the second electronic device, in accordance with a determination that the first pose of the second electronic device satisfies one or more criteria, the computing system operates the second electronic device in a first mode for detecting one or more portions of a user of the computing system. For example, as shown in FIG. 8A, the second electronic device 260 is configured to detect a pose of hand 804 when the hand is positioned within a field of view of the image sensor of the second electronic device (e.g., so that the second electronic device acts as a control device for the first electronic device).

In some examples, at 906, while operating the second electronic device in the first mode, the computing system detects, via the one or more input devices of the second electronic device (e.g., an image sensor of the second electronic device), a first characteristic of the one or more portions of the user (e.g., the computing system detects a position of a hand and/or one or more fingers of a hand of the user), wherein detecting the first characteristic of the one or more portions of the user includes detecting a hand gesture performed by the user using the image sensor of the second electronic device. For example, in FIG. 8A, the computing system detects, using an external image sensor of second electronic device (e.g., image sensor 206B of electronic device 260), a first air gesture (e.g., an air point and/or hand movement) performed by hand 606 of user 618.

In some examples, at 908, in response to detecting the first characteristic of the one or more portions of the user, the computing system performs a first operation associated with the first content presented in the three-dimensional environment. For example, in FIG. 8A, the computing system detects, using external image sensor 206b of second electronic device 260, a first air gesture (e.g., an air point and/or hand movement, optionally a rotation of a hand) performed by hand 804 of user, resulting in a corresponding movement of object 806 within the three-dimensional environment. Accordingly, the user can manipulate hand 804 above the second electronic device (e.g., electronic device 260) so as to manipulate object 806.

One advantage of the above process is that processing power for hand gesture detection can be offloaded onto a separate electronic device, which can extend the battery life of the first electronic device being worn by the user, lead to extended, immersive experiences that are presented by the first electronic device. A further advantage of the above process is an improved accuracy and reduction in errors with user input via hand gesture within a three-dimensional environment.

It is understood that process 900 is an example and that more, fewer, or different operations can be performed in the same or in a different order. Additionally, the operations in process 900 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method, comprising, at a computer system including a first electronic device in communication with a second electronic device, wherein the first electronic device includes one or more displays, presenting, via the one or more displays, first content in the three-dimensional environment. In some examples, presenting the first content in the three-dimensional environment includes, in accordance with a determination that one or more first criteria are satisfied, the one or more first criteria including a criterion that is satisfied when the computing system detects, via one or more input devices of the second electronic device, a first characteristic of the first electronic device or of a user of the first electronic device, locking the presentation of the first content in a first manner. In some examples, presenting the first content in the three-dimensional environment includes, in accordance with a determination that one or more second criteria are satisfied, different from the one or more first criteria, locking the presentation of the first content in a second manner, different from the first manner.

Additionally or alternatively, in some examples, the first characteristic includes a pose of a first portion of the user of the first electronic device.

Additionally or alternatively, in some examples, the first characteristic includes a pose of the first electronic device.

Additionally or alternatively, in some examples, locking the presentation of the first content in the first manner includes presenting the first content in a world-locked orientation.

Additionally or alternatively, in some examples, presenting the first content in the world-locked orientation includes presenting the first content relative to a current location of the second electronic device in the three-dimensional environment.

Additionally or alternatively, in some examples, the second electronic device includes an internal image sensor and an external image sensor, and presenting the first content relative to the current location of the second electronic device includes using the internal image sensor without using the external image sensor.

Additionally or alternatively, in some examples, presenting the first content in the world-locked orientation includes presenting the first content adjacent to the second electronic device while the second electronic device presents, via a display of the second electronic device, second content that is associated with the first content.

Additionally or alternatively, in some examples, presenting the first content adjacent to the second electronic device includes presenting the first content with a first spatial relationship relative to the display of the second electronic device. In some examples, the method further comprises, while presenting the first content with the first spatial relationship relative to the display of the second electronic device, and while a current orientation of the display of the second electronic device is a first orientation, detecting, via the one or more input devices of the second electronic device, a change in the current orientation of the display of the second electronic device from the first orientation to a second orientation, different from the first orientation. In some examples, the method further comprises, in response to detecting the change in the current orientation of the display of the second electronic device, maintaining presentation of the first content with the first spatial relationship relative to the display of the second electronic device.

Additionally or alternatively, in some examples, presenting the first content in the world-locked orientation includes presenting the first content relative to a respective location in the three-dimensional environment that is independent of a current location of the second electronic device in the three-dimensional environment.

Additionally or alternatively, in some examples, the second electronic device includes an internal image sensor and an external image sensor, and presenting the first content relative to the respective location includes using the internal image sensor and the external image sensor.

Additionally or alternatively, in some examples, locking the presentation of the first content in the second manner includes presenting the first content in a head-locked orientation.

Additionally or alternatively, in some examples, locking the presentation of the first content in the second manner includes presenting the first content in a body-locked orientation.

Additionally or alternatively, in some examples, locking the presentation of the first content in the first manner includes presenting the first content in a world-locked orientation relative to a current location of the second electronic device in the three-dimensional environment, and locking the presentation of the first content in the second manner includes presenting the first content in a world-locked orientation relative to a respective location in the three-dimensional environment that is independent of the current location of the second electronic device in the three-dimensional environment.

Additionally or alternatively, in some examples, the one or more first criteria include a criterion that is satisfied when the second electronic device has moved by less than a threshold amount over a predetermined period of time.

Additionally or alternatively, in some examples, the method further comprises, while locking the presentation of the first content in the second manner, in accordance with a determination that the one or more first criteria are satisfied, transitioning from locking the presentation of the first content in the second manner to locking the presentation of the first content in the first manner.

Additionally or alternatively, in some examples, transitioning from locking the presentation of the first content in the second manner to locking the presentation of the first content in the first manner includes presenting, via the one or more displays, a visual indication in the three-dimensional environment associated with locking the presentation of the first content in the first manner.

Additionally or alternatively, in some examples, the method further comprises, presenting an animation in the three-dimensional environment corresponding to the transition from locking the presentation of the first content in the second manner to locking the presentation of the first content in the first manner.

Additionally or alternatively, in some examples, the method further comprises, while locking the presentation of the first content in the first manner, in accordance with a determination that the one or more second criteria are satisfied, transitioning from locking the presentation of the first content in the first manner to locking the presentation of the first content in the second manner.

Additionally or alternatively, in some examples, the method further comprises, while locking the presentation of the first content in the first manner, detecting, via the one or more input devices of the second electronic device, an input corresponding to a request to control movement of the first content in the three-dimensional environment; and while detecting the input, moving the first content in the three-dimensional environment in accordance with movement of the second electronic device.

Additionally or alternatively, in some examples, the method further comprises presenting, via the one or more displays, an alignment user interface element in the three-dimensional environment. In some examples, the method further comprises detecting, via the one or more input devices of the second electronic device, the first characteristic of the first electronic device or of the user of the first electronic device, and while detecting the first characteristic of the first electronic device or of the user of the first electronic device, in accordance with a determination that a location of the second electronic device in the three-dimensional environment corresponds to the alignment user interface element, performing an action.

Therefore, according to the above, some examples of the disclosure are directed to a method, comprising, at a computing system including a first electronic device in communication with a second electronic device, wherein the first electronic device includes one or more displays, while presenting, via the one or more displays, first content in a three-dimensional environment, detecting, via one or more input devices of the second electronic device, a first pose of the second electronic device. In some examples, the method further comprises, in response to detecting the first pose of the second electronic device, in accordance with a determination that the first pose of the second electronic device satisfies one or more criteria, operating the second electronic device in a first mode for detecting one or more portions of a user of the computing system. In some examples, the method further comprises, while operating the second electronic device in the first mode, detecting, via the one or more input devices of the second electronic device, a first characteristic of the one or more portions of the user. In some examples, the method further comprises, in response to detecting the first characteristic of the one or more portions of the user, performing a first operation associated with the first content presented in the three-dimensional environment.

Additionally or alternatively, in some examples, the one or more input devices of the second electronic device include an image sensor.

Additionally or alternatively, in some examples, detecting the first characteristic of the one or more portions of the user includes detecting a hand gesture performed by the user using the image sensor.

Additionally or alternatively, in some examples, the image sensor is on a first side of the second electronic device, and the one or more criteria include a first criterion that is satisfied when a second side, opposite from the first side, of the second electronic device is directed toward a physical surface.

Additionally or alternatively, in some examples, the one or more criteria include a second criterion that is satisfied when the second side of the second electronic device is directed toward the physical surface for at least a threshold amount of time.

Additionally or alternatively, in some examples, the method further comprises, in accordance with a determination that the first pose of the second electronic device does not satisfy the one or more criteria, forgoing operating the second electronic device in the first mode for detecting the one or more portions of the user of the computing system.

Additionally or alternatively, in some examples, the method further comprises, while operating the second electronic device in the first mode, detecting, via the one or more input devices, a second characteristic, different from the first characteristic, of the one or more portions of the user; and in response to detecting the second characteristic of the one or more portions of the user, performing a second operation, different from the first operation, associated with the first content presented in the three-dimensional environment.

Additionally or alternatively, in some examples, the first characteristic is a first hand gesture, and the second characteristic is a second hand gesture, different from the first hand gesture.

Additionally or alternatively, in some examples, the method further comprises, while operating the second electronic device in the second mode, detecting, via the one or more input devices of the second electronic device, movement of the second electronic device from the first pose; and in response to detecting the movement of the second electronic device from the first pose, ceasing to operate the second electronic device in the first mode.

Additionally or alternatively, in some examples, the first operation includes presenting, via the one or more displays, a cursor in the three-dimensional environment.

Additionally or alternatively, in some examples, the method further comprises, while presenting the cursor in the three-dimensional environment, detecting, via the one or more input devices of the second electronic device, first movement; and moving the cursor in the three-dimensional environment in accordance with the first movement.

Additionally or alternatively, in some examples, the first operation includes scrolling the first content.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a computing system, comprising: one or more processors; memory; and one or more programs stored in the memory and configured to executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

Therefore, according to the above, some examples of the disclosure are directed to a method, comprising, at a computing system including a first electronic device in communication with a second electronic device, wherein the first electronic device includes one or more displays and one or more input devices, and wherein the second electronic device includes an image sensor. In some examples, while presenting, via the one or more displays, first content in a three-dimensional environment, the method includes detecting, via the one or more input devices of the first electronic device, a first pose of the second electronic device; and in response to detecting the first pose of the second electronic device, in accordance with a determination that the first pose of the second electronic device satisfies one or more criteria, operating the second electronic device in a first mode for detecting one or more portions of a user of the computing system. In some examples, while operating the second electronic device in the first mode, the method includes detecting, via the one or more input devices of the second electronic device, a hand gesture; and in response to detecting hand gesture, performing a first operation associated with the first content presented in the three-dimensional environment.

Additionally or alternatively, in some examples, the image sensor is on a first side of the second electronic device, and the one or more criteria include a first criterion that is satisfied when a second side, opposite from the first side, of the second electronic device is directed toward a physical surface.

Additionally or alternatively, in some examples, the one or more criteria include a second criterion that is satisfied when the second side of the second electronic device is directed toward the physical surface for at least a threshold amount of time.

Additionally or alternatively, in some examples, in response to detecting the first pose of the second electronic device, the method includes presenting, via the one or more displays, the first content including a three-dimensional volume in the three-dimensional environment. In some examples, the three-dimensional volume represents locations in the three-dimensional environment that are visible from the image sensor of the second electronic device, and the locations in the three-dimensional environment that are visible from the image sensor of the second electronic device are based on the first pose of the second electronic device.

Additionally or alternatively, in some examples, the three-dimensional volume is a trapezoidal prism, a rectangular prism, a cube, a sphere, or a cylinder.

Additionally or alternatively, in some examples, the three-dimensional volume is a virtual user interface object.

Additionally or alternatively, in some examples, the three-dimensional volume is located at a first distance from the second electronic device.

Additionally or alternatively, in some examples, the three-dimensional volume is displayed at least partially translucent.

Additionally or alternatively, in some examples, the second electronic device is not visible within the first content displayed via the one or more displays.

Additionally or alternatively, in some examples, the computing system further includes a third electronic device, the third electronic device including an image sensor. In some examples, the method further includes, while presenting, via the one or more displays, the first content in the three-dimensional environment, detecting, via the one or more input devices of the first electronic device, a first pose of the third electronic device. In some examples, presenting, via the one or more displays, the first content including the three-dimensional volume in the three-dimensional environment comprises presenting the three-dimensional volume representing locations in the three-dimensional environment that are visible from the image sensor of the second electronic device and from the image sensor of the third electronic device. In some examples, the locations in the three-dimensional environment that are visible from the image sensor of the third electronic device are based on the first pose of the third electronic device.

Additionally or alternatively, in some examples, the computing system further includes a third electronic device, the third electronic device including an image sensor. In some examples, the method further comprises: while presenting, via the one or more displays, the first content in the three-dimensional environment, detecting, via the one or more input devices of the first electronic device, a first pose of the third electronic device. In some examples, the method further comprises: in response to detecting the first pose of the third electronic device: presenting, via the one or more displays, the first content including a second three-dimensional volume in the three-dimensional environment. In some examples, the second three-dimensional volume represents locations in the three-dimensional environment that are visible from the image sensor of the third electronic device. In some examples, the locations in the three-dimensional environment that are visible from the image sensor of the third electronic device are based on the first pose of the third electronic device.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method, comprising:
at a computing system including a first electronic device in communication with a second electronic device, wherein the first electronic device includes one or more displays:
presenting, via the one or more displays, first content in a three-dimensional environment, including:
in accordance with a determination that one or more first criteria are satisfied, the one or more first criteria including a criterion that is satisfied when the computing system detects, via one or more input devices of the second electronic device, a first characteristic of the first electronic device or of a user of the first electronic device, locking the presentation of the first content in a first manner; and
in accordance with a determination that one or more second criteria are satisfied, different from the one or more first criteria, locking the presentation of the first content in a second manner, different from the first manner.

2. The method of claim 1, wherein the first characteristic includes a pose of a first portion of the user of the first electronic device or a pose of the first electronic device.

3. (canceled)

4. The method of claim 1, wherein locking the presentation of the first content in the first manner includes presenting the first content in a world-locked orientation.

5. The method of claim 4, wherein presenting the first content in the world-locked orientation includes presenting the first content relative to a current location of the second electronic device in the three-dimensional environment.

6-10. (canceled)

11. The method of claim 4, wherein locking the presentation of the first content in the second manner includes presenting the first content in a head-locked orientation or a body-locked orientation.

12. (canceled)

13. The method of claim 1, wherein:
locking the presentation of the first content in the first manner includes presenting the first content in a world-locked orientation relative to a current location of the second electronic device in the three-dimensional environment, and
locking the presentation of the first content in the second manner includes presenting the first content in a world-locked orientation relative to a respective location in the three-dimensional environment that is independent of the current location of the second electronic device in the three-dimensional environment.

14. The method of claim 1, wherein the one or more first criteria include a criterion that is satisfied when the second electronic device has moved by less than a threshold amount over a predetermined period of time.

15-18. (canceled)

19. The method of claim 1, further comprising:
while locking the presentation of the first content in the first manner, detecting, via the one or more input devices of the second electronic device, an input corresponding to a request to control movement of the first content in the three-dimensional environment; and
while detecting the input, moving the first content in the three-dimensional environment in accordance with movement of the second electronic device.

20. (canceled)

21. An electronic device comprising:
one or more processors;
memory;
one or more displays; and
one or more programs stored in the memory and configured to be executed by the one or more processors, wherein the electronic device is a first electronic device in communication with a second electronic device, the one or more programs including instructions for:
presenting, via the one or more displays, first content in a three-dimensional environment, including:
in accordance with a determination that one or more first criteria are satisfied, the one or more first criteria including a criterion that is satisfied when the first electronic device detects, via one or more input devices of the second electronic device, a first characteristic of the first electronic device or of a user of the first electronic device, locking the presentation of the first content in a first manner; and
in accordance with a determination that one or more second criteria are satisfied, different from the one or more first criteria, locking the presentation of the first content in a second manner, different from the first manner.

22. A non-transitory computer readable storage medium storing one or more programs, the one or more programs comprising instructions, which when executed by one or more processors of an electronic device, the electronic device being a first electronic device in communication with a second electronic device and comprising one or more displays, cause the electronic device to:
present, via the one or more displays, first content in a three-dimensional environment, including:
in accordance with a determination that one or more first criteria are satisfied, the one or more first criteria including a criterion that is satisfied when the first electronic device detects, via one or more input devices of the second electronic device, a first characteristic of the first electronic device or of a user of the first electronic device, lock the presentation of the first content in a first manner; and
in accordance with a determination that one or more second criteria are satisfied, different from the one or more first criteria, lock the presentation of the first content in a second manner, different from the first manner.

23-55. (canceled)

56. The electronic device of claim 21, wherein the first characteristic includes a pose of a first portion of the user of the first electronic device or a pose of the first electronic device.

57. The electronic device of claim 21, wherein locking the presentation of the first content in the first manner includes presenting the first content in a world-locked orientation.

58. The electronic device of claim 57, wherein presenting the first content in the world-locked orientation includes presenting the first content relative to a current location of the second electronic device in the three-dimensional environment.

59. The electronic device of claim 57, wherein locking the presentation of the first content in the second manner includes presenting the first content in a head-locked orientation or a body-locked orientation.

60. The electronic device of claim 21, wherein:
locking the presentation of the first content in the first manner includes presenting the first content in a world-locked orientation relative to a current location of the second electronic device in the three-dimensional environment, and
locking the presentation of the first content in the second manner includes presenting the first content in a world-locked orientation relative to a respective location in the three-dimensional environment that is independent of the current location of the second electronic device in the three-dimensional environment.

61. The electronic device of claim 21, wherein the one or more first criteria include a criterion that is satisfied when the second electronic device has moved by less than a threshold amount over a predetermined period of time.

62. The electronic device of claim 21, the one or more programs further including instructions for:
while locking the presentation of the first content in the first manner, detecting, via the one or more input devices of the second electronic device, an input corresponding to a request to control movement of the first content in the three-dimensional environment; and
while detecting the input, moving the first content in the three-dimensional environment in accordance with movement of the second electronic device.

63. The non-transitory computer readable storage medium of claim 22, wherein the first characteristic includes a pose of a first portion of the user of the first electronic device or a pose of the first electronic device.

64. The non-transitory computer readable storage medium of claim 22, wherein locking the presentation of the first content in the first manner includes presenting the first content in a world-locked orientation.

65. The non-transitory computer readable storage medium of claim 64, wherein presenting the first content in the world-locked orientation includes presenting the first content relative to a current location of the second electronic device in the three-dimensional environment.

66. The non-transitory computer readable storage medium of claim 64, wherein locking the presentation of the first content in the second manner includes presenting the first content in a head-locked orientation or a body-locked orientation.

67. The non-transitory computer readable storage medium of claim 22, wherein:
locking the presentation of the first content in the first manner includes presenting the first content in a world-locked orientation relative to a current location of the second electronic device in the three-dimensional environment, and
locking the presentation of the first content in the second manner includes presenting the first content in a world-locked orientation relative to a respective location in the three-dimensional environment that is independent of the current location of the second electronic device in the three-dimensional environment.

68. The non-transitory computer readable storage medium of claim 22, wherein the one or more first criteria include a criterion that is satisfied when the second electronic device has moved by less than a threshold amount over a predetermined period of time.

69. The non-transitory computer readable storage medium of claim 22, the instructions, when executed by the one or more processors of the electronic device, further cause the electronic device to:
while locking the presentation of the first content in the first manner, detect, via the one or more input devices of the second electronic device, an input corresponding to a request to control movement of the first content in the three-dimensional environment; and
while detecting the input, move the first content in the three-dimensional environment in accordance with movement of the second electronic device.
